(19) United States
(12) Patent Application Publication
(10) Pub. No.: US 2024/0259793 A1
(43) Pub. Date: Aug. 1, 2024

(54) WIRELESS COMMUNICATION DEVICE AND METHOD

(71) Applicant: Sony Group Corporation, Tokyo (JP)

(72) Inventors: Kosuke AIO, Tokyo (JP); Shigeru SUGAYA, Tokyo (JP)

(73) Assignee: Sony Group Corporation, Tokyo (JP)

(21) Appl. No.: 18/563,929

(22) PCT Filed: Feb. 7, 2022
(86) PCT No.: PCT/JP2022/004586

§ 371 Date: Nov. 24, 2023

(30) Foreign Application Priority Data
Jun. 2, 2021 (JP) 2021-092677

(51) Int. Cl. H04W 12/03; H04B 7/185; H04L 1/08

(52) U.S. Cl. CPC H04W 12/03; H04B 7/18513; H04L 1/08

(57) ABSTRACT

The present technology relates to a wireless communication device and method capable of improving low latency and high reliability.

The wireless communication device performs retransmission processing with each of a first other wireless communication device and a second other wireless communication device in response to a request signal transmitted from the first other wireless communication device or the second other wireless communication device, and performs a setting of relay communication in which encryption processing and decryption processing are skipped. The present technology can be applied to a wireless communication system.

### TECHNICAL FIELD

The present technology relates to a wireless communication device and method, and more particularly, to a wireless communication device and method capable of improving low latency and high reliability.

### BACKGROUND ART

In recent years, Home Mesh AP products for the purpose of expanding wireless LAN coverage in a home environment have attracted attention. Various operation modes are conceivable for the Home Mesh AP.

In Home Mesh APs, one AP is generally operated as a node that connects to the Internet (hereinafter, referred to as “Source Node”), and the remaining APs are operated as nodes that deliver signals to the subordinate terminals via wireless communication (hereinafter, referred to as “Relay Nodes”). Such communication in multiple APs is called relay communication, and is expected to become widespread in offices and factories in the future.

In order to support a wide range of applications, the wireless LAN is expected to require not only high throughput but also various wireless characteristics such as low latency and high reliability.

In conventional relay communications, retransmission control is not performed between links, or packets are buffered in a Relay Node, which is incompatible with low latency and high reliability.

Therefore, we focus on an MLO Relay that relays a packet in the middle of the MAC layer of the Relay Node. In the MLO Relay, it is expected to perform relay communication with low latency and high reliability by reducing packet buffering in the Relay Node as much as possible while performing retransmission control in each link.

In the MLO Relay described above, since encryption in the Relay Node is skipped, an operation of generating an encryption key between the Source Node and the STA and directly encrypting the relay packet between the Source Node and the STA is required as described in Non-Patent Document 1.

### CITATION LIST

### Non-Patent Document

Non-Patent Document 1: “Wook Bong Lee, Srinivas Kandala, Sharan Naribole, Ashok Ranganath”, “Virtual BSS For Multi AP Coordination”, “https://mentor.ieee.org/802.11/dcn/19/11-19-1019-00-00be-virtual-bss-for-multi-ap-coordination.pptx”, July 2019, Internet <Internet search on Apr. 15, 2021>

### SUMMARY OF THE INVENTION

### Problems to be Solved by the Invention

However, Non-Patent Document 1 does not disclose a method of performing initial setting for skipping encryption in the Relay Node. In particular, in the MLO Relay, it is necessary to set Block Ack according to UpLink (UL)/DownLink (DL), and it is necessary to perform appropriate setting processing according to the size of the relay dedicated memory included in the Relay Node.

The present technology has been made in view of such a situation, and aims to improve low latency and high reliability.

### Solutions to Problems

A wireless communication device according to a first aspect of the present technology includes a communication control unit that performs retransmission processing with each of a first other wireless communication device and a second other wireless communication device in response to a request signal transmitted from the first other wireless communication device or the second other wireless communication device, and performs a setting of relay communication in which encryption processing and decryption processing are skipped.

A wireless communication device according to a second aspect of the present technology includes a communication control unit that generates an encryption key directly with a first other wireless communication device and performs a setting of retransmission processing with a second other wireless communication device in relay communication in which communication with the first other wireless communication device is performed by relaying the second other wireless communication device.

In the first aspect of the present technology, retransmission processing is performed with each of a first other wireless communication device and a second other wireless communication device in response to a request signal transmitted from the first other wireless communication device or the second other wireless communication device, and a setting of relay communication in which encryption processing and decryption processing are skipped is performed.

In the second aspect of the present technology, an encryption key is directly generated with a first other wireless communication device and a setting of retransmission processing is performed with a second other wireless communication device in relay communication in which communication with the first other wireless communication device is performed by relaying the second other wireless communication device.

### BRIEF DESCRIPTION OF DRAWINGS

FIG. 1 is a diagram illustrating a configuration example of a wireless communication system according to an embodiment of the present technology.

FIG. 2 is a block diagram illustrating a configuration example of a wireless communication device operating as a Source Node.

FIG. 3 is a block diagram illustrating a configuration example of a wireless communication device operating as a conventional Relay Node.

FIG. 4 is a diagram illustrating a processing example in a data processing unit of FIG. 3.

FIG. 5 is a block diagram illustrating a configuration example of a wireless communication device operating as an STA.

FIG. 6 is a diagram illustrating a first example of a transmission latency.

FIG. 7 is a diagram illustrating a second example of a transmission latency.

FIG. 8 is a block diagram illustrating a configuration example of a wireless communication device according to the present technology that operates as a Relay Node.

FIG. 9 is a diagram illustrating a processing example in a data processing unit of FIG. 8.

FIG. 10 is a diagram illustrating state transition of the MLO Relay.

FIG. 11 is a diagram illustrating an overall sequence during MLO Relay Setup according to the first embodiment.

FIG. 12 is a diagram illustrating an overall sequence during MLO Relay Reset according to the first embodiment.

FIG. 13 is a diagram illustrating a configuration example of Relay Setup Info Element.

FIG. 14 is a diagram illustrating a configuration example of Relay Report Info Element.

FIG. 15 is a diagram illustrating a configuration of a Relay Setup Request frame.

FIG. 16 is a diagram illustrating a configuration of a Relay Setup Response frame.

FIG. 17 is a diagram illustrating a configuration of a Relay Association Request frame.

FIG. 18 is a diagram illustrating a configuration of a Relay Association Response frame.

FIG. 19 is a diagram illustrating a configuration of a Relay Setup/Reset Report frame.

FIG. 20 is a diagram illustrating a configuration of a Relay ADDBA Request frame.

FIG. 21 is a diagram illustrating a configuration of a Relay ADDBA Response frame.

FIG. 22 is a diagram illustrating an example of a DL MLO Relay Initial Setup sequence according to the first embodiment.

FIG. 23 is a diagram illustrating an example of a DL MLO Relay Setup sequence according to the first embodiment.

FIG. 24 is a diagram illustrating an example of a DL MLO Relay Reset sequence according to the first embodiment.

FIG. 25 is a diagram illustrating an example of a DL MLO Relay Final Reset sequence according to the first embodiment.

FIG. 26 is a diagram illustrating an example of a UL MLO Relay Initial Setup sequence according to the first embodiment.

FIG. 27 is a diagram illustrating an example of a UL MLO Relay Setup sequence according to the first embodiment.

FIG. 28 is a diagram illustrating an example of a UL MLO Relay Reset sequence according to the first embodiment.

FIG. 29 is a diagram illustrating an example of a UL MLO Relay Final Reset sequence according to the first embodiment.

FIG. 30 is a flowchart for explaining DL MLO Relay setting or releasing processing of a Source Node according to the first embodiment.

FIG. 31 is a flowchart for explaining DL MLO Relay setting or releasing processing of an STA according to the first embodiment.

FIG. 32 is a flowchart for explaining UL MLO Relay setting or releasing processing of a Source Node according to the first embodiment.

FIG. 33 is a flowchart for explaining UL MLO Relay setting or releasing processing of an STA according to the first embodiment.

FIG. 34 is a flowchart for explaining MLO Relay setting or releasing processing common to DL and UL in a Relay Node according to the first embodiment.

FIG. 35 is a flowchart for explaining BA Setup processing of a Relay Node according to the first embodiment.

FIG. 36 is a flowchart for explaining BA Setup processing of a Source Node or an STA according to the first embodiment.

FIG. 37 is a diagram illustrating an effect of Relay BA Setup of the first embodiment.

FIG. 38 is a diagram illustrating an effect of Relay BA Setup of the first embodiment.

FIG. 39 is a diagram illustrating an effect of Relay BA Setup of the first embodiment.

FIG. 40 is a diagram illustrating an overall sequence during MLO Relay Setup according to the second embodiment.

FIG. 41 is a diagram illustrating an overall sequence during MLO Relay Reset according to the second embodiment.

FIG. 42 is a diagram illustrating an example of a DL MLO Relay Initial Setup sequence according to the second embodiment.

FIG. 43 is a diagram illustrating an example of a DL MLO Relay Setup sequence according to the second embodiment.

FIG. 44 is a diagram illustrating an example of a DL MLO Relay Reset sequence according to the second embodiment.

FIG. 45 is a diagram illustrating an example of a DL MLO Relay Final Reset sequence according to the second embodiment.

FIG. 46 is a flowchart for explaining DL MLO Relay setting or releasing processing of a Source Node according to the second embodiment.

FIG. 47 is a flowchart for explaining DL MLO Relay setting or releasing processing of a Relay Node according to the second embodiment.

FIG. 48 is a flowchart for explaining DL MLO Relay setting or releasing processing of an STA Node according to the second embodiment.

FIG. 49 is a diagram illustrating an effect of Relay BA Setup of the second embodiment.

FIG. 50 is a diagram illustrating an effect of Relay BA Setup of the second embodiment.

FIG. 51 is a diagram illustrating an effect of Relay BA Setup of the second embodiment.

FIG. 52 is a diagram illustrating an effect of the present technology.

FIG. 53 is a block diagram illustrating a configuration example of a computer.

### MODE FOR CARRYING OUT THE INVENTION

Hereinafter, modes for carrying out the present technology will be described. The description will be given in the following order.
1. System Configuration and Device Configuration
2. First Embodiment
3. Second Embodiment
4. Others

### 1. SYSTEM CONFIGURATION AND DEVICE CONFIGURATION

### <System Configuration>

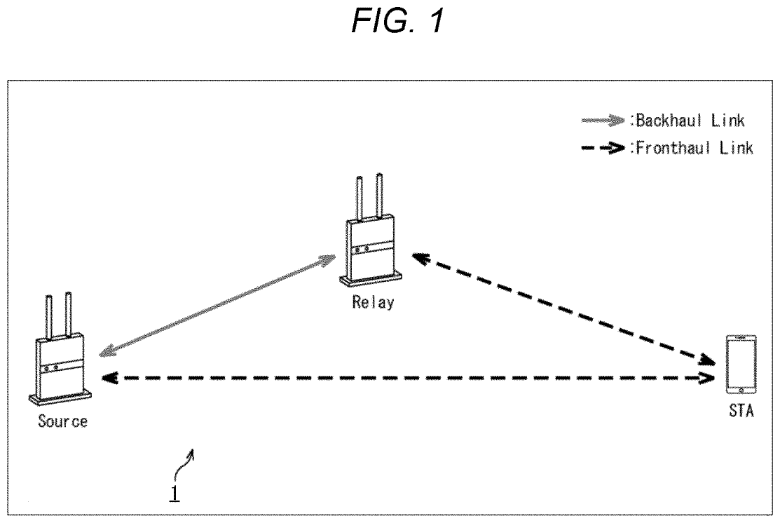

FIG. 1 is a diagram illustrating a configuration example of a wireless communication system according to an embodiment of the present technology.

A wireless communication system 1 of FIG. 1 includes two Access Points (APs, Base Station) and one STAtion (STA, terminal).

One of the two APs operates as a Source Node connected to WAN (Internet). The other of the two APs is not connected to the WAN and operates as a Relay Node that relays a signal from the Source Node to the STA as necessary. Note that the Source Node and the Relay Node perform cell formation.

In FIG. 1, a communication link between a Source Node and a Relay Node is referred to as a Backhaul Link. Communication links between the Source Node and the STA and between the Relay Node and the STA are referred to as Fronthaul Links. In the present specification, it is assumed that these links operate at different center frequencies and can perform communication in parallel.

Note that the target system configuration is not limited to this, and it is sufficient that there are a plurality of wireless communication devices to which connection is established, and there is a wireless communication device as a peripheral terminal for each wireless communication device, and the positional relationship is also irrelevant as long as the above-described conditions are satisfied.

### <Configuration of Wireless Communication Device>

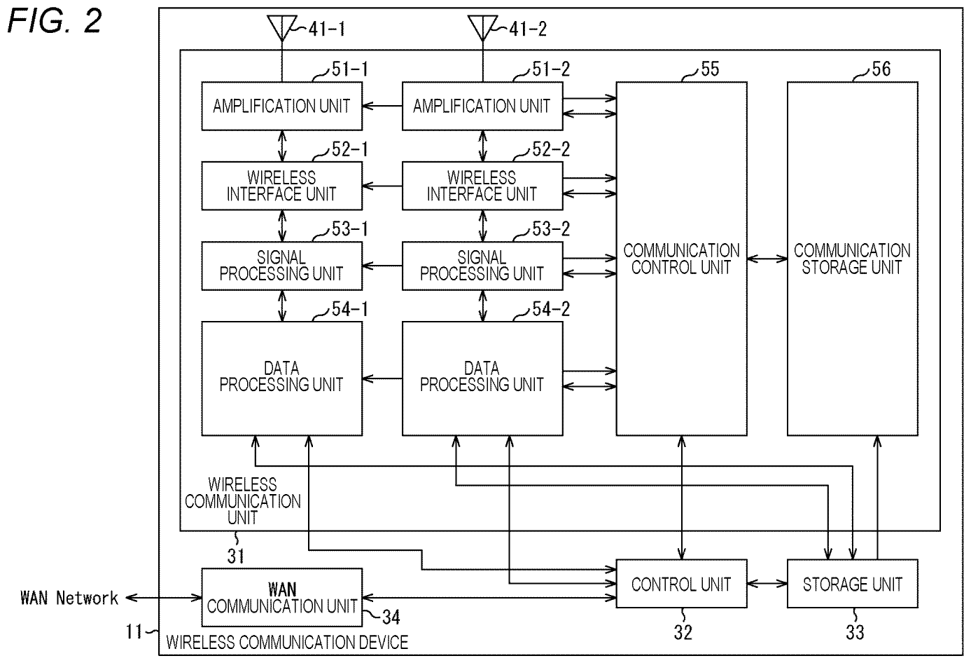

FIG. 2 is a block diagram illustrating a configuration example of a wireless communication device operating as a Source Node.

A wireless communication device 11 includes a wireless communication unit 31, a control unit 32, a storage unit 33, a WAN communication unit 34, and antennas 41-1 and 41-2. The antennas 41-1 and 41-2 are collectively referred to as an antenna 41 in a case where there is no need to distinguish them.

The wireless communication unit 31 transmits and receives data. The wireless communication unit 31 includes amplification units 51-1 and 51-2, a wireless interface unit 52-1 and a wireless interface unit 52-2, and signal processing units 53-1 and 53-2. In addition, the wireless communication unit 31 includes a data processing unit 54, a communication control unit 55, and a communication storage unit 56.

The wireless communication unit 31 holds two or more amplification units 51-1 and 51-2, two or more wireless interface units 52-1 and 52-2, and two or more signal processing units 53-1 and 53-2 so that parallel processing can be performed for the backhaul link and the fronthaul link.

Note that the amplification units 51-1 and 51-2, the wireless interface units 52-1 and 52-2, and the signal processing units 53-1 and 53-2 are collectively referred to as an amplification unit 51, a wireless interface unit 52, and a signal processing unit 53, respectively, in a case where there is no need to distinguish them.

At transmission, the amplification unit 51 amplifies an analog signal supplied from the wireless interface unit 52 to a predetermined power, and outputs the analog signal with the amplified power to the antenna 41. At reception, the amplification unit 51 amplifies an analog signal supplied from the antenna 41 to a predetermined power, and outputs the analog signal with amplified power to the wireless interface unit 52.

A part of the function of the amplification unit 51 may be included in the wireless interface unit 52. In addition, a part of the function of the amplification unit 51 may be a component outside the wireless communication unit 31.

At transmission, the wireless interface unit 52 converts a transmission symbol stream from the signal processing unit 53 into an analog signal, performs filtering, up-conversion to a carrier frequency, and phase control, and outputs the analog signal after the phase control to the amplification unit 51.

At the time of reception, the wireless interface unit 52 performs phase control, down-conversion, and reverse filtering on an analog signal supplied from the amplification unit 51, and outputs a reception symbol stream as a result of conversion into a digital signal to the signal processing unit 53.

At the time of transmission, the signal processing unit 53 performs encoding, interleaving, modulation, and the like on a data unit supplied from the data processing unit 54, adds a physical header, and outputs a transmission symbol stream to each wireless interface unit 52.

At the time of reception, the signal processing unit 53 analyzes a physical header of a reception symbol stream supplied from each wireless interface unit 52, performs demodulation, deinterleaving, decoding, and the like on the reception symbol stream, and generates a data unit. The generated data unit is output to the data processing unit 54.

Note that the signal processing unit 53 performs complex channel characteristic estimation and spatial separation processing as necessary.

At the time of transmission, the data processing unit 54 performs sequence management and encryption processing of the data held in the communication storage unit 56 and the control signal and the management information received from the communication control unit 55. After the encryption processing, the data processing unit 54 adds a Media Access Control (MAC) header and an error detection code to generate a packet, and performs multiple aggregation processing on the packets.

At the time of reception, the data processing unit 54 performs deaggregation processing, analysis and error detection of the MAC headers of the received packets, a retransmission request operation, and reorder processing.

The antenna 41, the amplification unit 51, the wireless interface unit 52, the signal processing unit 53, and the data processing unit 54 constitute one set (hereinafter, referred to as a communication set) for each having the same branch number. Each communication set becomes a component of the wireless communication device 11, and performs wireless communication using a backhaul link or a fronthaul link. Furthermore, each communication set may include the storage unit 33.

The communication control unit 55 controls operation of each unit of the wireless communication unit 31 and information transmission between the units.

Furthermore, the communication control unit 55 performs control to transfer a control signal and management information to be notified to another wireless communication device to the data processing unit 54.

The communication storage unit 56 holds information to be used by the communication control unit 55.

Furthermore, the communication storage unit 56 holds a packet to be transmitted and a received packet. A transmission buffer that holds packets to be transmitted is included in the communication storage unit 56.

The control unit 32 includes a central processing unit (CPU), a read only memory (ROM), a random access memory (RAM), and the like. The control unit 32 executes a program stored in the ROM or the like, and controls the wireless communication unit 31 and the communication control unit 55. Furthermore, the control unit 32 may also perform part of the operation of the communication control unit 55. Moreover, the communication control unit 55 and the control unit 32 may be configured as one block.

The storage unit 33 holds information used by the wireless communication unit 31 and the control unit 32. Furthermore, the storage unit 33 may also perform part of the operation of the communication storage unit 56. The storage unit 33 and the communication storage unit 56 may be configured as one block.

The WAN communication unit 34 analyzes the packet acquired from the WAN network, and transfers the analyzed packet to the wireless communication unit 31 via the control unit 32. The format of the transferred packet may be a state in which the IP Header is left as it is (access point mode) or a state in which the IP Header is analyzed and removed by the WAN communication unit 34 (router mode).

Note that the antenna 41, the amplification unit 51, and the wireless interface unit 52 having the same branch number form one set, and without being limited to two sets, three or more sets may be components of the wireless communication device 11. In addition, the wireless communication unit 31 is realized by one or more LSIs.

### <Configuration of Conventional Wireless Communication Device>

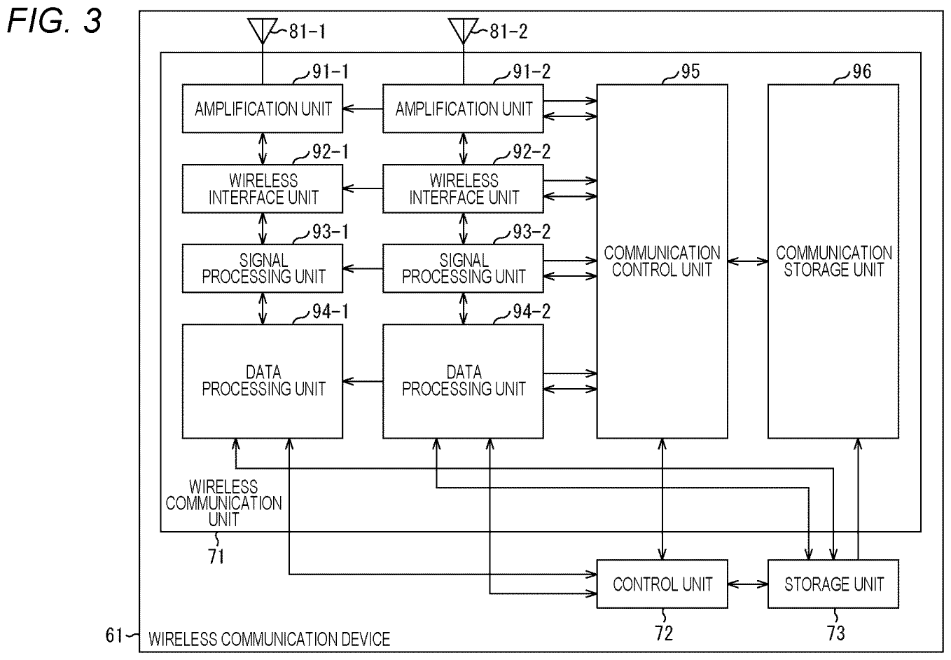

FIG. 3 is a block diagram illustrating a configuration example of a conventional wireless communication device operating as a Relay Node.

A wireless communication device 61 includes a wireless communication unit 71, a control unit 72, a storage unit 73, and antennas 81-1 and 81-2. The antennas 81-1 and 81-2 are collectively referred to as an antenna 81 in a case where there is no need to distinguish them.

The control unit 72, the storage unit 73, and the antenna 81 in FIG. 3 have similar configurations to the control unit 32, the storage unit 33, and the antenna 41 in FIG. 2.

The wireless communication unit 71 includes amplification units 91-1 and 91-2, a wireless interface unit 92-1 and a wireless interface unit 92-2, and signal processing units 93-1 and 93-2. In addition, the wireless communication unit 71 includes a data processing unit 94, a communication control unit 95, and a communication storage unit 96.

Note that the amplification units 91-1 and 91-2, the wireless interface units 92-1 and 92-2, and the signal processing units 93-1 and 93-2 are collectively referred to as an amplification unit 91, a wireless interface unit 92, and a signal processing unit 93, respectively, in a case where there is no need to distinguish them.

The amplification unit 91, the wireless interface unit 92, the signal processing unit 93, the data processing unit 94, the communication control unit 95, and the communication storage unit 96 in FIG. 3 have similar configurations to the amplification unit 51, the wireless interface unit 52, the signal processing unit 53, the data processing unit 54, the communication control unit 55, and the communication storage unit 56 in FIG. 2.

### <Processing in Data Processing Unit>

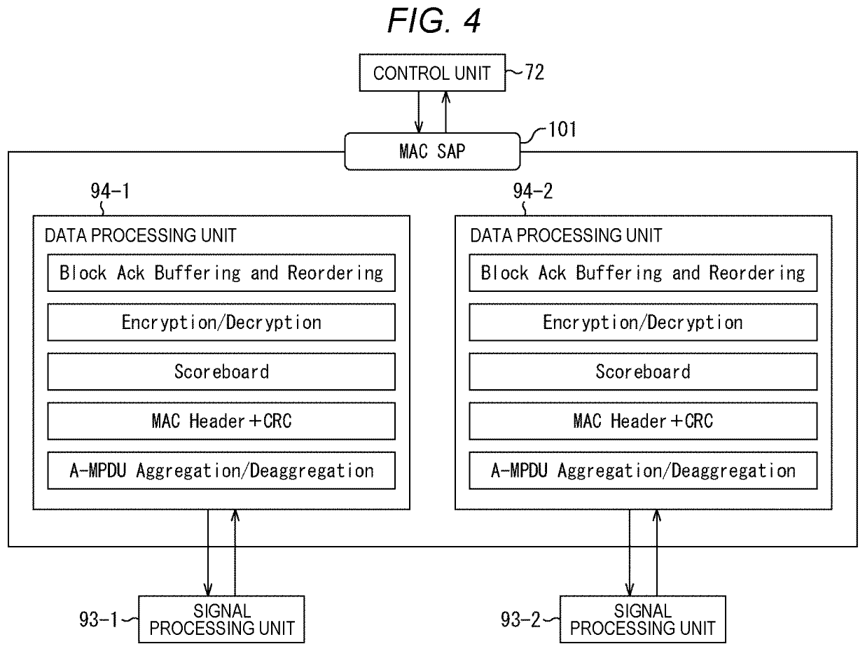

FIG. 4 is a diagram illustrating a processing example in the data processing unit of FIG. 3.

In FIG. 4, each data processing unit 94 exchanges control signals, data, and the like with the control unit 72 via a MAC Service Access Point (SAP) 101.

In the data processing unit 94, processing of Block Ack Buffering and Reordering, Encyption/Decryption, Scoreboard, MAC Header+CRC Check, and A-MPDU Aggregation/Deaggregation is performed.

Specifically, as described above, at the time of transmission, the data processing unit 94 performs sequence management of data held in the communication storage unit 96 (hereinafter, referred to as MAC Buffer) and a control signal and management information received from the communication control unit 95, and performs Encyption.

After performing the encryption processing, the data processing unit 94 adds a MAC header and an error detection code (MAC Header+CRC Creation), and generates a packet. In addition, the data processing unit 94 performs multiple aggregation processing (A-MPDU Aggregation) of the generated packets.

At the time of reception, the data processing unit 94 performs deaggregation processing (A-MPDU Deaggregation) of the MAC headers of the received packets, MAC header analysis and error detection (MAC Header+CRC Check), retransmission determination (Scoreboard), and Decryption. Furthermore, the data processing unit 94 performs partial storage (Block Ack Buffering and Reordering) for the reorder processing.

These processes are performed by the data processing units 94-1 and 94-2 so as to be processed in parallel by the backhaul link and the fronthaul link. The data processing units 94-1 and 94-2 also transfer data to and from the control unit 72, but transfer the transmission/reception packets to and from the signal processing units 93-1 and 93-2 under control, respectively.

### <Configuration of Wireless Communication Device>

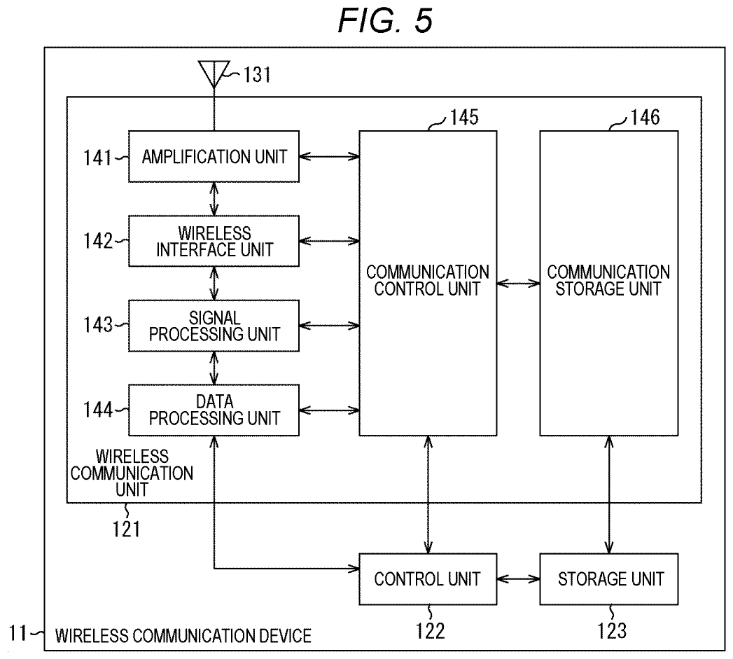

FIG. 5 is a block diagram illustrating a configuration example of a wireless communication device operating as an STA.

A wireless communication device 111 includes a wireless communication unit 121, a control unit 122, a storage unit 123, and antennas 131-1 and 131-2. The antennas 131-1 and 131-2 are collectively referred to as an antenna 131 in a case where there is no need to distinguish them.

The control unit 122, the storage unit 123, and the antenna 131 in FIG. 5 have similar configurations to the control unit 32, the storage unit 33, and the antenna 41 in FIG. 2.

The wireless communication unit 121 includes an amplification unit 141, a wireless interface unit 142, a signal processing unit 143, a data processing unit 144, a communication control unit 145, and a communication storage unit 146.

The amplification unit 141, the wireless interface unit 142, the signal processing unit 143, the data processing unit 144, the communication control unit 145, and the communication storage unit 146 in FIG. 5 have similar configurations to the amplification unit 51, the wireless interface unit 52, the signal processing unit 53, the data processing unit 54, the communication control unit 55, and the communication storage unit 56 in FIG. 2.

Note that although FIG. 5 illustrates an example in which the STA includes only one set of the amplification unit 141, the wireless interface unit 142, the signal processing unit 143, and the data processing unit 144 as the minimum configuration, the STA may be configured to be able to operate a plurality of frequency channels in parallel.

### PRIOR ART

Currently, the Relay Node often has the configurations of FIGS. 3 and 4 described above.

Therefore, for example, the Relay Node transfers the packet received from the Source Node via the backhaul link once to the control unit 72 and then transmits the packet to the STA via the fronthaul link. However, in this case, a transmission latency may occur.

### <First Example of Transmission Latency>

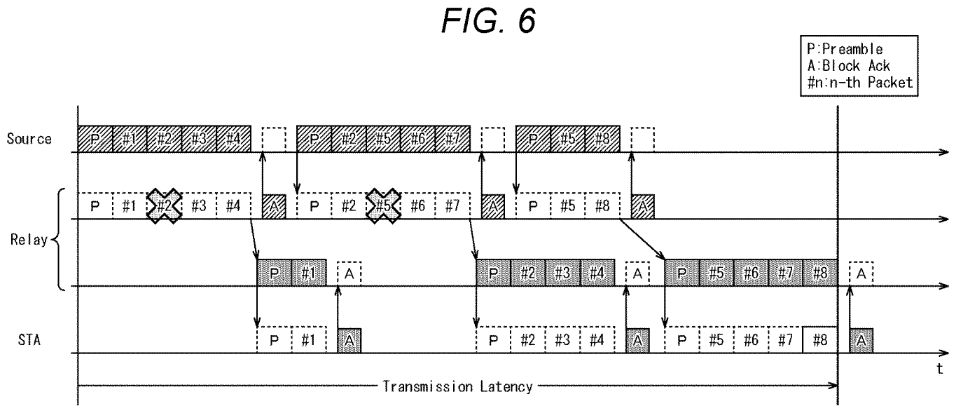

FIG. 6 is a diagram illustrating a first example of a transmission latency.

FIG. 6 illustrates an example in which packets #1 to #8 are transmitted from the Source Node to the STA via the Relay Node.

Note that, in the case of FIG. 6, an example of transmission and reception of data of the Source Node, the data processing unit 94-1 of the Relay Node, the data processing unit 94-2 of the Relay Node, and the STA is illustrated in order from the top.

In FIG. 6, #1 to #8 represent packets #1 to #8. P represents a Preamble serving as a PHY header, and A represents a Block Ack. In addition, a cross mark indicates a packet in which CRC is performed on the reception side and damage is found.

When the packets #1 to #4 are transmitted from the Source Node to the Relay Node, it is assumed that only the packet #2 is damaged on the reception side. In the case of FIG. 6, by the “Block Ack Buffering and Reordering” performed in the data processing unit 94-1 on the backhaul link side of the Relay Node, the successfully received packets #3 and #4 are temporarily stored until the packet #2 is retransmitted.

Therefore, the packet transferred to the data processing unit 94-2 on the fronthaul link side of the Relay Node, that is, the packet transmitted from the Relay Node to the STA is only the packet #1. Therefore, the number of packets transmitted from the Relay Node to the STA at one time decreases, and the transmission efficiency deteriorates.

When the packets #1 to #4 are transmitted from the Source Node to the Relay Node and received by the data processing unit 94-1 of the Relay Node, the data processing unit 94-1 of the Relay Node transmits Block Acks of the successfully received packets #1, #3, and #4 to the Source Node.

The Source Node that has received the Block Ack from the Relay Node then transmits the packet #2 for which reception has failed and the next packets #5 to #7 to the Relay Node. At that time, even in a case where only the packet #5 is damaged on the reception side, similarly, the packets #6 and #7 which are successfully received are temporarily stored by “Block Ack Buffering and Reordering” performed in the data processing unit 94-1 on the backhaul link side.

Therefore, the packets transmitted from the Relay Node to the STA are only the packet #2 and the temporarily stored packets #3 and #4. Therefore, the number of packets transmitted from the Relay Node to the STA at one time decreases, and the transmission efficiency deteriorates.

When the packet #2 and the packets #5 to #7 are transmitted from the Source Node to the Relay Node and received by the data processing unit 94-1 of the Relay Node, the data processing unit 94-1 of the Relay Node transmits Block Acks of the successfully received packets #2, #6, and #7 to the Source Node.

The Source Node that has received the Block Ack from the Relay Node then transmits the packet #5 for which reception has failed and the next packet #8 to the Relay Node. In this case, since reception of none of the packets has failed, the packets transmitted from the Relay Node to the STA are the packets #5 and #8 and the temporarily stored packets #6 and #7.

As described above, in the case of FIG. 6, in the Relay Node, in a case where the reception of one packet has failed, even if the subsequent packet has been successfully received, the packet is temporarily stored by “Block Ack Buffering and Reordering”, and thus the transmission efficiency to the STA deteriorates.

### <Second Example of Transmission Latency>

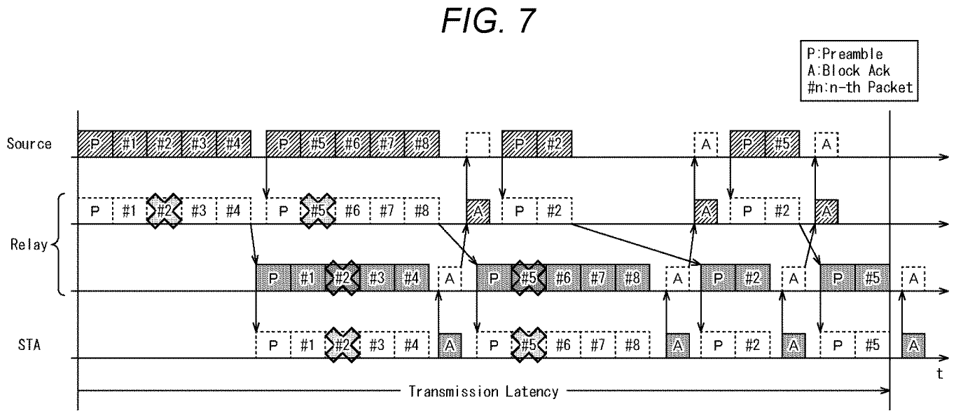

FIG. 7 is a diagram illustrating a second example of the transmission latency.

Similarly to FIG. 6, FIG. 7 illustrates an example in which packets #1 to #8 are transmitted from the Source Node to the STA via the Relay Node.

In the case of FIG. 7, an example of a system of an Amplitude Forword (AF) Relay or a system of viewing only a MAC header and transmitting to the fronthaul link side is illustrated.

The packets #1 to #4 are transmitted from the Source Node to the Relay Node. At that time, it is assumed that only the packet #2 is damaged on the reception side. In the case of FIG. 7, the retransmission processing performed in the data processing unit 94-1 on the backhaul link side of the Relay Node is skipped, and the packets #1 to #4 are transferred to the data processing unit 94-1 on the fronthaul side and transmitted to the STA. That is, the damaged packet #2 is also transmitted to the STA as it is.

Next, the packets #5 to #8 are transmitted from the Source Node to the Relay Node. At that time, it is assumed that only the packet #5 is damaged on the reception side. In the Relay Node, the packets #5 to #8 are transmitted to the STA as described above. That is, the damaged packet #5 is also transmitted to the STA as it is.

The STA transmits the Block Ack of the successfully received packets #1 and #3 to #5 to the Source Node via the Relay Node (the data processing unit 94-2 and the data processing unit 94-1). The Source Node that has received the Block Ack from the Relay Node then transmits the packet #2 for which reception has failed to the Relay Node. In the Relay Node, the packet #2 is transmitted to the STA as described above.

Similarly, the STA transmits the Block Acks of the successfully received packets #6 to #8 to the Source Node via the Relay Node. The Source Node that has received the Block Ack from the Relay Node then transmits the packet #5 for which reception has failed to the Relay Node. In the Relay Node, the packet #5 is transmitted to the STA as described above.

As described above, in the case of FIG. 7, in a case where reception of one packet fails in the Relay Node, the packet for which reception has failed is also transmitted to the STA, and thus, the transmission efficiency to the STA deteriorates.

From the above, in the Relay Node, the retransmission processing is also executed on the backhaul link side, but it is considered desirable that buffering for the reorder processing in the data processing unit 94 is not performed as much as possible, and transmission is performed as it is on the fronthaul link side.

Therefore, in the present technology, setting, changing, and releasing of relay communication are performed in a configuration of a wireless communication device operating as a Relay Node described below.

### <Configuration of Wireless Communication Device of Present Technology>

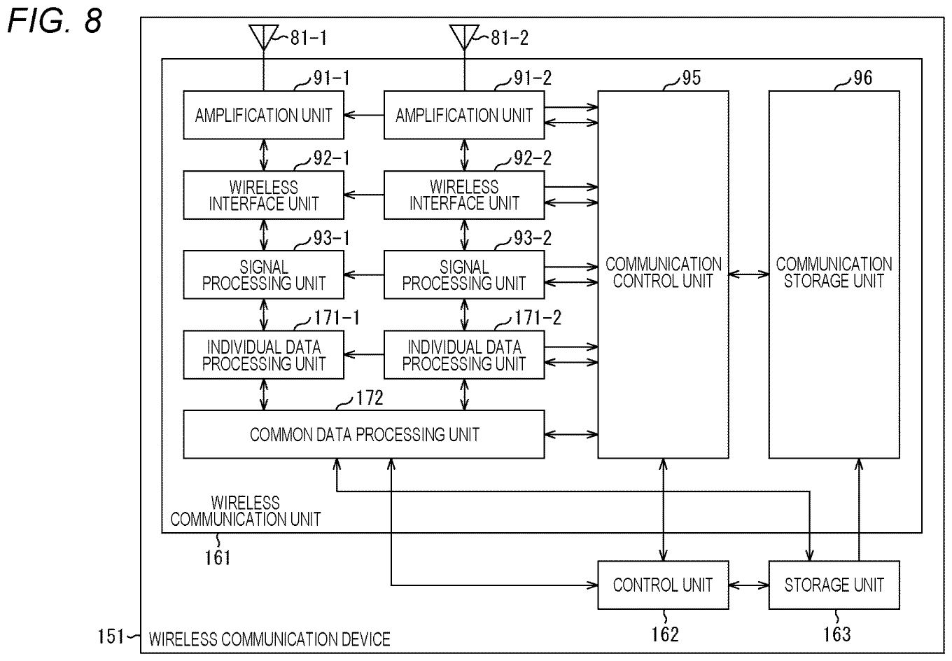

FIG. 8 is a block diagram illustrating a configuration example of a wireless communication device operating as a Relay Node according to the present technology.

A wireless communication device 151 includes a wireless communication unit 161, a control unit 162, a storage unit 163, and antennas 81-1 and 81-2 of FIG. 3.

The control unit 162 and the storage unit 163 in FIG. 8 have similar configurations to the control unit 72 and the storage unit 73 in FIG. 3.

The wireless communication unit 161 is different from the wireless communication unit 71 of FIG. 3 in that the data processing units 94-1 and 94-2 are replaced with individual data processing units 171-1 and 171-2 and a common data processing unit 172.

Note that the individual data processing units 171-1 and 171-2 are collectively referred to as an individual data processing unit 171 in a case where there is no need to distinguish them.

The individual data processing unit 171-1 performs individual processing on the backhaul link, for example.

The individual data processing unit 171-2 performs individual processing on the fronthaul link, for example.

The common data processing unit 172 performs common processing on the fronthaul link and the backhaul link.

### <Processing in Data Processing Unit>

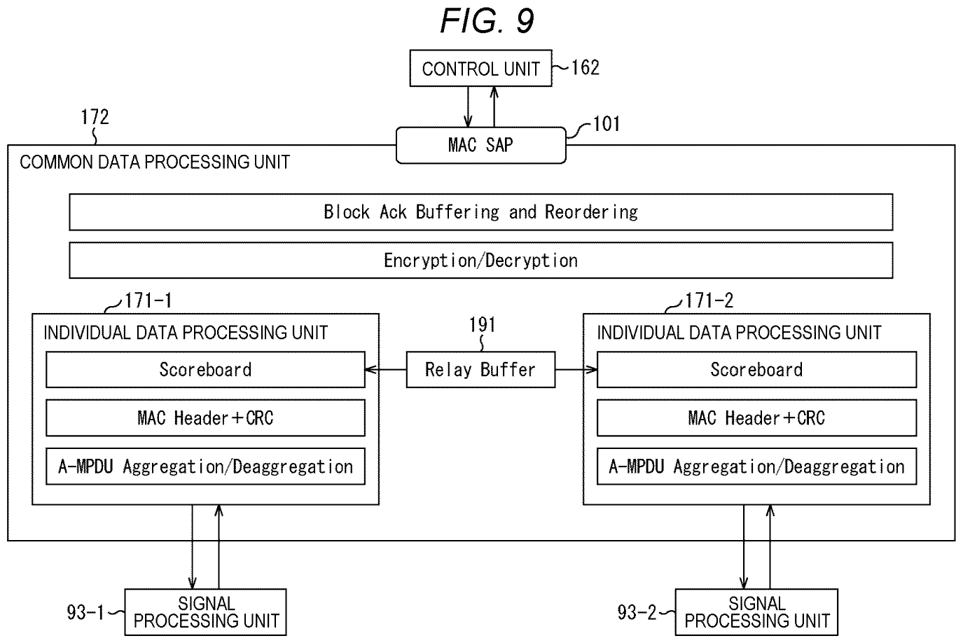

FIG. 9 is a diagram illustrating a processing example in the data processing unit of FIG. 8.

In FIG. 9, similarly to in FIG. 4, the individual data processing units 171-1 and 171-2 and the common data processing unit 172 exchange control signals, data, and the like with the control unit 162 via the MAC SAP 101.

In the individual data processing unit 171, processing of Scoreboard, MAC Header+CRC Check, and A-MPDU Aggregation/Deaggregation is performed.

In the common data processing unit 172, processing of Block Ack Buffering and Reordering and Encyption/Decryption is performed.

Furthermore, in FIG. 9, a Relay Buffer 191 is provided between the individual data processing units 171-1 and 171-2.

In the case of an MLO Relay, the common data processing unit 172 performs sequence management of data held in a MAC Buffer and a control signal and management information received from the communication control unit 95 at the time of transmission.

The individual data processing unit 171 performs sequence management, and then adds a MAC header and an error detection code (MAC Header+CRC Creation) to generate a packet. In addition, the data processing unit 94 performs multiple aggregation processing (A-MPDU Aggregation) of the generated packets.

At the time of reception, the individual data processing unit 171 performs deaggregation processing (A-MPDU Deaggregation) of the MAC headers of the received packets, MAC header analysis and error detection (MAC Header+CRC Check), and retransmission determination (Scoreboard).

At that time, the individual data processing unit 171-1 performs retransmission determination processing on the signal received from the backhaul link, and supplies the signal after the retransmission determination processing to the individual data processing unit 171-2 of the fronthaul link via the Relay Buffer 191. In addition, the individual data processing unit 171-2 performs retransmission determination processing on the signal received from the fronthaul link, and supplies the signal after the retransmission determination processing to the individual data processing unit 171-2 of the backhaul link via the Relay Buffer 191. This makes it possible to avoid encryption, decryption, and buffering before transmission while maintaining retransmission processing in each link.

Note that such a configuration is called a Multi-Link Architecture, and relay communication using the configuration of FIG. 9 is hereinafter referred to as an MLO Relay.

The above-described processing is performed by the individual data processing units 171-1 and 171-2 and the Relay Buffer 191 so as to be processed in parallel in the backhaul link and the fronthaul link. The individual data processing units 171-1 and 171-2 also perform data transfer with the control unit 162, but transfer of transmission/reception packets is performed with the signal processing units 93-1 and 93-2 under control, respectively.

### <State Transition of MLO Relay>

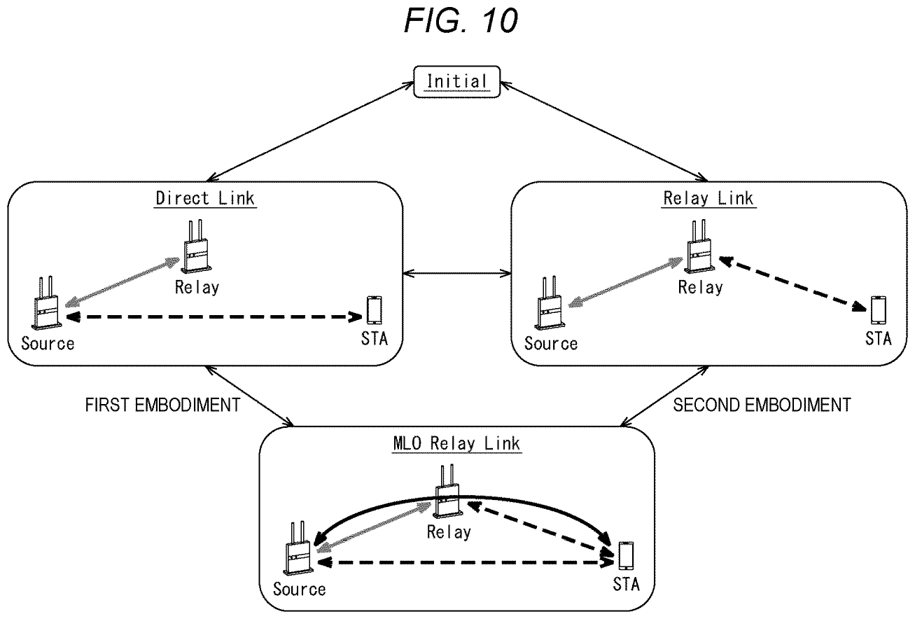

FIG. 10 is a diagram illustrating state transition of the MLO Relay.

In FIG. 10, Direct Link, Relay Link, and MLO Relay Link are illustrated as three states of the wireless communication system 1 of FIG. 1.

Direct Link is a state in which the Source Node and the STA are directly connected.

The Relay Link is a state in which the Relay Node performs relay communication with the configuration of FIG. 3.

The MLO Relay Link is a state in which the Relay Node performs MLO Relay that is relay communication of the present technology with the configuration of FIG. 8.

There are roughly two types of necessary processing for performing MLO Relay from Direct Link or Relay Link. The first is that, in order to skip the encryption and decryption processing in the Relay Node during MLO Relay communication, encryption key generation and encryption key exchange need to be performed between the Source Node and the STA.

The second is that, at the time of Relay communication, setting of Block ACK (in particular, how many packets can be associated) needs to be determined on the basis of the storage capability of the Relay Buffer 191 in the Relay Node. In particular, since the Relay Buffer 191 is mounted in a lower order than the conventional memory, there is a possibility that the packet storage capability is lowered.

Hereinafter, a specific embodiment will be described focusing on MLO Relay setting processing. Note that, here, a method of setting the MLO Relay or releasing the MLO Relay from two states will be described as a first embodiment and a second embodiment.

First, as a first embodiment, setting processing for transitioning from the Direct Link to the MLO Relay Link and setting processing for returning from the MLO Relay Link to the Direct Link will be described.

Next, as a second embodiment, setting processing for transitioning from the Relay Link to the MLO Relay Link and setting processing for returning from the MLO Relay Link to the Relay Link will be described.

### 2. First Embodiment

### <Overall Sequence During MLO Relay Setup>

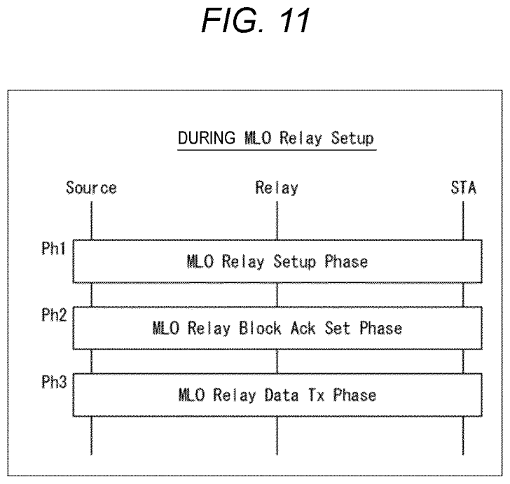

FIG. 11 is a diagram illustrating an overall sequence during MLO Relay Setup (setting) according to the first embodiment.

FIG. 11 illustrates, as a first embodiment, setting processing for transitioning from the Direct Link to the MLO Relay Link as described above with reference to FIG. 10. In the state of Direct Link, generation, exchange, and the like of an encryption key between the Source Node and the Relay Node have already been performed.

In the phase Ph1 MLO Relay Setup Phase, the wireless communication system 1 performs setting processing for performing the MLO Relay. The Source Node, the Relay Node, and the STA perform MLO Relay Setup processing. Note that, if necessary, the wireless communication system 1 also performs connection processing between the Relay Node and the STA.

In the phase Ph2 MLO Relay Block Ack Set Phase, the wireless communication system 1 performs Block Ack Setup processing for the MLO Relay. That is, the Source Node or the STA exchanges an ADDBA (ADD Block Ack) Request frame and an ADDBA Response frame with the Relay Node.

In the phase Ph3 MLO Relay Data Tx Phase, the wireless communication system 1 performs transmission by the MLO Relay. In this phase, the Source Node or the STA transmits a packet to which an MLO Relay configured Relay Traffic Indication (TID) is assigned. The Relay TID is information for identifying a packet on which MLO Relay is performed. The Relay TID is hereinafter also simply referred to as a TID.

Note that these Phases do not need to be performed continuously, and the MLO Relay Block Ack Set Phase of the phase Ph2 may be started periodically after the MLO Relay Setup of the phase Ph1 is completed once.

### <Overall Sequence During MLO Relay Reset>

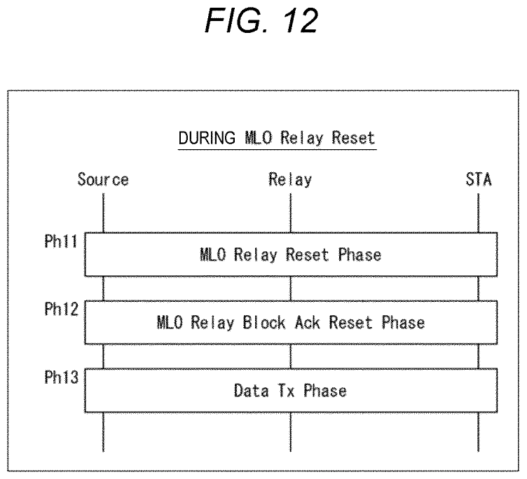

FIG. 12 is a diagram illustrating an overall sequence during MLO Relay Reset (release) according to the first embodiment.

In FIG. 12, as a first embodiment, as described above with reference to FIG. 10, releasing processing for returning from the MLO Relay Link to the Direct Link is illustrated.

In the phase Ph11 MLO Relay Reset Phase, the wireless communication system 1 performs Reset processing for releasing the MLO Relay. Note that, if necessary, the wireless communication system 1 also performs disconnection processing between the Relay Node and the STA.

In the phase Ph12 MLO Relay Block Ack Reset Phase, the wireless communication system 1 performs Block Ack Reset processing for the MLO Relay. In the phase Ph12, similarly to the prior art, a Delete Block Ack (DELBA) frame and an ACK frame are exchanged between transmission and reception.

In the phase Ph13 Data Tx Phase, the wireless communication system 1 performs direct transmission between the Source and the STA.

First, configuration examples of frames and elements used in the first embodiment will be described.

### <Configuration of Relay Setup Info Element>

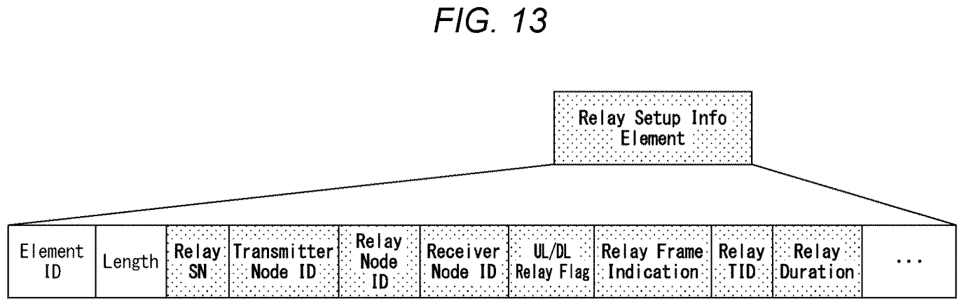

FIG. 13 is a diagram illustrating a configuration example of Relay Setup Info Element.

Relay Setup Info Element is a setting information group of relay communication for use in MLO Relay setting. Relay Setup Info Element in FIG. 13 is an Element stored and transmitted in some frames described later.

The Relay Setup Info Element includes Element ID, Length, Relay SN, Transmitter Node ID, Relay Node ID, Receiver Node ID, UL/DL Relay Flag, Relay Frame Indication, Relay TID, and Relay Duration. Note that, in FIG. 13, portions different from the conventional portions are hatched. It similarly applies to the drawings illustrating the following Element or Frame configuration examples.

The Element ID is information indicating that this Element is a Relay Setup Info Element.

The Length is information indicating the length of this Element.

The Relay Sequence Number (SN) is information indicating a processing number of the MLO Relay. The SN of the MLO Relay is set by the request side. The response side uses the value designated by the request side as it is.

The Transmitter Node ID is identification information of the transmission Node.

The Relay Node ID is identification information of the Relay Node.

The Receiver Node ID is identification information of the reception Node.

The identification information of these Nodes is only required to be any information that can be determined by the device, such as a MAC address, a BSSID, and an Association ID (AID).

The UL/DL Relay Flag is flag information for notifying a direction in which relay communication of UL or DL is performed. For example, 0 indicates UL and 1 indicates DL.

The Relay Frame Indication is information indicating a frame (packet) type on which MLO Relay is performed. For example, 0 indicates Data only, 1 indicates Control or Management frame only, and 2 indicates Both (Data and Control or Management frame).

As described above, the Relay TID is information for identifying a packet on which the MLO Relay is performed. A Relay SN may be attached to each Relay TID.

In a case where the Relay TID is not designated, a special value (for example, 0) may be input.

The Relay Duration is information indicating a period during which MLO Relay is performed. In a case where the period is not designated, a special value (for example, 0) may be determined to be input.

Note that, in FIG. 13, Element of IEEE 802.11 is described as a base, but the present technology is not limited to this Element configuration, and at least some information in the drawing is only required to be included. Furthermore, this Element is described assuming to be transmitted in a MAC Frame, but may be transmitted in a TCP/IP Frame as long as some information in the drawing is described. It similarly applies to the following Elements.

### <Configuration of Relay Report Info Element>

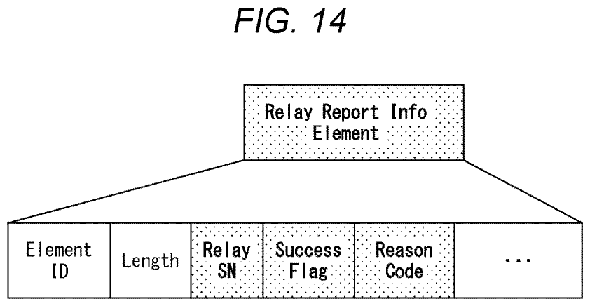

FIG. 14 is a diagram illustrating a configuration example of Relay Report Info Element.

The Relay Report Info Element is a response information group for setting or releasing relay communication for responding to the MLO Relay setting request. Similarly to the Relay Setup Info Element in FIG. 13, the Relay Report Info Element in FIG. 14 is an Element stored and transmitted in some frames described later.

The Relay Report Info Element includes an Element ID, a Length, a Relay SN, a Success Flag, and a Reason Code. Note that, in FIG. 14, description of parts common to the example of FIG. 13 is omitted.

The Success Flag is flag information indicating success or failure in setting the MLO Relay. For example, 0 indicates Fail, and 1 indicates Success.

The Reason Code is information indicating a reason when the MLO Relay fails to be set. Note that a combination of the information (value) and the reason is determined in advance.

### <Configuration of Relay Setup Request Frame>

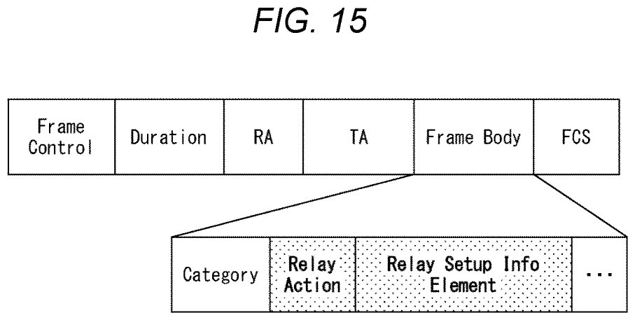

FIG. 15 is a diagram illustrating a configuration of a Relay Setup Request frame.

The Relay Setup Request frame is a relay communication setting request signal for setting relay communication. The Relay Setup Request frame in FIG. 15 includes fields of Frame control, Duration, Receiver Address (RA), Transmitter Address (TA), Frame Body, and FCS.

The field of the Frame Control includes information indicating the type of Frame.

The field of the Duration includes information indicating the length of the Frame.

The field of the RA includes information indicating the transmission destination address.

The field of the TA includes information indicating the transmission source address.

The field of the Frame Body includes a body of information to be transmitted. In the present technology, a Relay Action Frame is included in a field of a Frame Body.

In the case of FIG. 15, the Relay Action Frame includes subfields of Category, Relay Action, and Relay Setup Info Element in FIG. 13.

The subfield of Category includes information indicating that this Action Frame is Relay Action Frame.

The subfield of Relay Action includes information (for example, 0 to 5) indicating the type of Relay Action Frame. For example, 0 indicates that the type of this Relay Action Frame is Relay Setup Request. 1 indicates that the type of this Relay Action Frame is Relay Setup Response. 2 indicates that the type of the Relay Action Frame is Relay Setup Report.

3 indicates that the type of this Relay Action Frame is Relay Reset Request. 4 indicates that the type of this Relay Action Frame is Relay Reset Response. 5 indicates that the type of this Relay Action Frame is Relay Reset Report.

The field of FCS includes an error correction code.

Note that, in FIG. 15, Action Frame of IEEE 802.11 is described as a base, but the present technology is not limited to this Frame configuration, and at least some information in the drawing is only required to be included. Furthermore, this Frame is described assuming to be transmitted as a MAC Frame, but may be transmitted as a TCP/IP Frame as long as some information in the drawing is described. It similarly applies to the subsequent Frames.

### <Configuration of Relay Setup Response Frame>

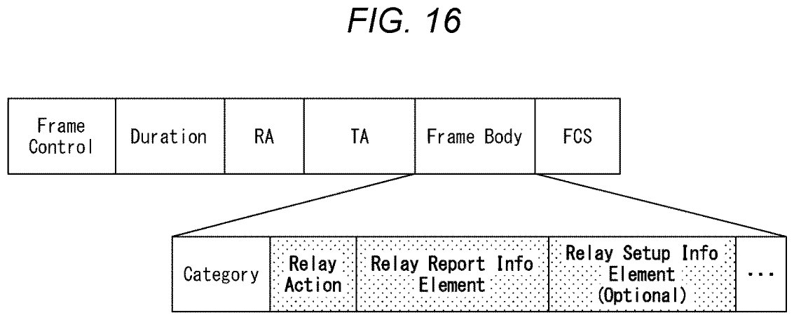

FIG. 16 is a diagram illustrating a configuration of a Relay Setup Response frame.

The Relay Setup Response frame is a relay communication setting response signal that is a response signal to the relay communication setting request signal. The Relay Setup Response frame in FIG. 16 includes fields of Frame control, Duration, RA, TA, Frame Body, and FCS. Note that, in FIG. 16, description of parts common to the example of FIG. 15 is omitted.

The field of the Frame Body includes a body of information to be transmitted. In the present technology, a Relay Action Frame is included in a field of a Frame Body.

In the case of FIG. 16, the Relay Action Frame includes subfields of Category, Relay Action, Relay Report Info Element in FIG. 14, and Relay Setup Info Element in FIG. 13. Note that, as indicated by Optional in FIG. 16, if Relay Setup Info Element is unnecessary, it may be skipped.

### <Configuration of Relay Association Request Frame>

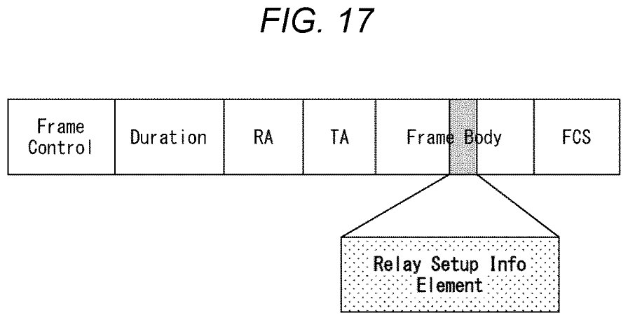

FIG. 17 is a diagram illustrating a configuration of a Relay Association Request frame.

The Relay Association Request frame is a connection request signal for relay communication. The Relay Association Request frame in FIG. 17 includes fields of Frame control, Duration, RA, TA, Frame Body, and FCS. Note that, in FIG. 17, description of parts common to the example of FIG. 15 is omitted.

The field of the Frame Body includes a body of information to be transmitted. In the present technology, Relay Setup Info Element in FIG. 13 is included in the field of the Frame Body.

### <Configuration of Relay Association Response Frame>

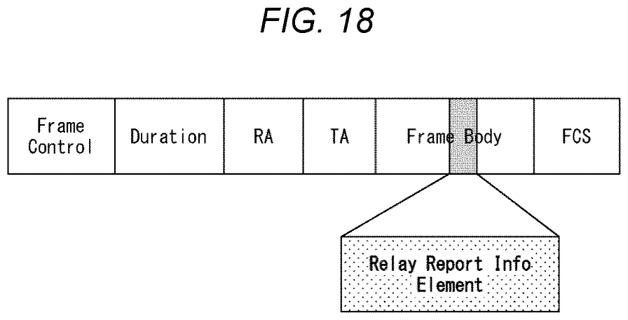

FIG. 18 is a diagram illustrating a configuration of a Relay Association Response frame.

The Relay Association Response frame is a connection response signal for relay communication, which is a response signal to the connection request signal for relay communication. The Relay Association Response frame in FIG. 18 includes fields of Frame control, Duration, RA, TA, Frame Body, and FCS. Note that, in FIG. 18, description of parts common to the example of FIG. 15 is omitted.

The field of the Frame Body includes a body of information to be transmitted. In the present technology, Relay Report Info Element in FIG. 14 is included in the field of the Frame Body.

### <Configuration of Relay Setup/Reset Report Frame>

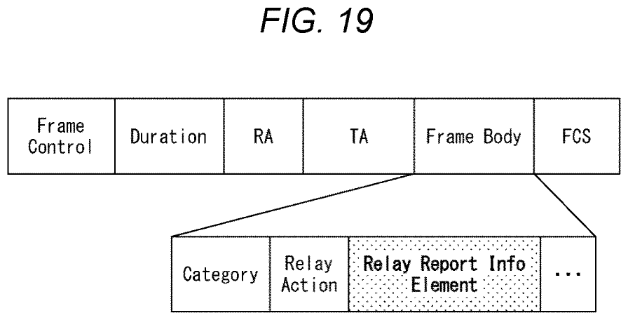

FIG. 19 is a diagram illustrating a configuration of a Relay Setup/Reset Report frame.

The Relay Setup/Reset Report frame is a relay setting (release) completion signal indicating completion of setting or releasing of relay communication. The Relay Setup/Reset Report frame in FIG. 19 includes fields of Frame control, Duration, RA, TA, Frame Body, and FCS. Note that, in FIG. 19, description of parts common to the example of FIG. 15 is omitted.

The field of the Frame Body includes a body of information to be transmitted. In the present technology, Relay Report Info Element in FIG. 14 is included in the field of the Frame Body.

### <Configuration of Relay ADDBA Request Frame>

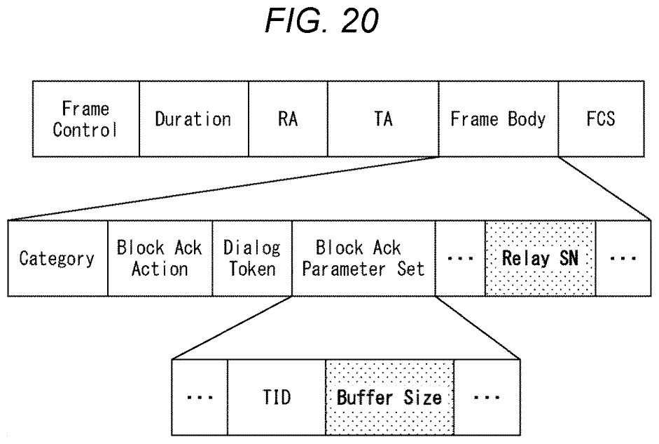

FIG. 20 is a diagram illustrating a configuration of a Relay ADDBA Request frame.

The Relay ADDBA Request frame is a retransmission processing setting request signal for relay communication that requests setting of retransmission processing for relay communication. The Relay ADDBA Request frame is a frame used in the MLO Relay Block Ack Setup Phase of the phase Ph2.

The Relay ADDBA Request frame in FIG. 20 includes fields of Frame control, Duration, RA, TA, Frame Body, and FCS. Note that, in FIG. 20, description of parts common to the example of FIG. 15 is omitted.

The field of the Frame Body includes a body of information to be transmitted.

In the case of FIG. 20, the Frame Body includes subfields of Category, Block Ack Action, Dialog Token, Block Ack Parameter Set, and Relay SN.

The subfield of Category includes information indicating that this Action Frame is a Block Ack Action Frame.

The subfield of the Block Ack Action includes information indicating the type of Block Ack Action Frame. In the case of FIG. 20, this subfield includes information indicating that it is Relay ADDBA Request.

The subfield of the Dialog Token includes information indicating a processing number.

The subfield of the Block Ack Parameter Set includes an information group necessary for Block Ack Setup. In the case of FIG. 20, this subfield includes information such as the TID and the Size of the RelayBuffer 191.

The subfield of the Relay SN includes sequence number information for positioning information with a preset MLO Relay. The sequence number information is basically managed in association with the TID.

Note that although FIG. 20 illustrates the Action Frame of IEEE 802.11 as a base, the present technology is not limited to this Frame configuration, and is only required to include at least information indicating that this frame is a frame different from the conventional ADDBA Request frame. Furthermore, this Frame is described assuming to be transmitted as a MAC Frame, but may be transmitted as a TCP/IP Frame as long as some information in the drawing is described. It similarly applies to the subsequent Frames.

### <Configuration of Relay ADDBA Response Frame>

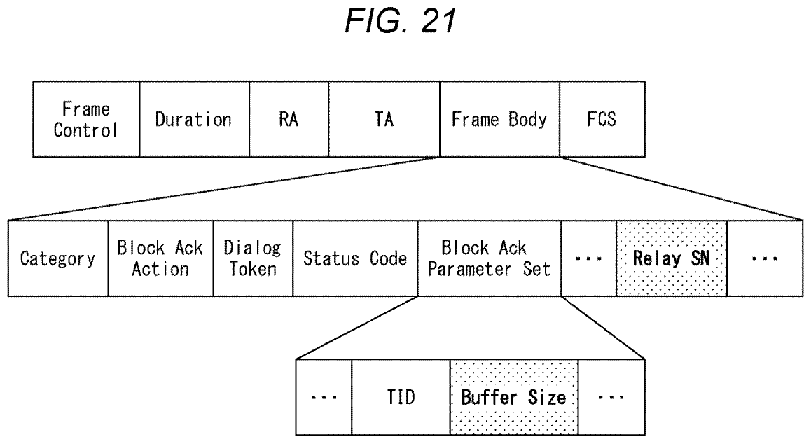

FIG. 21 is a diagram illustrating a configuration of a Relay ADDBA Response frame.

The Relay ADDBA Response frame is a relay communication retransmission processing setting response signal that is a response signal to the relay communication retransmission processing setting request signal. The Relay ADDBA Response frame in FIG. 21 is a frame used in the MLO Relay Block Ack Setup Phase, similarly to the Relay ADDBA Request frame in Ph2 in FIG. 20.

The Relay ADDBA Response frame in FIG. 21 includes fields of Frame control, Duration, RA, TA, Frame Body, and FCS. Note that, in FIG. 21, description of parts common to the example of FIG. 15 is omitted.

The field of the Frame Body includes a body of information to be transmitted.

In the case of FIG. 21, the Frame Body includes subfields of Category, Block Ack Action, Dialog Token, Status Code, Block Ack Parameter Set, and Relay SN. Note that, in FIG. 21, description of parts common to the example of FIG. 20, such as Block Ack Parameter Set and Relay SN, will be omitted.

The subfield of Category includes information indicating that this Action Frame is a Block Ack Action Frame.

The subfield of the Block Ack Action includes information indicating the type of Block Ack Action Frame. In the case of FIG. 20, this subfield includes information indicating Relay ADDBA Response.

The subfield of the Status Code includes information indicating the status of Relay Block Ack Setup. Note that a new situation may be defined for the MLO Relay.

### <DL MLO Relay Initial Setup Sequence>

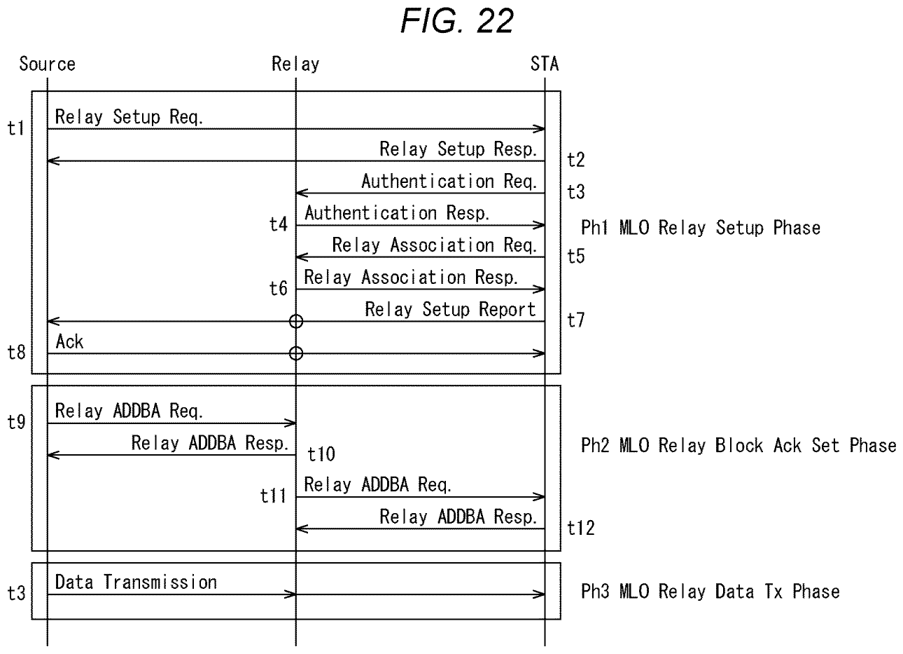

FIG. 22 is a diagram illustrating an example of a DL MLO Relay Initial Setup (initial setting) sequence according to the first embodiment.

Note that, in FIG. 22, a circle at the position of the Relay Node indicates that the control signal is once transmitted via the Relay Node in a case where the MLO Relay of the control signal is set. Furthermore, a circle at the position of the Relay Node indicates that the control signal is directly transmitted between the Source Node and the STA in a case where the MLO Relay of the control signal is not set. It similarly applies to the drawings illustrating the subsequent sequences.

Processing from timing t1 to t8 in FIG. 22 is processing of the MLO Relay Setup Phase of the phase Ph1. Processing from timing t9 to t12 is processing of the phase Ph2 MLO Relay Block Ack Set Phase. Processing at timing t13 is processing of the phase Ph3 MLO Relay Data Tx Phase.

The Source Node transmits a Relay Setup Request (Req.) frame in FIG. 15 to the STA at timing t1.

The STA receives a Relay Setup Request frame transmitted from the Source Node, and transmits a Relay Setup Response (Resp.) frame in FIG. 16 to the Source Node at timing t2. The Source Node receives a Relay Setup Response frame transmitted from the STA.

At timing t3, the STA transmits an Authentication Request frame for requesting authentication to the Relay Node.

The Relay Node receives the Authentication Request frame transmitted from the STA, and transmits an Authentication Response frame for responding to the authentication request to the STA at timing t4.

The STA receives the Authentication Response frame transmitted from the Relay Node, and transmits the Relay Association Request frame in FIG. 17 to the Relay Node at timing t5.

The Relay Node receives the Relay Association Request frame transmitted from the STA, and transmits the Relay Association Response frame in FIG. 18 to the STA at timing t6.

The STA receives the Relay Association Response frame transmitted from the Relay Node, and transmits the Relay Setup Report frame in FIG. 19 to the Source Node at timing t7.

The Source Node receives the Relay Setup Report frame transmitted from the STA, and transmits an Ack frame, which is a response to the Relay Setup Report frame, to the STA at timing t8. The STA receives the ACK frame transmitted from the Source Node.

Note that, at timings t7 and t8, direct exchange of the control signal between the STA and the Source Node is a case where the MLO Relay of the control signal is not set as described above. Conversely, in a case where the MLO Relay of the control signal is set, the control signal is transmitted once in the STA and the Source Node via the Relay Node.

The Source Node transmits the Relay ADDBA Request frame in FIG. 20 to the Relay Node at timing t9.

The Relay Node receives the Relay ADDBA Request frame transmitted from the Source Node, and transmits the Relay ADDBA Response frame in FIG. 21 to the Source Node at timing t10. The Source Node receives a Relay ADDBA Response frame transmitted from the Relay Node.

The Relay Node transmits the Relay ADDBA Request frame in FIG. 20 to the STA at timing t11.

The STA receives the Relay ADDBA Request frame transmitted from the Relay Node, and transmits the Relay ADDBA Response frame in FIG. 21 to the Relay Node at timing t12. The Relay Node receives the Relay ADDBA Response frame.

The Source Node performs Data Transmission for transmitting a Data frame to the Relay Node at timing t13. The Relay Node receives a Data frame transmitted from the Source Node, and performs relay communication with the STA by the processing method described above with reference to FIG. 9. The STA receives a Data frame transmitted from the Relay Node.

### <DL MLO Relay Setup Sequence>

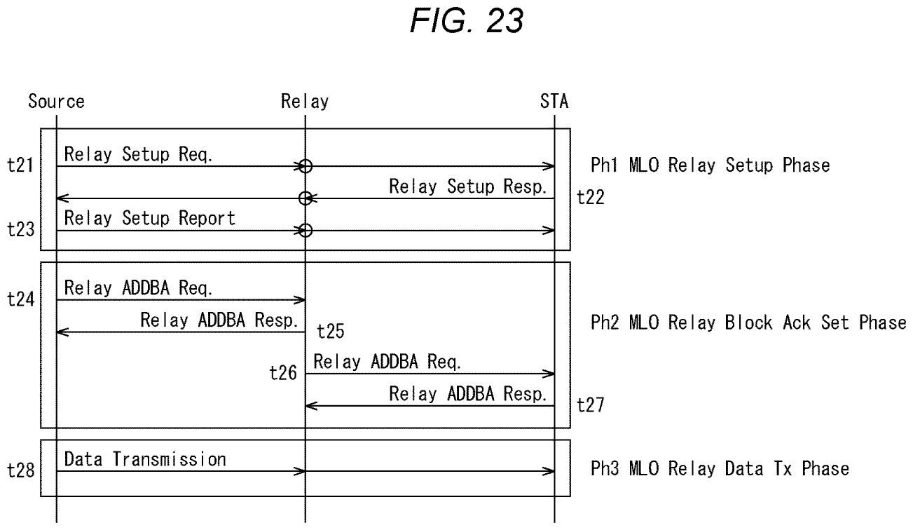

FIG. 23 is a diagram illustrating an example of a DL MLO Relay Setup sequence according to the first embodiment.

Processing from timing t21 to t23 in FIG. 23 is processing of the MLO Relay Setup Phase of the phase Ph1. Processing from timing t24 to t27 is processing of the phase Ph2 MLO Relay Block Ack Set Phase. Processing at timing t28 is processing of the phase Ph3 MLO Relay Data Tx Phase.

The Source Node transmits the Relay Setup Request frame in FIG. 15 to the RelayNode and the STA at timing t21.

The RelayNode and the STA receive the Relay Setup Request frame transmitted from the Source Node, and transmit the Relay Setup Response frame in FIG. 16 to the Source Node at timing t22.

The Source Node receives the Relay Setup Response frame transmitted from the Relay Node and the STA, and transmits the Relay Setup Report frame in FIG. 19 to the RelayNode and the STA at timing t23. The RelayNode and the STA receive a Relay Setup Response frame transmitted from the Source Node.

Note that the direct exchange of the control signals between the STA and the Source Node at the timings t21 to t23 is a case where the MLO Relay of the control signal is not set as described above.

Conversely, in a case where the MLO Relay of the control signal is set, the control signal is transmitted once via the Relay Node in the STA and the Source Node.

The Source Node transmits the Relay ADDBA Request frame in FIG. 20 to the Relay Node at timing t24.

The Relay Node receives the Relay ADDBA Request frame transmitted from the Source Node, and transmits the Relay ADDBA Response frame in FIG. 21 to the Source Node at timing t25. The Source Node receives a Relay ADDBA Response frame transmitted from the Relay Node.

The Relay Node transmits the Relay ADDBA Request frame in FIG. 20 to the STA at timing t26.

The STA receives the Relay ADDBA Request frame transmitted from the Relay Node, and transmits the Relay ADDBA Response frame in FIG. 21 to the Relay Node at timing t27. The Relay Node receives the Relay ADDBA Response frame transmitted from the STA.

The Source Node performs Data Transmission for transmitting a Data frame to the Relay Node at timing t28. The Relay Node receives a Data frame transmitted from the Source Node, and performs relay communication with the STA by the processing method described above with reference to FIG. 9. The STA receives a Data frame transmitted from the Relay Node.

### <DL MLO Relay Reset Sequence>

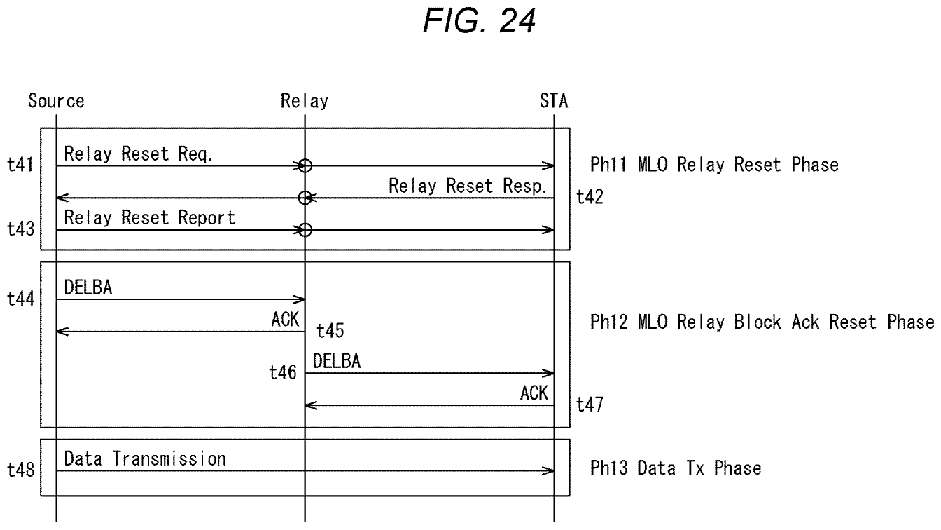

FIG. 24 is a diagram illustrating an example of a DL MLO Relay Reset sequence according to the first embodiment.

Processing from timing t41 to t43 in FIG. 24 is processing of the MLO Relay Reset Phase of the phase Ph11. Processing from timing t44 to t47 is processing of the phase Ph12 MLO Relay Block Ack Reset Phase. Processing at timing t48 is processing of the phase Ph13 Data Tx Phase.

At timing t41, the Source Node transmits a Relay Reset Request frame, which is a relay communication release request signal for requesting release of relay communication, to the Relay Node and the STA. The Relay Reset Request frame includes the Relay Report Info Element in FIG. 14 including the Relay SN and the like.

The Relay Node and the STA receive a Relay Reset Request frame transmitted from the Source Node, and transmit a Relay Reset Response frame, which is a relay communication release response signal for responding to the relay communication release request signal, to the Source Node at timing t42. The Relay Reset Response frame includes the Relay Report Info Element in FIG. 14.

The Source Node receives the Relay Reset Response frame transmitted from the Relay Node and the STA, and transmits the Relay Reset Report frame in FIG. 19 to the Relay Node and the STA at timing t43. The Relay Node and the STA receive a Relay Reset Report frame transmitted from the Source Node.

Note that the direct exchange of the control signal between the STA and the Source Node at the timings t41 to t43 is a case where the MLO Relay of the control signal is not set as described above. Conversely, in a case where the MLO Relay of the control signal is set, the control signal is transmitted once via the Relay Node in the STA and the Source Node.

The Source Node transmits the DELBA frame to the Relay Node at timing t44.

The Relay Node receives the DELBA frame transmitted from the Source Node, and transmits an ACK frame to the Source Node at timing t45. The Source Node receives the ACK frame transmitted from the Relay Node.

The Relay Node transmits the DELBA frame to the STA at timing t46.

The STA receives the DELBA frame transmitted from the Relay Node, and transmits an ACK frame to the Relay Node at timing t47. The Relay Node receives the ACK frame transmitted from the STA.

The Source Node performs Data Transmission for transmitting a Data frame to the STA at timing t48. The STA receives the Data frame transmitted from the Source Node.

### <DL MLO Relay Final Reset Sequence>

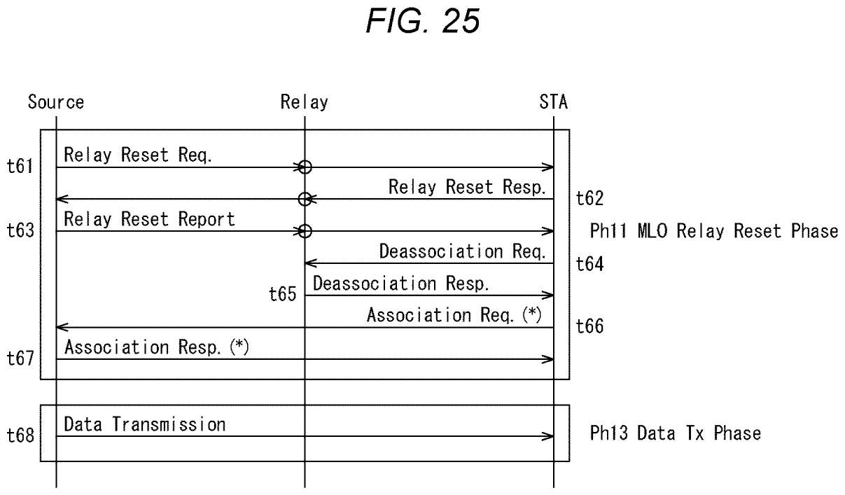

FIG. 25 is a diagram illustrating an example of a DL MLO Relay Final Reset sequence according to the first embodiment.

Processing from timing t61 to t67 in FIG. 25 is processing of the MLO Relay Reset Phase of the phase Ph11. Processing at timing t68 is processing of the phase Ph13 Data Tx Phase.

The Source Node transmits a Relay Reset Request frame to the Relay Node and the STA at timing t61.

The Relay Node and the STA receive a Relay Reset Request frame transmitted from the Source Node, and transmit a Relay Reset Response frame to the Source Node at timing t62.

The Source Node receives the Relay Reset Response frame transmitted from the Relay Node and the STA, and transmits the Relay Reset Report frame in FIG. 19 to the Relay Node and the STA at timing t63.

Note that the direct exchange of the control signals between the STA and the Source Node at the timings t61 to t63 is a case where the MLO Relay of the control signal is not set as described above.

Conversely, in a case where the MLO Relay of the control signal is set, the control signal is transmitted once via the Relay Node in the STA and the Source Node.

The STA receives a Relay Reset Report frame transmitted from the Source Node, and transmits a Deassociation (disconnection) Request frame, which is a disconnection request signal, to the Relay Node at timing t64.

The Relay Node receives the Deassociation Request frame transmitted from the STA, and transmits a Deassociation Response frame, which is a response signal to the disconnection request signal, to the STA at timing t65.

The STA receives the Deassociation Response frame transmitted from the Relay Node, and transmits an Association Request frame, which is a connection request signal, to the Source Node at timing t66.

The Source Node receives the Association Request frame transmitted from the STA, and transmits an Association Response frame, which is a response signal to the connection request signal, to the STA at timing t67.

The STA receives an Association Response frame transmitted from the Source Node.

Note that, at timings t66 and t67, asterisks are illustrated. This asterisk indicates that the processing is performed as necessary.

The Source Node performs Data Transmission for transmitting a Data frame to the STA at timing t68. The STA receives the Data frame transmitted from the Source Node.

### <UL MLO Relay Initial Setup Sequence>

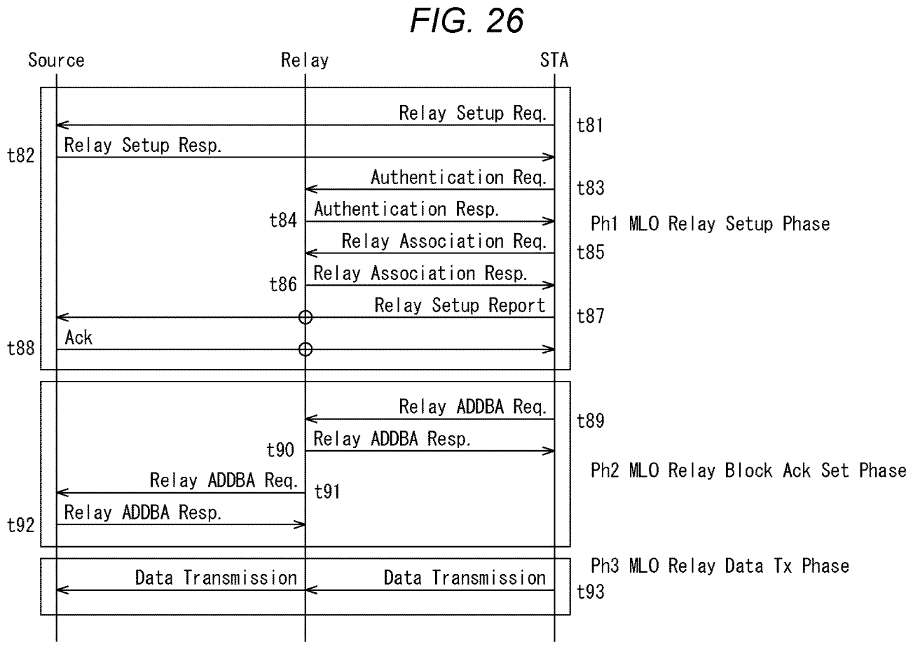

FIG. 26 is a diagram illustrating an example of a UL MLO Relay Initial Setup (initial setting) sequence according to the first embodiment.

Processing from timing t81 to t88 in FIG. 26 is processing of the MLO Relay Setup Phase of the phase Ph1. Processing from timing t89 to t92 is processing of the phase Ph2 MLO Relay Block Ack Set Phase. Processing at timing t93 is processing of the phase Ph3 MLO Relay Data Tx Phase.

At timing t81, the STA transmits a Relay Setup Request frame in FIG. 15 to the Source Node.

The Source Node receives the Relay Setup Request frame transmitted from the STA, and transmits the Relay Setup Response frame in FIG. 16 to the STA at timing t82.

The STA receives the Relay Setup Response frame transmitted from the Source Node, and transmits an Authentication Request frame to the Relay Node at timing t83.

The Relay Node receives an Authentication Request frame transmitted from the STA, and transmits an Authentication Response frame to the STA at timing t84.

The STA receives the Authentication Response frame transmitted from the Relay Node, and transmits the Relay Association Request frame in FIG. 17 to the Relay Node at timing t85.

The Relay Node receives the Relay Association Request frame transmitted from the STA, and transmits the Relay Association Response frame in FIG. 18 to the STA at timing t86.

The STA receives the Relay Association Response frame transmitted from the Relay Node, and transmits the Relay Setup Report frame in FIG. 19 to the Source Node at timing t87.

The Source Node receives the Relay Setup Report frame transmitted from the STA, and transmits an Ack frame, which is a response to the Relay Setup Report frame, to the STA at timing t88.

Note that the direct exchange of the control signals between the STA and the Source Node at timings t87 and t88 is a case where the MLO Relay of the control signal is not set as described above. Conversely, in a case where the MLO Relay of the control signal is set, the control signal is transmitted once via the Relay Node in the STA and the Source Node.

The STA receives the Ack frame transmitted from the Source Node, and transmits the Relay ADDBA Request frame in FIG. 20 to the Relay Node at timing t89.

The Relay Node receives the Relay ADDBA Request frame transmitted from the STA, and transmits the Relay ADDBA Response frame in FIG. 21 to the STA at timing t90.

The STA receives the Relay ADDBA Response frame transmitted from the Relay Node.

The Relay Node transmits the Relay ADDBA Request frame in FIG. 20 to the Source Node at timing t91.

The Source Node receives the Relay ADDBA Request frame transmitted from the Relay Node, and transmits the Relay ADDBA Response frame in FIG. 21 to the Relay Node at timing t92. The Relay Node receives a Relay ADDBA Response frame transmitted from the Source Node.

At timing t93, the STA performs Data Transmission for transmitting a Data frame to the Relay Node. The Relay Node receives the Data frame transmitted from the STA, and performs relay communication with the Source Node by the processing method described above with reference to FIG. 9. The Source Node receives a Data frame transmitted from the Relay Node.

### <UL MLO Relay Setup Sequence>

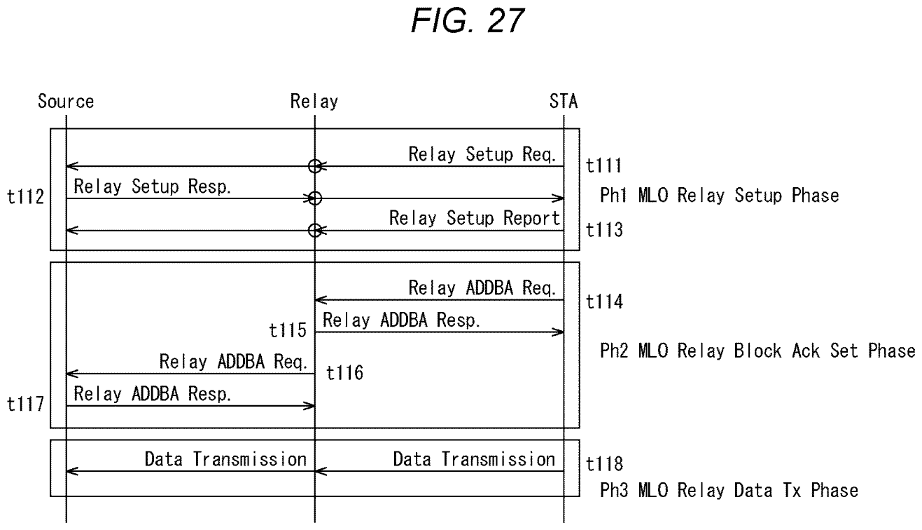

FIG. 27 is a diagram illustrating an example of a UL MLO Relay Setup sequence according to the first embodiment.

Processing from timing till to t113 in FIG. 27 is processing of the MLO Relay Setup Phase of the phase Ph1. Processing from timing t114 to t117 is processing of the phase Ph2 MLO Relay Block Ack Set Phase. Processing at timing t118 is processing of the phase Ph3 MLO Relay Data Tx Phase.

At timing t111, the STA transmits a Relay Setup Request frame in FIG. 15 to the Relay Node and the Source Node.

The Relay Node and the Source Node receive the Relay Setup Request frame transmitted from the STA, and transmit the Relay Setup Response frame in FIG. 16 to the STA at timing t112.

The STA receives the Relay Setup Response frame transmitted from the Relay Node and the Source Node, and transmits the Relay Setup Report frame in FIG. 19 to the Relay Node and the Source Node at timing t113. The Relay Node and the Source Node receive a Relay Setup Report frame transmitted from the STA.

Note that the direct exchange of the control signals between the STA and the Source Node at the timings t111 to t113 is a case where the MLO Relay of the control signal is not set as described above.

Conversely, in a case where the MLO Relay of the control signal is set, the control signal is transmitted once via the Relay Node.

At timing t114, the STA transmits the Relay ADDBA Request frame in FIG. 20 to the Relay Node.

The Relay Node receives the Relay ADDBA Request frame transmitted from the STA, and transmits the Relay ADDBA Response frame in FIG. 21 to the STA at timing t115. The STA receives the Relay ADDBA Response frame transmitted from the Relay Node.

The Relay Node transmits the Relay ADDBA Request frame in FIG. 20 to the Source Node at timing t116.

The Source Node receives the Relay ADDBA Request frame transmitted from the Relay Node, and transmits the Relay ADDBA Response frame in FIG. 21 to the Relay Node at timing t117. The Relay Node receives a Relay ADDBA Response frame transmitted from the Source Node.

At timing t118, the STA performs Data Transmission for transmitting a Data frame to the Relay Node. The Relay Node receives the Data frame transmitted from the STA, and performs relay communication with the Source Node by the processing method described above with reference to FIG. 9. The Source Node receives a Data frame transmitted from the Relay Node.

### <UL MLO Relay Reset Sequence>

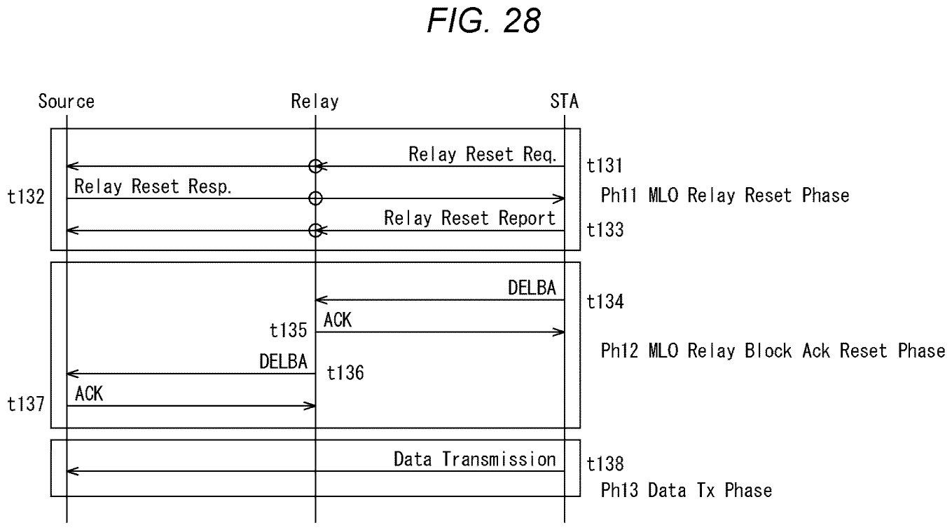

FIG. 28 is a diagram illustrating an example of a UL MLO Relay Reset sequence according to the first embodiment.

Processing from timing t131 to t133 in FIG. 28 is processing of the MLO Relay Reset Phase of the phase Ph11. Processing from timing t134 to t137 is processing of the phase Ph12 MLO Relay Block Ack Reset Phase. Processing at timing t138 is processing of the phase Ph13 Data Tx Phase.

At timing t131, the STA transmits a Relay Reset Request frame, which is a relay communication release request signal for requesting release of relay communication, to the Relay Node and the Source Node.

The Relay Node and the Source Node receive a Relay Reset Request frame transmitted from the STA, and transmit a Relay Reset Response frame, which is a relay communication release response signal in response to the relay communication release request signal, to the STA at timing t132.

The STA receives the Relay Reset Response frame transmitted from the Relay Node and the Source Node, and transmits the Relay Reset Report frame in FIG. 19 to the Relay Node and the Source Node at timing t133. The Relay Node and the Source Node receive a Relay Reset Report frame transmitted from the STA.

Note that the direct exchange of the control signals between the STA and the Source Node at the timings t131 to t133 is a case where the MLO Relay of the control signal is not set as described above. Conversely, in a case where the MLO Relay of the control signal is set, the control signal is transmitted once via the Relay Node.

At timing t134, the STA transmits a DELBA frame to the Relay Node.

The Relay Node receives the DELBA frame transmitted from the STA and transmits an ACK frame to the STA at timing t135. The STA receives the ACK frame transmitted from the Relay Node.

The Relay Node transmits the DELBA frame to the Source Node at timing t136.

The Source Node receives the DELBA frame transmitted from the Relay Node, and transmits an ACK frame to the Relay Node at timing t137. The Relay Node receives the ACK frame transmitted from the Source Node.

At timing t138, the STA performs Data Transmission for transmitting a Data frame to the Source Node. The Source Node receives a Data frame transmitted from the STA.

### <UL MLO Relay Final Reset Sequence>

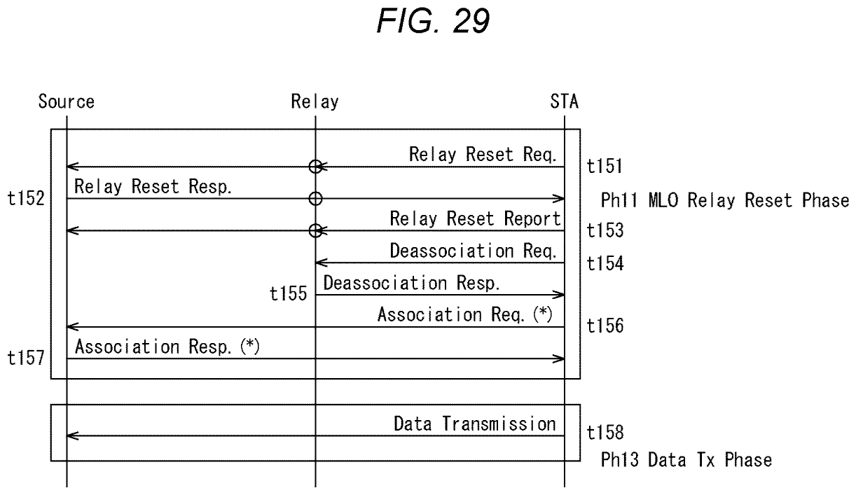

FIG. 29 is a diagram illustrating an example of a UL MLO Relay Final Reset sequence according to the first embodiment.

Processing from timing t151 to t157 in FIG. 29 is processing of the MLO Relay Reset Phase of the phase Ph11. Processing at timing t158 is processing of the phase Ph13 Data Tx Phase.

At timing t151, the STA transmits a Relay Reset Request frame to the Relay Node and the Source Node.

The Relay Node and the Source Node receive a Relay Reset Request frame transmitted from the STA, and transmit a Relay Reset Response frame to the STA at timing t152.

The STA receives the Relay Reset Response frame transmitted from the Relay Node and the Source Node, and transmits the Relay Reset Report frame in FIG. 19 to the Relay Node and the Source Node at timing t153. The Relay Node and the Source Node receive a Relay Reset Report frame transmitted from the STA.

Note that the direct exchange of the control signal between the STA and the Source Node at the timings t151 to t153 is a case where the MLO Relay of the control signal is not set as described above. Conversely, in a case where the MLO Relay of the control signal is set, the control signal is transmitted once via the Relay Node in the STA and the Source Node.

At timing t154, the STA transmits a Deassociation Request frame to the Relay Node.

The Relay Node receives the Deassociation Request frame transmitted from the STA, and transmits a Deassociation Response frame to the STA at timing t155.

The STA receives the Deassociation Response frame transmitted from the Relay Node, and transmits an Association Request frame in the Source Node at timing t156.

The Source Node receives the Association Request frame transmitted from the STA, and transmits an Association Response frame to the STA at timing t157.

Note that, at timings t156 and t157, asterisks are illustrated. This asterisk indicates that the processing is performed as necessary.

The STA receives the Association Response frame transmitted from the Source Node, and performs Data Transmission to transmit a Data frame to the Source Node at timing t158. The Source Node receives a Data frame transmitted from the STA.

### <Relay Setting or Releasing Processing in DL of Source Node>

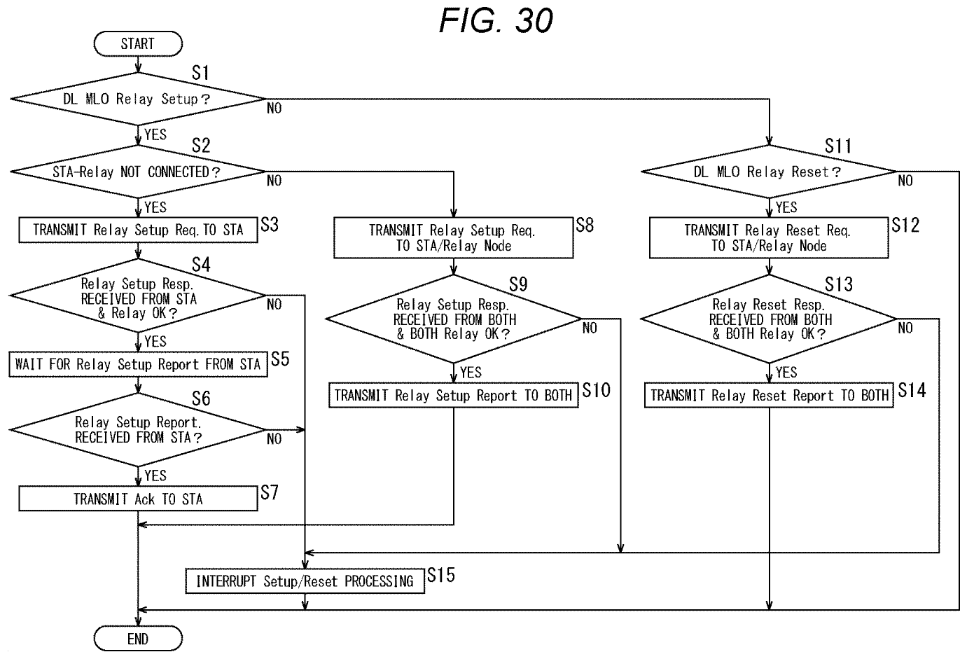

FIG. 30 is a flowchart for explaining DL MLO Relay setting or releasing processing of the Source Node according to the first embodiment.

In step S1, the communication control unit 55 of the Source Node determines whether or not to perform DL MLO Relay Setup. In a case where it is determined in step S1 that the DL MLO Relay Setup is performed, the processing proceeds to step S2.

Note that the communication control unit 55 of the Source Node may start MLO Relay Setup by receiving a frame including feedback information transmitted from the STA. The feedback information is information such as identification information and signal strength of surrounding APs. This frame may be defined by the IEEE 802.11 standard, or may be a newly defined frame such as an MLO Relay Setup frame.

In step S2, the communication control unit 55 of the Source Node determines whether or not the STA and the Relay Node are not connected. In a case where it is determined in step S2 that the STA and the Relay Node are not connected, the processing proceeds to step S3.

In steps S3 to S7, the DL Initial Setup processing in FIG. 22 is performed.

In step S3, the communication control unit 55 of the Source Node causes a Relay Setup Request frame to be transmitted to the STA. The STA receives the Relay Setup Request frame and transmits a Relay Setup Response frame (t2 in FIG. 22).

In step S4, the communication control unit 55 of the Source Node determines whether or not the Relay Setup Response frame transmitted from the STA has been received, and the Success Flag of the received Relay Setup Response frame is Relay OK.

In a case where it is determined in step S4 that the Relay Setup Response frame has been received and the Success Flag of the received Relay Setup Response frame is Relay OK, the processing proceeds to step S5.

In step S5, the communication control unit 55 of the Source Node waits until receiving the Relay Setup Report frame transmitted from the STA. The STA terminates the authentication and connection processing with the Relay Node and transmits a Relay Setup Report frame (t7 in FIG. 22).

In step S6, the communication control unit 55 of the Source Node determines whether or not a Relay Setup Report frame transmitted from the STA has been received.

In a case where it is determined in step S6 that the Relay Setup Report frame has been received, the processing proceeds to step S7.

In step S7, the communication control unit 55 of the Source Node causes an ACK frame to be transmitted to the STA. Thereafter, the DL MLO Relay setting processing of the Source Node ends.

In a case where it is determined in step S4 that the Relay Setup Response frame has not been received or the Success Flag of the received Relay Setup Response frame is Relay NG, the processing proceeds to step S15.

Also in a case where it is determined in step S6 that the Relay Setup Report frame has not been received, the processing proceeds to step 315.

On the other hand, in a case where it is determined in step S2 that the STA and the Relay Node are connected, the processing proceeds to step S8.

In steps S8 to S10, the DL Setup processing in FIG. 23 is performed.

In step S8, the communication control unit 55 of the Source Node transmits a Relay Setup Request frame to the STA and the Relay Node. The STA and the Relay Node receive the Relay Setup Request frame and transmit a Relay Setup Response frame (t22 in FIG. 23).

In step S9, the communication control unit 55 of the Source Node determines whether or not the Relay Setup Response frame transmitted from the both has been received, and the Success Flag of the received Relay Setup Response frame is Relay OK. Both in the case of FIG. 30 are a STA and a Relay Node.

In a case where it is determined in step S9 that the Relay Setup Response frame transmitted from the both has been received and the Success Flag of the received Relay Setup Response frame is Relay OK, the processing proceeds to step S10.

In step S10, the communication control unit 55 of the Source Node causes a Relay Setup Report frame to be transmitted to the both.

Note that, in step S10 described above, in a case where the Relay Setup Response frame from the STA is transmitted via the Relay Node, if possible, the Relay Node may collectively transmit the Relay Setup Response frame to the Source Node. In this case, the Success Flag is OK only in a case where both the STA and the Relay Node are Relay OK. Further, information indicating which Node is NG may be notified in Reason Code.

After step S10, the DL MLO Relay setting processing of the Source Node ends.

In a case where it is determined in step S9 that the Relay Setup Response frame transmitted from the both has not been received or the Success Flag of the received Relay Setup Response frame is Relay NG, the processing proceeds to step S15.

On the other hand, in a case where it is determined in step S1 that DL MLO Relay Setup is not to be performed, the processing proceeds to step S11.

In step S11, the communication control unit 55 of the Source Node determines whether or not to perform DL MLO Relay Reset. In a case where it is determined in step S11 that the DL MLO Relay Reset is performed, the processing proceeds to step 312.

In steps S12 to S14, the DL MLO Reset processing of FIG. 24 is performed.

In step 312, the communication control unit 55 of the Source Node transmits a Relay Reset Request frame to the STA and the Relay Node. The STA and the Relay Node receive a Relay Reset Request frame and transmit a Relay Reset Response frame (t42 in FIG. 24).

In step S13, the communication control unit 55 of the Source Node determines whether or not the Relay Reset Response frame transmitted from the both has been received, and the Success Flag of the received Relay Reset Response frame is Relay OK.

In a case where it is determined in step S13 that the Relay Reset Response frame transmitted from the both has been received and the Success Flag of the received Relay Reset Response frame is Relay OK, the processing proceeds to step S14.

Note that, in step S13 described above, in a case where the Relay Reset Response frame from the STA is transmitted via the Relay Node, if possible, the Relay Node may be combined into one Relay Reset Response frame and transmitted to the Source Node. In this case, the Success Flag is OK only in a case where both the STA and the Relay Node are Relay OK. Further, information indicating which Node is NG may be notified in Reason Code.

In step S14, the communication control unit 55 of the Source Node causes a Relay Reset Report frame to be transmitted to the both. After step S14, the DL MLO Relay releasing processing of the Source Node ends.

In a case where it is determined in step S13 that the Relay Reset Response frame transmitted from the both has not been received or the Success Flag of the received Relay Reset Response frame is Relay NG, the processing proceeds to step S15.

In step S15, the communication control unit 55 of the Source Node interrupts the Setup or Reset processing.

That is, in the processing of steps S4, S6, S9, S13, and the like described above, in a case where the Source Node has not been able to acquire any frame within a certain period of time, or in a case where Success Flag=“NG” has been returned from any device, the processing proceeds to step S15, and the interruption processing is performed. At this time, a Relay Setup Report frame set with Success Flag=“NG” may be transmitted to the STA or the Relay Node.

After step S15, the DL MLO Relay setting or releasing processing of the Source Node ends.

In a case where it is determined in step S11 that DL MLO Relay Reset is not to be performed, the DL MLO Relay setting or releasing processing of the Source Node ends.

### <Relay Setting or Releasing Processing in DL of STA>

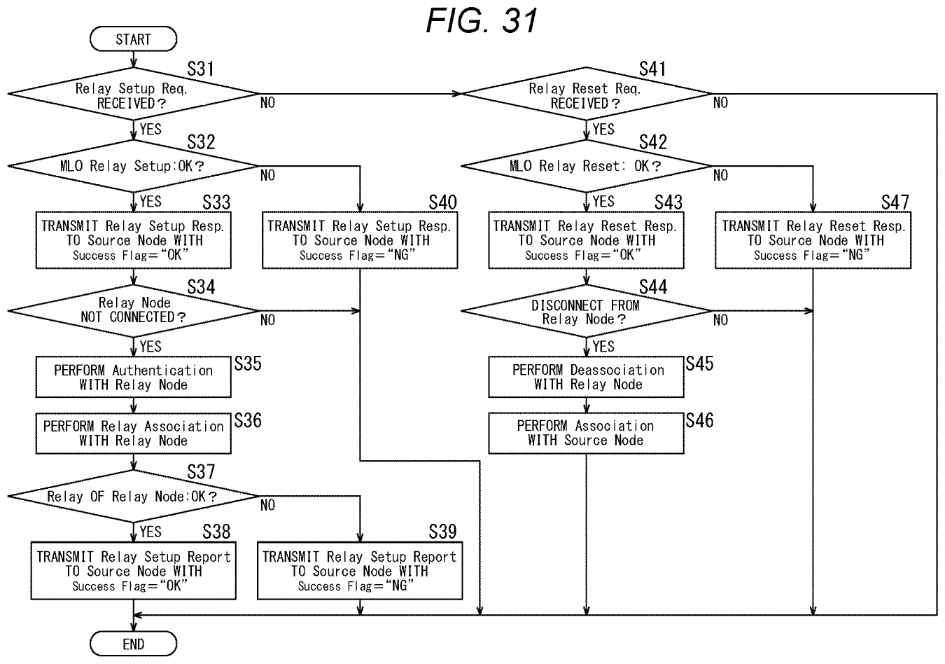

FIG. 31 is a flowchart for explaining DL MLO Relay setting or releasing processing of the STA according to the first embodiment.

In step S31, the communication control unit 145 of the STA determines whether or not a Relay Setup Request frame has been received. The Source Node transmits a Relay Setup Request frame (t1 in FIG. 22). In a case where it is determined in step S31 that the Relay Setup Request frame has been received, the processing proceeds to step S32.

Note that the communication control unit 145 of the STA may start MLO Relay Setup by receiving a frame including feedback information from the STA. The feedback information is information such as identification information and signal strength of surrounding APs. This frame may be defined by the IEEE 802.11 standard, or may be a newly defined frame such as an MLO Relay Setup frame.

In step S32, the communication control unit 145 of the STA determines whether or not MLO Relay Setup can be performed (OK). In a case where it is determined in step S32 that MLO Relay Setup can be performed, the processing proceeds to step S33.

In steps S33 to S39, the DL Initial Setup processing of FIG. 22 or the DL Setup processing of FIG. 23 is performed. Specifically, step S33 is common, but the case where the determination in step S34 is Yes is the DL Initial Setup processing in FIG. 22, and the case where the determination in step S34 is No is the DL Setup processing in FIG. 23.

In step S33, the communication control unit 145 of the STA transmits a Relay Setup Response frame to the Source Node with Success Flag=“OK”.

In step S34, the communication control unit 145 of the STA determines whether or not the Relay Node is not connected. In a case where it is determined in step S34 that the Relay Node is not connected, the processing proceeds to step S35.

In step S35, the communication control unit 145 of the STA performs Relay Node and Authentication.

In step S36, the communication control unit 145 of the STA performs Relay Association which is connection processing with the Relay Node.

Note that, in the connection processing, information of the MLO Relay supplied between the Source Node and the STA in the previous processing is transmitted to the Relay Node by exchanging a Relay Association Request (Response) frame.

The Relay Setup Report frame may be transmitted from the Relay Node to the Source Node if possible.

In a case of receiving a Relay Setup Response frame with Success Flag=“NG” from the Relay Node, the STA transmits a Relay Setup Response frame set with Success Flag “NG” to the Source Node. Note that, in this case, Reason Code of the Relay Setup Response frame transmitted in step S39 indicates a reason for rejection.

After the connection processing is completed, the STA basically manages connection information of the Source Node and the Relay Node. In a case where the relay direction is both the UL and DL directions, and the object of the frame to be relayed is all frames including the data signal and the control signal, the STA may discard the connection information of the Source Node once. In this case, in order to return to the original state, the STA needs to perform the Association processing with the Source Node again.

After the connection processing is completed, the STA skips the 4-Way Handshake which is the subsequent key information exchange processing. This is because the key information held by the STA is held as it is, and the packet decryption processing is performed using the held encryption key, regardless of the presence or absence of Relay communication.

In step S37, the communication control unit 145 of the STA determines whether or not the Relay of the Relay Node is OK on the basis of the connection state with the Relay. In a case where it is determined in step S37 that the Relay of the Relay Node is OK, the processing proceeds to step S38.

In step S38, the communication control unit 145 of the STA sets Success Flag=“OK”, and causes a Relay Setup Report frame to be transmitted to the Source Node.

In a case where it is determined in step S37 that the Relay of the Relay Node is NG, the processing proceeds to step S39.

In step S39, the communication control unit 145 of the STA sets Success Flag=“NG”, and causes a Relay Setup Report frame to be transmitted to the Source Node.

In a case where it is determined in step S34 that the Relay Node is connected, the DL MLO Relay setting processing of the STA ends.

In a case where it is determined in step S32 that MLO Relay Setup cannot be performed, the processing proceeds to step S40.

In step S40, the communication control unit 145 of the STA transmits a Relay Setup Response frame to the Source Node with Success Flag=“NG”. Thereafter, the DL MLO Relay setting processing of the STA ends.

On the other hand, in a case where it is determined in step S31 that the Relay Setup Request frame has not been received, the processing proceeds to step S41.

In step S41, the communication control unit 145 of the STA determines whether or not a Relay Reset Request frame has been received. The Source Node transmits a Relay Request frame (t61 in FIG. 25). In a case where it is determined in step S41 that the Relay Reset Request frame has been received, the processing proceeds to step S42.

In step S42, the communication control unit 145 of the STA determines whether or not MLO Relay Reset can be performed (OK). In a case where it is determined in step S42 that the MLO Relay Reset can be performed, the processing proceeds to step S43.

In steps S43 to S46, the DL Reset processing of FIG. 24 or the DL Final Reset processing of FIG. 25 is performed. Specifically, step S42 is common, but the case of Yes in step S44 is the DL Final Reset processing in FIG. 25, and the case of No in step S44 is the DL Reset processing in FIG. 24.

In step S43, the communication control unit 145 of the STA transmits a Relay Reset Response frame to the Source Node with Success Flag=“OK”.

In step S44, the communication control unit 145 of the STA determines whether or not to disconnect from the Relay Node. In a case where it is determined in step S44 that the Relay Node is disconnected, the processing proceeds to step S45.

Note that, as the determination of the disconnection in step S44, it may be determined whether or not it is unnecessary to perform the MLO Relay by the MLO Relay release of the present technology.

Furthermore, if the STA holds the connection information with the Source Node, the connection processing may be skipped.

In step S45, the communication control unit 145 of the STA performs Deassociation with the Relay Node.

In step S46, the communication control unit 145 of the STA performs Association which is connection processing with the Source Node.

In a case where it is determined in step S44 that the Relay Node is not disconnected, the DL MLO Relay releasing processing of the STA ends.

In a case where it is determined in step S42 that MLO Relay Setup cannot be performed, the processing proceeds to step S47.

In step S47, the communication control unit 145 of the STA transmits a Relay Reset Response frame to the Source Node with Success Flag=“NG”. Thereafter, the DL MLO Relay releasing processing of the STA ends.

In a case where it is determined in step S41 that the Relay Reset Request frame has not been received, the DL MLO Relay setting or releasing processing of the STA ends.

Note that, in a case where it is determined in the processing such as steps S32 and S42 described above that the MLO Relay Setup/Reset cannot be performed by itself, the Relay Setup or Reset Response frame is transmitted to the Source Node with Success Flag=“NG”. The determination criterion at this time is not particularly limited. For example, the determination may be made on the basis of a channel status or a traffic situation.

Note that, in this case, the reason for rejection is indicated by Reason Code of Relay Setup or Reset Response frame.

### <Relay Setting or Releasing Processing in UL of Source Node>

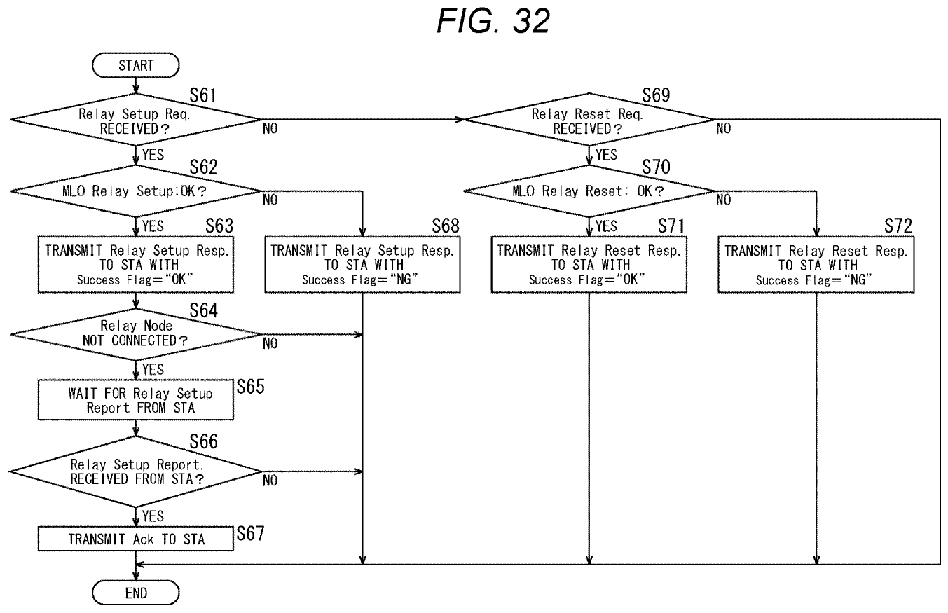

FIG. 32 is a flowchart for explaining UL MLO Relay setting or releasing processing of the Source Node according to the first embodiment.

In step S61, the communication control unit 55 of the Source Node determines whether or not a Relay Setup Request frame has been received. The STA transmits a Relay Setup Request frame (t81 in FIG. 26). In a case where it is determined in step S61 that the Relay Setup Request frame has been received, the processing proceeds to step S62.

In step S62, the communication control unit 55 of the Source Node determines whether or not MLO Relay Setup can be performed (OK). In a case where it is determined in step S62 that MLO Relay Setup can be performed, the processing proceeds to step 363.

In steps S63 to S67, the UL Initial Setup processing in FIG. 26 or the UL Setup processing in FIG. 27 is performed. Specifically, step S63 is common, but the case of Yes in step S64 is the UL Initial Setup processing in FIG. 26, and the case of No in step S64 is the UL Setup processing in FIG. 27.

In step S63, the communication control unit 55 of the Source Node transmits a Relay Setup Response frame to the STA with Success Flag=“OK”.

In step S64, the communication control unit 55 of the Source Node determines whether or not the Relay Node is not connected. In a case where it is determined in step S64 that the Relay Node is not connected, the processing proceeds to step S65.

In step S65, the communication control unit 55 of the Source Node waits for reception of the Relay Setup Report frame transmitted from the STA. The STA terminates the Relay Node, authentication, connection processing, and the like, and transmits a Relay Setup Report frame (t87 in FIG. 26).

In step S66, it is determined whether or not a Relay Setup Report frame transmitted from the STA has been received. In a case where it is determined in step S66 that the Relay Setup Report frame transmitted from the STA has been received, the processing proceeds to step S67.

In step S67, the communication control unit 55 of the Source Node causes an ACK frame to be transmitted to the STA. Thereafter, the UL MLO Relay setting processing of the Source Node ends.

In a case where it is determined in step S66 that the Relay Setup Report frame transmitted from the STA has not been received, the UL MLO Relay setting processing of the Source Node ends similarly.

In a case where it is determined in step S64 that the communication control unit 55 of the Source Node is connected to the Relay Node, the UL MLO Relay setting processing of the Source Node ends.

In a case where it is determined in step S62 that the communication control unit 55 of the Source Node cannot perform MLO Relay Setup, the processing proceeds to step S68.

In step S68, the communication control unit 55 of the Source Node sets Success Flag=“NG”, and causes the Relay Setup Report frame to be transmitted to the STA.

On the other hand, in a case where it is determined in step S61 that the Relay Setup Request frame has not been received, the processing proceeds to step S69.

In step S69, the communication control unit 55 of the Source Node determines whether or not a Relay Reset Request frame has been received. The STA transmits a Relay Reset Request frame (t131 in FIG. 28). In a case where it is determined in step S69 that the Relay Reset Request frame has been received, the processing proceeds to step S70.

In step S70, the communication control unit 55 of the Source Node determines whether or not MLO Relay Reset can be performed (OK). In a case where it is determined in step S70 that MLO Relay Setup can be performed, the processing proceeds to step S71.

In step S71, the UL Reset processing of FIG. 28 is performed.

In step S71, the communication control unit 55 of the Source Node transmits a Relay Reset Response frame to the STA with Success Flag=“OK”. Thereafter, the UL MLO Relay releasing processing of the Source Node ends.

In a case where it is determined in step S70 that MLO Relay Setup cannot be performed, the processing proceeds to step S72.

In step S72, the communication control unit 55 of the Source Node transmits a Relay Reset Response frame to the STA with Success Flag=“NG”. Thereafter, the UL MLO Relay releasing processing of the Source Node ends.

In a case where it is determined in step S69 that the Relay Reset Request frame has not been received, the UL MLO Relay setting or releasing processing of the Source Node ends.

Note that, in a case where it is determined in the processing such as steps S62 and S70 described above that the MLO Relay Setup/Reset cannot be performed by itself, the Relay Setup or Reset Response frame is transmitted to the STA with Success Flag=“NG”. The determination criterion at this time is not particularly limited. For example, the determination may be made on the basis of a channel status or a traffic situation. Note that, in this case, the reason for rejection is indicated by Reason Code.

### <Relay Setting or Releasing Processing in UL of STA>

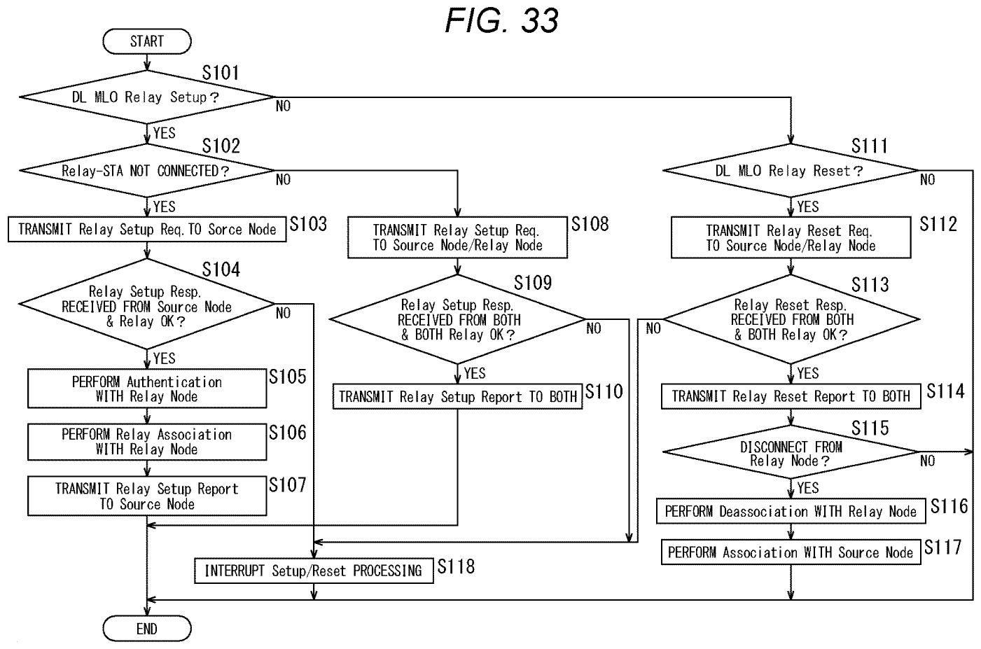

FIG. 33 is a flowchart for explaining UL MLO Relay setting or releasing processing of the STA according to the first embodiment.

In step S101, the communication control unit 145 of the STA determines whether or not to perform UL MLO Relay Setup. In a case where it is determined in step S101 that the UL MLO Relay Setup is performed, the processing proceeds to step S102.

Note that the communication control unit 145 of the STA may start MLO Relay Setup using a measurement result from the surrounding environment.

In step S102, the communication control unit 145 of the STA determines whether or not the STA and the Relay Node are not connected. In a case where it is determined in step S102 that the STA and the Relay Node are not connected, the processing proceeds to step S103.

In steps S103 to S107, the UL Initial Setup processing in FIG. 26 is performed.

In step S103, the communication control unit 145 of the STA causes a Relay Setup Request frame to be transmitted to the Source Node. The Source Node receives the Relay Setup Request frame and transmits a Relay Setup Response frame (t82 in FIG. 26).

In step S104, the communication control unit 145 of the STA determines whether or not the Relay Setup Response frame transmitted from the Source Node has been received, and the Success Flag of the received Relay Setup Response frame is Relay OK.

In a case where it is determined in step 3104 that the Relay Setup Response frame has been received and the Success Flag of the received Relay Setup Response frame is Relay OK, the processing proceeds to step S105.

In step S105, the communication control unit 145 of the STA performs Relay Node and Authentication.

In step S106, the communication control unit 145 of the STA performs Relay Association which is connection processing with the Relay Node. Note that the connection processing is similar to the connection processing in step S36 in FIG. 31.

In step S107, the communication control unit 145 of the STA transmits a Relay Setup Report frame to the Source Node. Thereafter, the UL MLO Relay setting processing of the STA ends.

In a case where it is determined in step S104 that the Relay Setup Response frame has not been received or the Success Flag of the received Relay Setup Response frame is Relay NG, the processing proceeds to step S118.

On the other hand, in a case where it is determined in step S102 that the STA and the Relay Node are connected, the processing proceeds to step S108.

In steps S108 to S110, the UL Setup processing in FIG. 27 is performed.

In step S108, the communication control unit 145 of the STA transmits a Relay Setup Request frame to the Source Node and the Relay Node. The Source Node and the Relay Node receive a Relay Setup Request frame and transmit a Relay Setup Response frame (t112 in FIG. 27).

In step S109, the communication control unit 145 of the STA determines whether or not the Relay Setup Response frame transmitted from the both has been received, and the Success Flag of the received Relay Setup Response frame is Relay OK. Both in the case of FIG. 33 are a Source Node and a Relay Node.

In a case where it is determined in step 3109 that the Relay Setup Response frame transmitted from the both has been received and the Success Flag of the received Relay Setup Response frame is Relay OK, the processing proceeds to step S110.

In step S110, the communication control unit 145 of the STA causes a Relay Setup Report to be transmitted to the both.

Note that, in step S110 described above, in a case where the Relay Setup Response frame from the Source Node is transmitted via the Relay Node, if possible, the Relay Node may collectively transmit the Relay Setup Response frame to the STA. In this case, the Success Flag is OK only in a case where both the Source Node and the Relay Node are Relay OK. Further, information indicating which Node is NG may be notified by Reason Code of Relay Setup Response frame.

After step S110, the UL MLO Relay setting processing of the STA ends.

In a case where it is determined in step S109 that the Relay Setup Response frame transmitted from the both has not been received or the Success Flag of the received Relay Setup Response frame is Relay NG, the processing proceeds to step S118.

On the other hand, in a case where it is determined in step S101 that UL MLO Relay Setup is not to be performed, the processing proceeds on to step S111.

In step S111, the communication control unit 145 of the STA determines whether or not to perform UL MLO Relay Reset. In a case where it is determined in step S111 that the UL MLO Relay Reset is performed, the processing proceeds to step S112.

In steps S112 to S117, the UL Reset processing of FIG. 28 or the UL Final Reset processing of FIG. 29 is performed. Specifically, steps S112 to S115 are common, but the case where the determination in step S115 is Yes is the UL Final Reset processing in FIG. 29, and the case where the determination in step S115 is NO is the UL Reset processing in FIG. 28.

In step S112, the communication control unit 145 of the STA transmits a Relay Reset Request frame to the Source Node and the Relay Node. The Source Node and the Relay Node receive a Relay Reset Request frame and transmit a Relay Reset Response frame (t132 in FIG. 28).

In step 3113, the communication control unit 145 of the STA determines whether or not the Relay Reset Response frame transmitted from the both has been received, and the Success Flag of the received Relay Reset Response frame is Relay OK.

In a case where it is determined in step S113 that the Relay Reset Response frame transmitted from the both has been received and the Success Flag of the received Relay Reset Response frame is Relay OK, the processing proceeds to step S114.

Note that, in step S113 described above, in a case where the Relay Reset Response frame from the Source Node is transmitted via the Relay Node, if possible, the Relay Node may collectively transmit one Relay Reset Response frame to the STA. In this case, the Success Flag is OK only in a case where both the STA and the Relay Node are Relay OK. Further, information indicating which Node is NG may be notified by Reason Code of Relay Reset Response frame.

In step S114, the communication control unit 145 of the STA causes a Relay Reset Report frame to be transmitted to the both.

In step S115, the communication control unit 145 of the STA determines whether or not to disconnect from the Relay Node. In a case where it is determined in step 3115 that the Relay Node is disconnected, the processing proceeds to step S116. Note that the determination of disconnection is similar to the processing in step S44 in FIG. 31.

In step S116, the communication control unit 145 of the STA performs Deassociation with the Relay Node.

In step S117, the communication control unit 145 of the STA performs Relay Association which is connection processing with the Source Node.

In a case where it is determined in step S115 that the Relay Node is not disconnected, the UL MLO Relay releasing processing of the STA ends.

In a case where it is determined in step S113 that the Relay Reset Response frame transmitted from the both has not been received or the Success Flag of the received Relay Reset Response frame is Relay NG, the processing proceeds to step S118.

In step S118, the communication control unit 145 of the STA interrupts the Setup or Reset processing.

That is, in the processing of steps S104, S109, S113, and the like described above, in a case where the Source Node has not been able to acquire any frame within a certain period of time, or in a case where Success Flag=“NG” has been returned from any device, the processing proceeds to step S118, and the interruption processing is performed. At this time, a Relay Setup Report frame set with Success Flag=“NG” may be transmitted to the Source Node or the Relay Node.

After step S118, the DL MLO Relay setting or releasing processing of the STA ends.

In a case where it is determined in step S111 that the UL MLO Relay Reset is not performed, the UL MLO Relay setting or releasing processing of the STA ends.

### <Relay Setting or Releasing Processing Common to DL and UL of Relay Node>

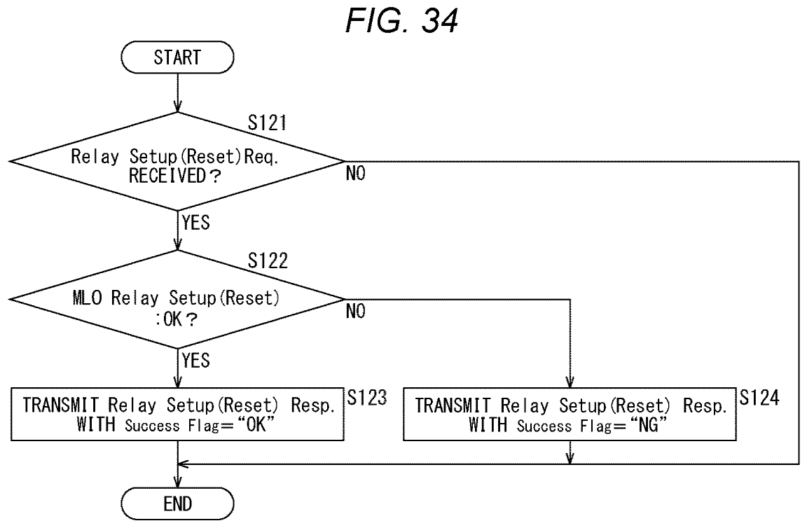

FIG. 34 is a flowchart for explaining MLO Relay setting or releasing processing common to DL and UL in the Relay Node according to the first embodiment.

Note that, although FIG. 34 illustrates the MLO Relay setting or releasing processing in the case of the setting processing, only the processing and the frame name “Relay Setup” are replaced with “Relay Reset”, and the MLO Relay setting or releasing processing is similarly performed in the case of the releasing process.

In step S121, the communication control unit 95 of the Relay Node determines whether or not a Relay Setup Request frame has been received. For example, the Source Node transmits a Relay Setup Request frame (t21 in FIG. 23). In a case where it is determined in step S121 that the Relay Setup Request frame has been received, the processing proceeds to step S122.

In step S122, the communication control unit 95 of the Relay Node determines whether or not MLO Relay Setup can be performed. In a case where it is determined in step S122 that the MLO Relay Setup can be performed, the processing proceeds to step S123.

The implementation determination criterion in step S122 is not particularly limited. For example, the determination may be made on the basis of the magnitude of Relay Buffer Size or a channel status. In this case, a reason for rejection is indicated in Reason Code of the Relay Setup Response frame.

In step S123, the communication control unit 95 of the Relay Node sets Success Flag=“OK”, and causes a Relay Setup Request frame to be transmitted to the Relay Setup Response frame of the transmitter. The transmitter of the Relay Setup Request frame is the Source Node or the STA.

In a case where it is determined in step S122 that MLO Relay Setup cannot be performed, the processing proceeds to step S124.

In step S124, the communication control unit 95 of the Relay Node sets Success Flag=“NG”, and causes a Relay Setup Request frame to be transmitted to the Relay Setup Response frame of the transmitter.

After step S123 or S124, the MLO Relay setting or releasing processing common to the DL and the UL of the Relay Node ends.

### <BA Setup Processing of Relay Node>

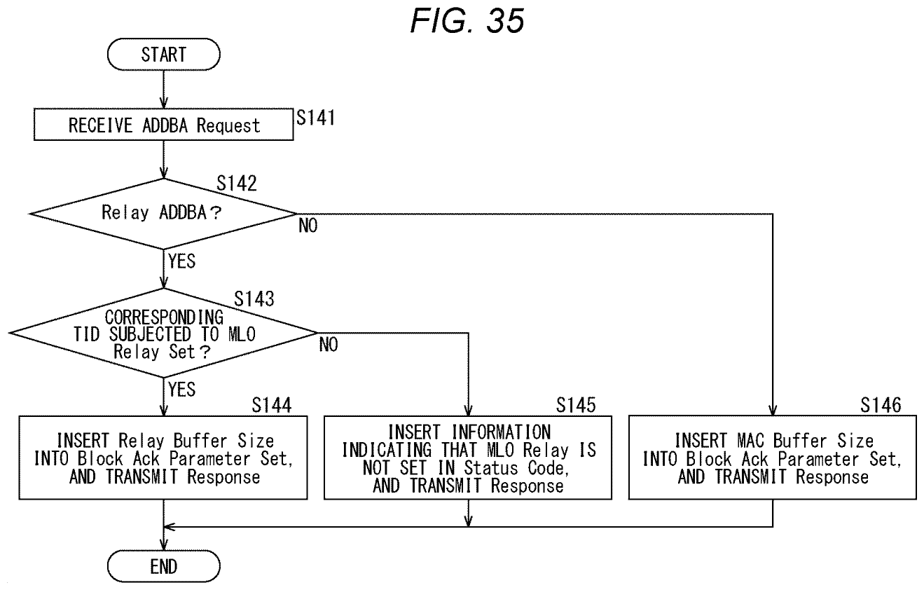

FIG. 35 is a flowchart for explaining BA Setup processing of the Relay Node according to the first embodiment.

In the MLO Relay Data Tx Phase of the phase Ph3, before the Source Node transmits the packet to which the Relay TID in which the MLO Relay is set is assigned, the Source Node transmits an ADDBA Request frame (t9 in FIG. 23).

In step S141, the communication control unit 95 of the Relay Node receives the ADDBA Request frame.

In step S142, the communication control unit 95 of the Relay Node determines whether the ADDBA indicated by the received ADDBA Request frame is the Relay ADDBA or the conventional ADDBA. In a case where it is determined in step S142 that the ADDBA indicated by the received ADDBA Request frame is Relay ADDBA, the processing proceeds to step S143.

In step S143, the communication control unit 95 of the Relay Node determines whether or not the TID designated in the received ADDBA Request frame has been subjected to the MLO Relay set. In a case where it is determined in step S143 that the TID designated in the received ADDBA Request frame has been subjected to the MLO Relay set, the processing proceeds on to step S144.

In step S144, the communication control unit 95 of the Relay Node inserts Relay Buffer Size into Block Ack Parameter Set, and causes Relay ADDBA Response to be transmitted to the Source Node.

That is, the communication control unit 95 of the Relay Node stores the memory size of the Relay Buffer 191 as the value of Buffer Size included in the Block Ack Set field of the Relay ADDBA Response, and causes the memory size to be transmitted to the Source Node.

In a case where it is determined in step S143 that the TID designated in the received ADDBA Request frame has not been subjected to the MLO Relay set, the processing proceeds to step S145.

In step S145, the communication control unit 95 of the Relay Node inserts information indicating that the MLO Relay is not set in the Status Code, and causes the Relay ADDBA Response frame to be transmitted to the Source Node.

In a case where it is determined in step S142 that the ADDBA indicated by the received ADDBA Request frame is the conventional ADDBA, the processing proceeds to step S146.

In step S146, the communication control unit 95 of the Relay Node inserts MAC Buffer Size into a Block Ack Parameter Set, and causes a conventional ADDBA Response frame to be transmitted to the Source Node.

That is, the communication control unit 95 of the Relay Node stores the memory size of the MAC Buffer as the value of Buffer Size included in the Block Ack Set field of the ADDBA Response frame, and causes the value to be transmitted to the Source Node.

Note that although FIG. 35 illustrates an example in which the Source Node is the Request transmission side, it similarly applies to a case where the STA is the Request transmission side.

### <BA Setup Processing of Source Node or STA>

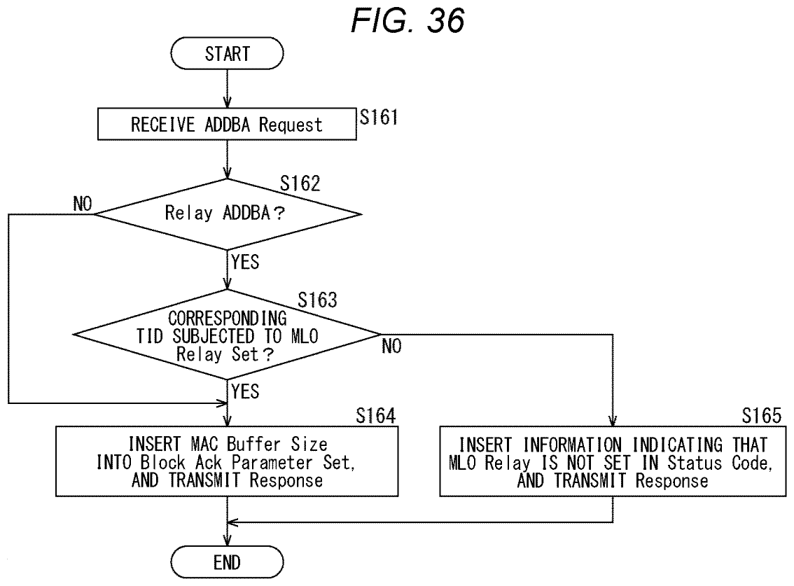

FIG. 36 is a flowchart for explaining BA Setup processing of the Source Node or the STA according to the first embodiment.

In the MLO Relay Data Tx Phase of the phase Ph3, the Relay Node transmits an ADDBA Request frame before the STA transmits the packet to which the TID in which the MLO Relay is set is assigned (t91 in FIG. 26).

In step S161, the communication control unit 55 of the Source Node receives the ADDBA Request frame.

In step S162, the communication control unit 55 of the Source Node determines whether the ADDBA indicated by the received ADDBA Request frame is Relay ADDBA or conventional ADDBA. In a case where it is determined in step S162 that the ADDBA indicated by the received ADDBA Request frame is Relay ADDBA, the processing proceeds to step S163.

In step 3163, the communication control unit 55 of the Source Node determines whether or not the TID designated in the received ADDBA Requestframe has been subjected to the MLO Relay set. In a case where it is determined in step 3163 that the TID designated in the received ADDBA Request frame has been subjected to the MLO Relay set, the processing proceeds on to step S164.

In addition, in a case where it is determined in step S162 that the ADDBA indicated by the received ADDBA Request frame is the conventional ADDBA, the processing proceeds to step S164.

In step S164, the communication control unit 55 of the Source Node inserts MAC Buffer Size into Block Ack Parameter Set, and causes a conventional ADDBA Response frame to be transmitted to the Source Node.

That is, the communication control unit 55 of the Source Node stores the memory size of the MAC Buffer as the value of Buffer Size included in the Block Ack Set field of the ADDBA Response frame, and causes the value to be transmitted to the Source Node.

In a case where it is determined in step S163 that the TID designated in the received ADDBA Request frame has not been subjected to the MLO Relay set, the processing proceeds to step S165.

In step S165, the communication control unit 55 of the Source Node inserts information indicating that the MLO Relay is not set in the Status Code, and causes the Relay ADDBA Response frame to be transmitted to the Relay Node.

Note that, in FIG. 36, an example in which the Source Node performs has been described, but it similarly applies to a case where the STA performs the Source Node.

### Effects of First Embodiment

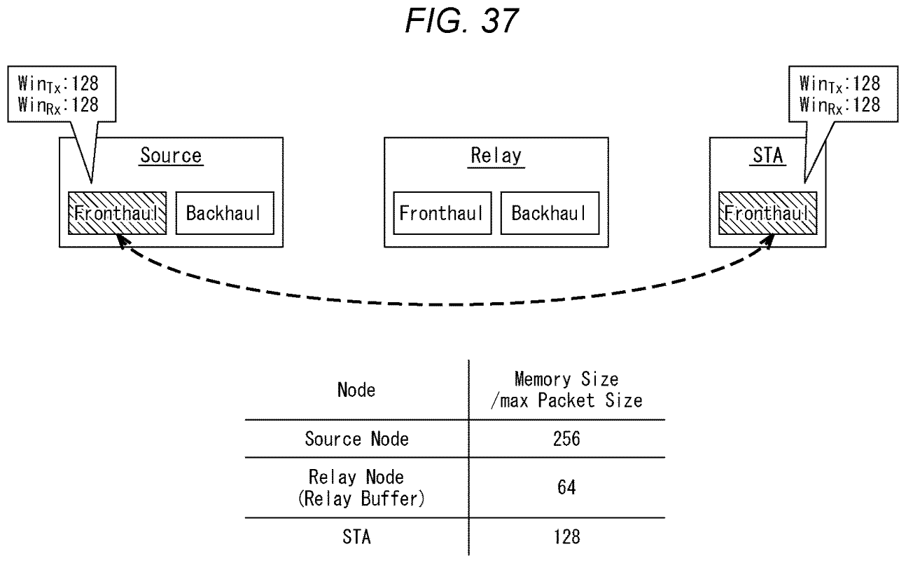

FIGS. 37 to 39 are diagrams illustrating effects of Relay BA Setup according to the first embodiment.

In FIGS. 37 to 39, each device of a Source Node, a Relay Node, and an STA is illustrated. In these devices, Window Size of ScoreBoard (retransmission determination) on the fronthaul link side with Fronthaul and Window Size of ScoreBoard on the backhaul link side with Backhaul are illustrated.

That is, Window Size of ScoreBoard (retransmission determination) on the fronthaul link side of the Source Node and the Relay Node, Window Size of ScoreBoard on the backhaul link side, and Window Size of ScoreBoard on the fronthaul link side of the STA are illustrated.

Here, for the sake of simplicity, the Window Size of each ScoreBoard is set to a smaller value obtained by dividing the max Packet Size from the memory size held by the transmission/reception device. Values obtained by dividing the max Packet Size from the memory size are 256, 64, and 128 for the Source Node, the Relay Buffer of the Relay Node, and the STA, respectively.

FIG. 37 is a diagram illustrating an example in the case of NO Relay.

In FIG. 37, transmission Window Size (hereinafter, Win_{TX}) and reception Window Size (hereinafter, Win_{RX}) of ScoreBoard on the fronthaul link side of Source Node are set to 128. Further, transmission Window Size (hereinafter, Win_{TA}) and reception Window Size (hereinafter, Wing_{RX}) of ScoreBoard on the fronthaul link side of the STA are set to 128.

Note that, since it is not an MLO Relay or a Relay, the Window Size of ScoreBoard on the backhaul link side of the Source Node and the Window Size of ScoreBoard on the fronthaul link side and the backhaul link side of the Relay Node are not set.

That is, in the case of FIG. 37, since the Source Node and the STA directly perform data communication in both the UL and the DL, Win_{TX} and Win_{RX} of ScoreBoard on the fronthaul link side of the Source Node and the STA are set to “128” from the memory size of the STA.

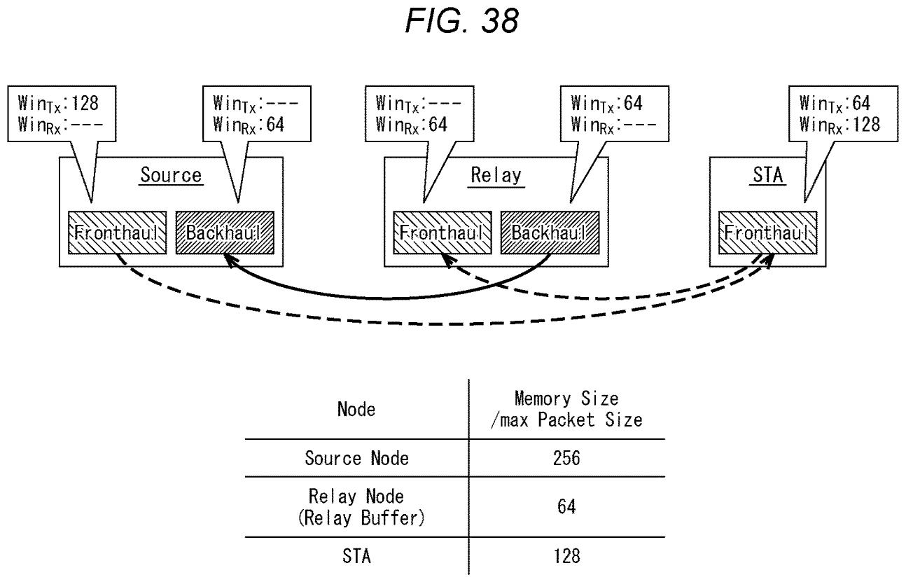

FIG. 38 is a diagram illustrating an example of a case where the UL MLO Relay is set.

In FIG. 38, 128 is set to Win_{TX} of ScoreBoard on the fronthaul link side of the Source Node, and 64 is set to Win_{RX} of ScoreBoard on the backhaul link side of the Source Node.

64 is set to Win_{RX} of ScoreBoard on the fronthaul link side of the Relay Node, and 64 is set to Win_{TX} of ScoreBoard on the backhaul link side of the Relay Node.

Win_{TX} on ScoreBoard on the fronthaul link side of the STA is set to 64, and Win_{RX} is set to 128.

That is, in a case where the UL MLO Relay is set from the state in FIG. 37, Win_{TX} on ScoreBoard on the fronthaul link side of the STA and Win_{RX} on ScoreBoard on the backhaul link side of the Source Node are changed as illustrated in FIG. 38, and “64” is set on the basis of the Relay Buffer 191 held by the Relay Node.

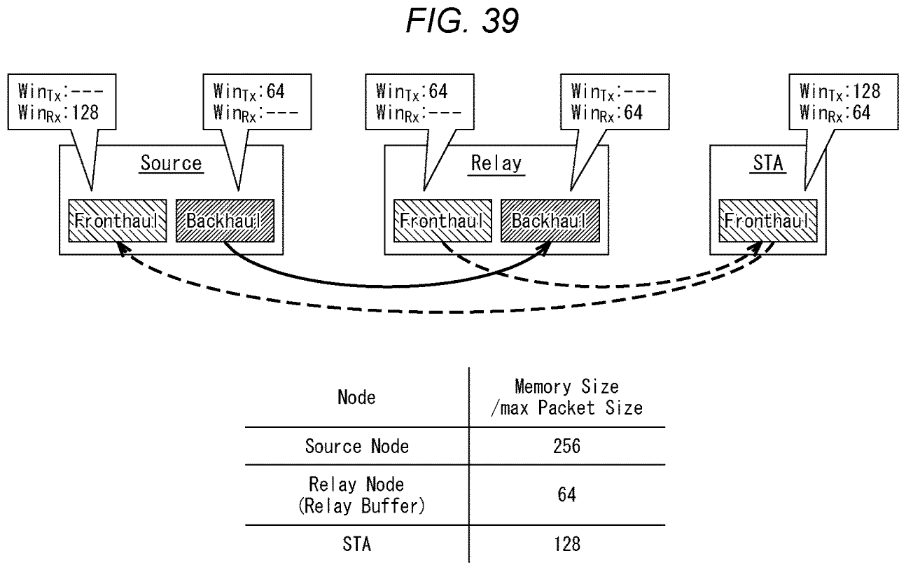

FIG. 39 is a diagram illustrating an example of a case where the DL MLO Relay is set.

In FIG. 39, 128 is set to Win_{R}z of ScoreBoard on the fronthaul link side of the Source Node, and 64 is set to Win_{TX} of ScoreBoard on the backhaul link side of the Source Node.

64 is set to Win_{TX} of ScoreBoard on the fronthaul link side of the Relay Node, and 64 is set to Win_{RX} of ScoreBoard on the backhaul link side of the Relay Node.

Win_{TX} on ScoreBoard on the fronthaul link side of the STA is set to 128, and Win_{RX} is set to 64.

That is, in a case where the DL MLO Relay is set from the state in FIG. 37, Win_{RX} of ScoreBoard on the fronthaul link side of the STA and Win_{TX} of ScoreBoard on the backhaul link side of the Source Node are changed as illustrated in FIG. 39, and “64” is set on the basis of the Relay Buffer 191 held by the Relay Node.

### <MLO Relay Data Tx Phase>

Next, details of the MLO Relay Data Tx Phase illustrated in FIG. 22 or 23 will be described.

First, the MLO Relay Data Tx Phase of Ph3 in DL will be described.

As described above, it is assumed that the phases Ph1 and Ph2 end and the DL MLO Relay is set. In this case, when transmitting a packet to the corresponding TID (hereinafter, referred to as a corresponding STA/TID) by the corresponding STA, the Source Node first transmits the packet to the Relay Node via the backhaul link. At that time, the RA field of the packet to be transmitted is set to the Relay Node. If possible, the address of the STA may be set in the Destination Address (DA) field. In a case where the DL Relay is “Disable”, the Source Node directly transmits a packet or a control signal to the STA.

In a case where the DL MLO Relay is set, when the Relay Node receives a packet to the corresponding STA/TID in the backhaul link, the individual data processing unit 171-1 of the backhaul link performs CRC Check/retransmission processing and then temporarily stores the packet in the Relay Buffer 191.

Thereafter, in a case where the fronthaul link can be transmitted, the individual data processing unit 171-2 of the fronthaul link receives the temporarily stored packet in the Relay Buffer 191 and transmits the packet to the STA. In this case, the TA field of the packet to be transmitted is set to the Relay Node. If possible, the address of the Source Node may be set in the Source Address (SA) field.

In a case where the DL Relay is “Disable”, the packet from the Source Node received on the backhaul link is processed after all data processing is performed once and transferred to the control unit 162 only when the RA indicates its own address.

In a case where the DL MLO Relay is set, the STA acquires a packet of the corresponding TID from the Relay Node via the fronthaul link. In a case where the TID of the packet received from the Relay Node is not the corresponding TID set by MLO Relay Setup, the packet is discarded after MAC header analysis. In addition, similarly, in a case where the DL Relay is “Disable”, the packet received from the Relay Node is discarded after MAC header analysis.

Next, the MLO Relay Data Tx Phase of Ph3 in UL will be described.

Similarly to the DL, in a case where the phase Ph1 and the phase Ph2 end and the UL MLO Relay is set, the STA transmits a packet to the Relay Node via the fronthaul link when transmitting the packet to the corresponding TID (hereinafter, referred to as a corresponding Source Node/TID) in the corresponding Source Node. At this time, the RA field of the packet to be transmitted is set to the Relay Node. If possible, the address of the Source Node may be set in the DA field of the packet to be transmitted.

In a case where the UL Relay is “Disable”, the STA directly transmits a packet or a control signal to the Source Node.

In a case where the UL MLO Relay is set, when the Relay Node receives a packet to the corresponding Source Node/TID on the fronthaul link, the individual data processing unit 171-1 of the fronthaul link performs CRC Check/retransmission processing and then temporarily stores the packet in the Relay Buffer 191. Thereafter, in a case where the backhaul link can be transmitted, the individual data processing unit 171-2 of the backhaul link receives the temporarily held packet and transmits the packet to the Source Node. At this time, the TA field of the packet to be transmitted is set in the Relay Node. If possible, the address of the STA may be set in the SA field of the packet to be transmitted.

In a case where the UL Relay is “Disable”, the packet from the STA received on the fronthaul link is processed after all the data processing is performed once and transferred to the control unit 162 only when the RA indicates its own address.

The Source Node acquires a packet of the corresponding TID from the Relay Node in the backhaul link. In a case where the TID of the packet received from the Relay Node is not the corresponding TID set by MLO Relay Setup, the packet is discarded after MAC header analysis.

In addition, similarly, in a case where the UL Relay is “Disable”, the packet received from the Relay Node is discarded after MAC header analysis.

### 3. SECOND EMBODIMENT

### <Overall Sequence During MLO Relay Setup>

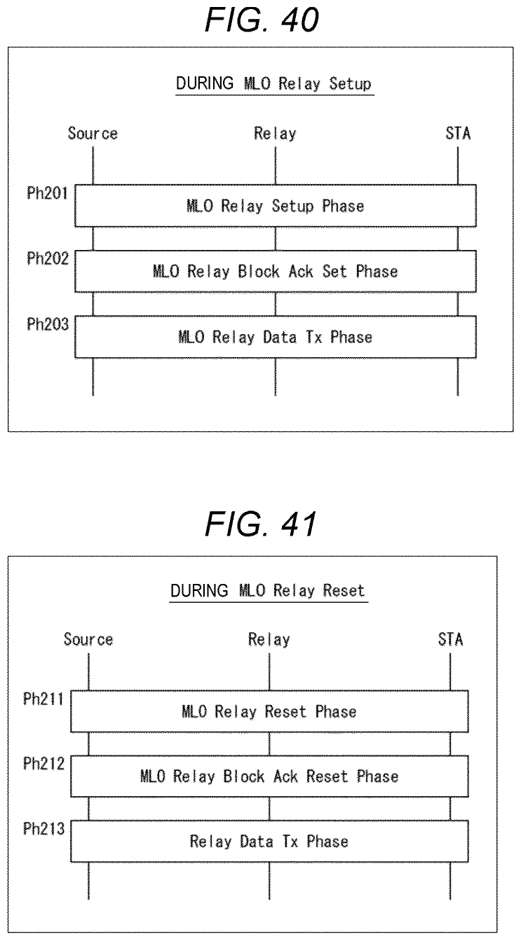

FIG. 40 is a diagram illustrating an overall sequence during MLO Relay Setup (setting) according to the second embodiment. Note that the flow of the overall sequence in FIG. 40 is similar to that of the example of the first embodiment in FIG. 11.

FIG. 40 illustrates, as a second embodiment, setting processing for transitioning from Relay Link to MLO Relay Link as described above with reference to FIG. 10.

In the phase Ph201 MLO Relay Setup Phase, the wireless communication system 1 performs setting processing for performing the MLO Relay.

In the phase Ph202 MLO Relay Block Ack Set Phase, the wireless communication system 1 performs Block Ack Setup processing for the MLO Relay.

In the phase Ph203 MLO Relay Data Tx Phase, the wireless communication system 1 performs transmission by the MLO Relay.

### <Overall Sequence During MLO Relay Reset>

FIG. 41 is a diagram illustrating an overall sequence during MLO Relay Reset (release) according to the second embodiment.

FIG. 41 illustrates, as a second embodiment, releasing processing for returning from the MLO Relay Link to the Relay Link as described above with reference to FIG. 10.

Note that the flow of the overall sequence in FIG. 41 is different from the example of the first embodiment in FIG. 12 in that the phase Ph3 Data Tx Phase is switched to the phase Ph213 Relay Data Tx Phase.

In the phase Ph211 MLO Relay Reset Phase, the wireless communication system 1 performs Reset processing for releasing the MLO Relay.

In the phase Ph212 MLO Relay Block Ack Reset Phase, the wireless communication system 1 performs Block Ack Reset processing for the MLO Relay.

In the phase Ph213 Relay Data Tx Phase, the wireless communication system 1 performs transmission between the Source Node and the STA via the Relay Node.

Configuration examples of the frame and the element used in the second embodiment are similar to those in the first embodiment.

### <DL MLO Relay Initial Setup Sequence>

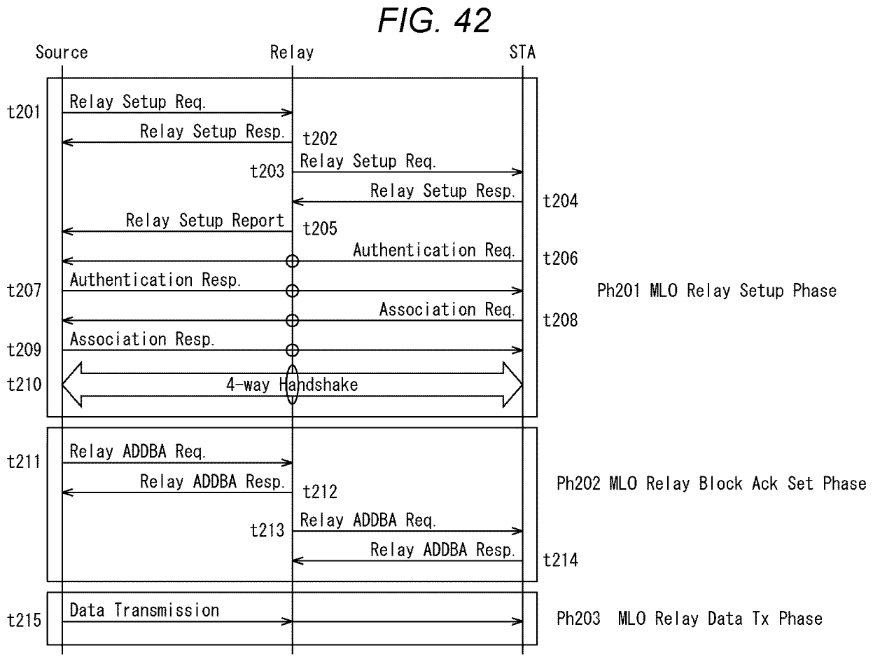

FIG. 42 is a diagram illustrating an example of a DL MLO Relay Initial Setup sequence according to the second embodiment.

Processing from timing t201 to t210 in FIG. 42 is processing of the MLO Relay Setup Phase of the phase Ph201. Processing from timing t211 to t214 is processing of the phase Ph202 MLO Relay Block Ack Set Phase. Processing at timing t215 is processing of the phase Ph203 MLO Relay Data Tx Phase.

The Source Node transmits the Relay Setup Request frame in FIG. 15 to the Relay Node at timing t201.

The Relay Node receives the Relay Setup Request frame transmitted from the Source Node, and transmits the Relay Setup Response frame in FIG. 16 to the Source Node at timing t202.

The Relay Node transmits the Relay Setup Request frame in FIG. 15 to the STA at timing t203.

The STA receives the Relay Setup Request frame transmitted from the Relay Node, and transmits the Relay Setup Response frame in FIG. 16 to the Relay Node at timing t204.

The Relay Node receives the Relay Setup Response frame transmitted from the STA, and transmits the Relay Setup Report frame in FIG. 19 to the Source Node at timing t205. The Source Node receives a Relay Setup Report frame transmitted from the Relay Node.

At timing t206, the STA transmits an Authentication Request frame to the Source Node.

The Source Node receives an Authentication Request frame transmitted from the STA, and transmits an Authentication Response frame to the STA at timing t207.

The STA receives the Authentication Response frame transmitted from the Relay Node, and transmits the Relay Association Request frame in FIG. 17 to the Source Node at timing t208.

The Source Node receives the Relay Association Request frame transmitted from the STA, and transmits the Relay Association Response frame in FIG. 18 to the STA at timing t209.

The STA receives the Relay Association Response frame transmitted from the Relay Node, and performs 4-Way Handshake that is key information exchange processing with the Source Node at timing t210.

Note that the direct exchange between the STA and the Source Node at the timings t206 to t210 is a case where the MLO Relay of the control signal is not set as described above. Conversely, in a case where the MLO Relay of the control signal is set, the control signal is transmitted once via the Relay Node in the STA and the Source Node.

The Source Node transmits the Relay ADDBA Request frame in FIG. 20 to the Relay Node at timing t211.

The Relay Node receives the Relay ADDBA Request frame transmitted from the Source Node, and transmits the Relay ADDBA Response frame in FIG. 21 to the Source Node at timing t212. The Source Node receives a Relay ADDBA Response frame transmitted from the Relay Node.

The Relay Node transmits the Relay ADDBA Request frame in FIG. 20 to the STA at timing t213.

The STA receives the Relay ADDBA Request frame transmitted from the Relay Node, and transmits the Relay ADDBA Response frame in FIG. 21 to the Relay Node at timing t214. The Relay Node receives the Relay ADDBA Response frame transmitted from the STA.

The Source Node performs Data Transmission for transmitting a Data frame to the Relay Node at timing t215. The Relay Node receives a Data frame transmitted from the Source Node, and performs relay communication with the STA by the processing method described above with reference to FIG. 9. The STA receives a Data frame transmitted from the Relay Node.

### <DL MLO Relay Setup Sequence>

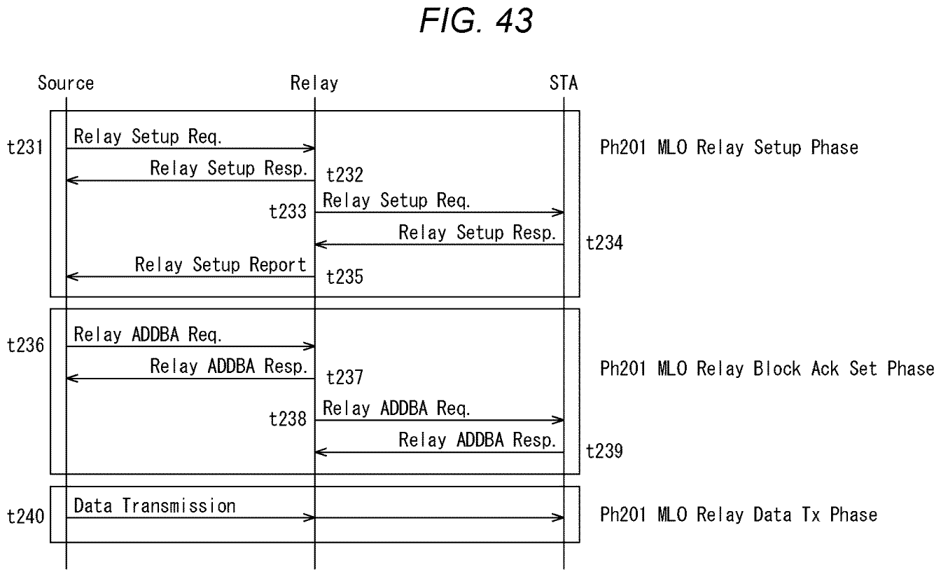

FIG. 43 is a diagram illustrating an example of a DL MLO Relay Setup sequence according to the second embodiment.

Processing from timing t231 to t235 in FIG. 43 is processing of the MLO Relay Setup Phase of the phase Ph201. Processing from timing t236 to t239 is processing of the phase Ph202 MLO Relay Block Ack Set Phase. Processing at timing t240 is processing of the phase Ph203 MLO Relay Data Tx Phase.

The Source Node transmits the Relay Setup Request frame in FIG. 15 to the Relay Node at timing t231.

The Relay Node receives the Relay Setup Request frame transmitted from the Source Node, and transmits the Relay Setup Response frame in FIG. 16 to the Source Node at timing t232. The Source Node receives a Relay Setup Response frame transmitted from the Relay Node.

The Relay Node transmits the Relay Setup Request frame in FIG. 15 to the STA at timing t233.

The STA receives the Relay Setup Request frame transmitted from the Relay Node, and transmits the Relay Setup Response frame in FIG. 16 to the Relay Node at timing t234.

The Relay Node receives the Relay Setup Response frame transmitted from the STA, and transmits the Relay Setup Report frame in FIG. 19 to the Source Node at timing t235.

The Source Node receives the Relay Setup Report frame transmitted from the Relay Node, and transmits the Relay ADDBA Request frame in FIG. 20 to the Relay Node at timing t236.

The Relay Node receives the Relay ADDBA Request frame transmitted from the Source Node, and transmits the Relay ADDBA Response frame in FIG. 21 to the Source Node at timing t237. The Source Node receives a Relay ADDBA Response frame transmitted from the Relay Node.

The Relay Node transmits the Relay ADDBA Request frame in FIG. 20 to the STA at timing t238.

The STA receives the Relay ADDBA Request frame transmitted from the Relay Node, and transmits the Relay ADDBA Response frame in FIG. 21 to the Relay Node at timing t239. The Relay Node receives the Relay ADDBA Response frame transmitted from the STA.

The Source Node performs Data Transmission for transmitting a Data frame to the Relay Node at timing t240. The Relay Node receives a Data frame transmitted from the Source Node, and performs relay communication with the STA by the processing method described above with reference to FIG. 9. The STA receives a Data frame transmitted from the Relay Node.

### <DL MLO Relay Reset Sequence>

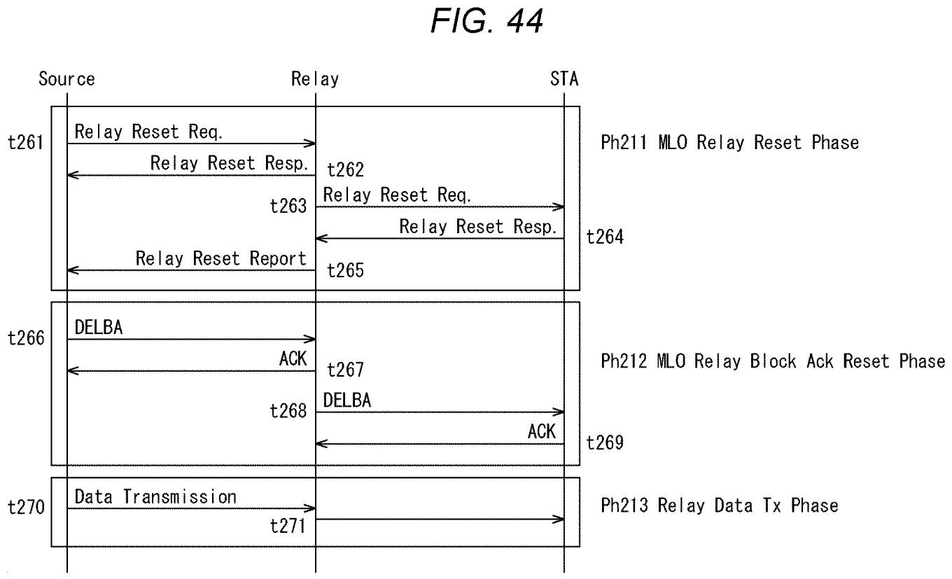

FIG. 44 is a diagram illustrating an example of a DL MLO Relay Reset sequence according to the second embodiment.

Processing from timing t261 to t265 in FIG. 44 is processing of the MLO Relay Reset Phase of the Ph211. Processing from timing t266 to t269 is processing of the Ph212 MLO Relay Block Ack Reset Phase. Processing at timings t270 and t271 is processing of the Ph213 Relay Data Tx Phase.

The Source Node transmits a Relay Reset Request frame to the Relay Node at timing t261.

The Relay Node receives a Relay Reset Request frame transmitted from the Source Node, and transmits a Relay Reset Response frame to the Source Node at timing t262. The Source Node receives a Relay Reset Response frame transmitted from the Relay Node.

The Relay Node transmits a Relay Reset Report frame to the STA at timing t263.

The STA receives a Relay Reset Request frame transmitted from the Relay Node, and transmits a Relay Reset Response frame to the Relay Node at timing t264.

The Relay Node receives the Relay Reset Response frame transmitted from the Relay Node, and transmits the Relay Reset Report frame in FIG. 19 to the Source Node at timing t265.

The Source Node receives the Relay Reset Report frame transmitted from the Relay Node, and transmits the DELBA frame to the Relay Node at timing t266.

The Relay Node receives the DELBA frame transmitted from the Source Node, and transmits an ACK frame to the Source Node at timing t267. The Source Node receives the ACK frame transmitted from the Relay Node.

The Relay Node transmits the DELBA frame to the STA at timing t268.

The STA receives the DELBA frame transmitted from the Relay Node, and transmits an ACK frame to the Relay Node at timing t269. The Relay Node receives the ACK frame transmitted from the STA.

The Source Node performs Data Transmission for transmitting a Data frame to the STA via the Relay Node at timings t270 and t271.

That is, the Source Node transmits a Data frame to the Relay Node at timing t270.

The Relay Node receives the Data frame transmitted from the Source Node, and transmits the Data frame to the STA at timing t271. The STA receives a Data frame transmitted from the Relay Node.

### <DL MLO Relay Final Reset Sequence>

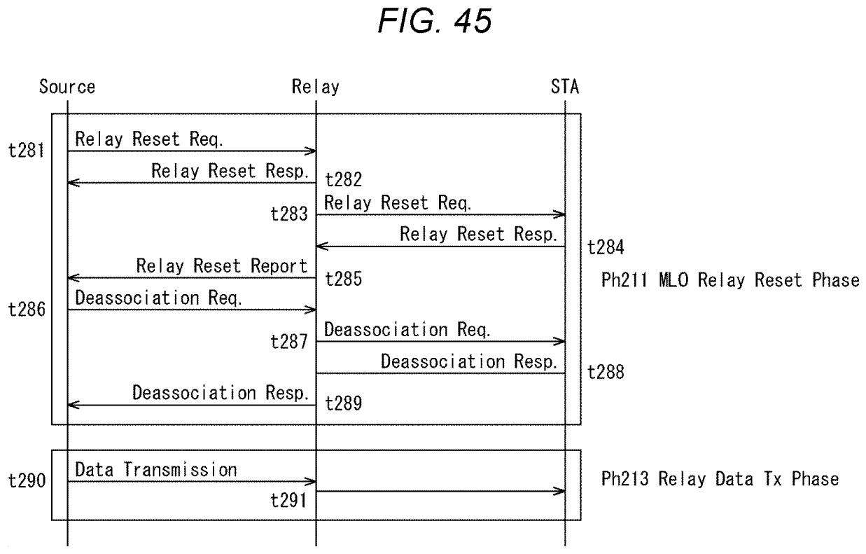

FIG. 45 is a diagram illustrating an example of a DL MLO Relay Final Reset sequence according to the second embodiment.

Processing from timing t281 to t289 in FIG. 45 is processing of the MLO Relay Reset Phase of the Ph211. Processing at timings t290 and t291 is processing of the Ph213 Relay Data Tx Phase.

The Source Node transmits a Relay Reset Request frame to the Relay Node at timing t281.

The Relay Node receives a Relay Reset Request frame transmitted from the Source Node, and transmits a Relay Reset Response frame to the Source Node at timing t282. The Source Node receives a Relay Reset Response frame transmitted from the Relay Node.

The Relay Node transmits a Relay Reset Request frame to the STA at timing t283.

The STA receives a Relay Reset Request frame transmitted from the Relay Node, and transmits a Relay Reset Response frame to the Relay Node at timing t284.

The Relay Node receives the Relay Reset Response frame transmitted from the STA, and transmits the Relay Reset Report frame in FIG. 19 to the Source Node at timing t285.

The Source Node receives the Relay Reset Report frame transmitted from the Relay Node, and transmits a Deassociation Request frame to the Relay Node at timing t286.

The Relay Node receives the Deassociation Request frame transmitted from the Source Node, and transmits the Deassociation Request frame to the STA at timing t287.

The STA receives the Deassociation Request frame transmitted from the Relay Node, and transmits the Deassociation Response frame on the Relay Node at timing t288.

The Relay Node receives the Deassociation Response frame transmitted from the STA, and transmits the Deassociation Response frame to the Source Node at timing t289. The Source Node receives a Deassociation Response frame transmitted from the Relay Node.

The Source Node performs Data Transmission for transmitting a Data frame to the STA via the Relay Node at timings t290 and t291.

That is, the Source Node transmits a Data frame to the Relay Node at timing t290.

The Relay Node receives the Data frame transmitted from the Source Node, and transmits the Data frame to the STA at timing t291. The STA receives a Data frame transmitted from the Relay Node.

Note that, in the sequence at the time of UL, basically, the Source Node and the Relay Node are only reversed in the sequence at the time of DL described above with reference to FIGS. 42 to 45, and the sequences are basically the same. Therefore, the sequence at the time of UL and the description thereof are omitted. Also, as for the processing illustrated in the following drawings, since the Source Node and the Relay Node are basically reversed for DL and UL, only the processing at the time of DL will be described below.

### <Relay Setting or Releasing Processing in DL of Source Node>

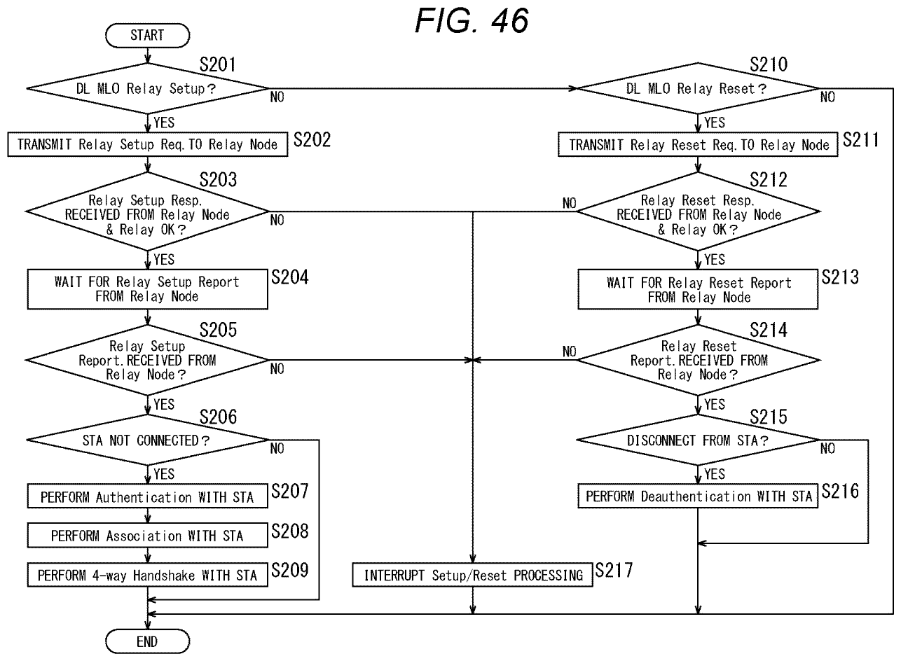

FIG. 46 is a flowchart for explaining DL MLO Relay setting or releasing processing of the Source Node according to the second embodiment.

In step S201, the communication control unit 55 of the Source Node determines whether or not to perform DL MLO Relay Setup. In a case where it is determined in step S201 that the DL MLO Relay Setup is performed, the processing proceeds to step S202.

Note that the communication control unit 55 of the Source Node may start MLO Relay Setup by receiving a frame including feedback information transmitted from the STA. The feedback information is information such as identification information and signal strength of surrounding APs. This frame may be defined by the IEEE 802.11 standard, or may be a newly defined frame such as an MLO Relay Setup frame.

Furthermore, in a case where the information exchange cannot be directly performed between the Source Node and the STA, the information exchange between the Source Node and the STA may be performed via the Relay Node.

In steps S202 to S209, the DL Initial Setup processing in FIG. 42 or the DL Setup processing in FIG. 43 is performed. Specifically, steps S202 to S205 are common, but the case where the determination in step S206 is Yes is the DL Initial Setup processing in FIG. 42, and the case where the determination in step S206 is NO is the DL Setup processing in FIG. 43.

In step S202, the communication control unit 55 of the Source Node causes a Relay Setup Request frame to be transmitted to the Relay Node. The Relay Node receives a Relay Setup Request frame and transmits a Relay Setup Response frame (t202 in FIG. 42).

In step S203, the communication control unit 55 of the Source Node determines whether or not the Relay Setup Response frame transmitted from the Relay Node has been received, and the Success Flag of the received Relay Setup Response frame is Relay OK.

In a case where it is determined in step S203 that the Relay Setup Response frame has been received and the Success Flag of the received Relay Setup Response frame is Relay OK, the processing proceeds to step S204. The Relay Node terminates transmission and reception of the Relay Setup Request frame and the Response frame with the STA, and transmits a Relay Setup Report frame (t205 in FIG. 42).

In step S204, the communication control unit 55 of the Source Node waits until the Relay Setup Report frame transmitted from the Relay Node is received.

In step S205, the communication control unit 55 of the Source Node determines whether or not a Relay Setup Report frame transmitted from the Relay Node has been received. In a case where it is determined in step S205 that the Relay Setup Report frame has been received, the processing proceeds to step S206.

In step S206, the communication control unit 55 of the Source Node determines whether or not the STA is not connected. In a case where it is determined in step S206 that the STA is not connected, the processing proceeds to step S207.

In step 3207, the communication control unit 55 of the Source Node performs Authentication with the STA.

In step S208, the communication control unit 55 of the Source Node performs Association with the STA.

In step S209, the communication control unit 55 of the Source Node performs 4-Way Handshake with the STA. Thereafter, the DL MLO Relay setting processing of the Source Node ends.

In a case where it is determined in step S206 that the communication control unit 55 of the Source Node is connected to the STA, the DL MLO Relay setting processing of the Source Node ends.

In a case where it is determined in step S205 that the Relay Setup Report frame has not been received, the processing proceeds to step S217.

Also in a case where it is determined in step S203 that the Relay Setup Response frame has not been received or the Success Flag of the received Relay Setup Response frame is Relay NG, the processing proceeds to step S217.

On the other hand, in a case where it is determined in step S201 that DL MLO Relay Setup is not to be performed, the processing proceeds to step S210.

In step S210, the communication control unit 55 of the Source Node determines whether or not to perform DL MLO Relay Reset. In a case where it is determined in step S210 that the DL MLO Relay Reset is performed, the processing proceeds to step S211.

In steps S211 to S216, the DL MLO Reset processing of FIG. 44 or the DL MLO Initial Reset processing of FIG. 45 is performed. Specifically, steps S211 to S214 are common, but the case where the determination in step S215 is Yes is the DL MLO Initial Reset processing in FIG. 45, and the case where the determination in step S215 is No is the DL MLO Reset processing in FIG. 44.

In step S211, the communication control unit 55 of the Source Node transmits a Relay Reset Request frame to the Relay Node. The Relay Node receives the Relay Setup Request frame and transmits a Relay Setup Response frame (t262 in FIG. 44).

In step S212, the communication control unit 55 of the Source Node determines whether or not the Relay Reset Response frame transmitted from the Relay Node has been received, and the Success Flag of the received Relay Reset Response frame is Relay OK.

In a case where it is determined in step S212 that the Relay Reset Response frame transmitted from the Relay Node has been received and the Success Flag of the received Relay Reset Response frame is Relay OK, the processing proceeds to step S213. The Relay Node terminates transmission and reception of the Relay Reset Request frame and the Response frame with the STA, and transmits a Relay Reset Report frame (t265 in FIG. 44).

In step S213, the communication control unit 55 of the Source Node waits for reception of the Relay Reset Report frame transmitted from the Relay Node.

In step S214, the communication control unit 55 of the Source Node determines whether or not a Relay Reset Report frame transmitted from the Relay Node has been received. In a case where it is determined in step S214 that the Relay Reset Report frame transmitted from the Relay Node has been received, the processing proceeds to step 3215.

In step S215, the communication control unit 55 of the Source Node determines whether or not to disconnect from the STA. In a case where it is determined in step S215 that the STA is disconnected, the processing proceeds to step S216.

In step S216, the communication control unit 55 of the Source Node performs Deauthentication with the STA.

In a case where it is determined in step S215 that the STA is not disconnected, the DL MLO Relay releasing processing of the Source Node ends.

In a case where it is determined in step 3212 that the Relay Reset Response frame transmitted from the Relay Node has not been received or the Success Flag of the received Relay Reset Response frame is Relay NG, the processing proceeds to step 3217.

In a case where it is determined in step S214 that the Relay Reset Report frame transmitted from the Relay Node has not been received, the processing also proceeds to step S217.

In step S217, the communication control unit 55 of the Source Node interrupts the Setup or Reset processing.

That is, in the processing of steps S203, S205, S212, S214, and the like described above, in a case where the Source Node has not been able to acquire any frame within a certain period of time, or in a case where Success Flag=“NG” has been returned from any device, the processing proceeds to step S217, and the interruption processing is performed. At this time, a Relay Setup Report frame set with Success Flag=“NG” may be transmitted to the Relay Node.

After step S217, the DL MLO Relay setting or releasing processing of the Source Node ends.

In a case where it is determined in step S210 that DL MLO Relay Reset is not to be performed, the DL MLO Relay setting or releasing processing of the Source Node ends.

### <Relay Setting or Releasing Processing in DL of Relay Node>

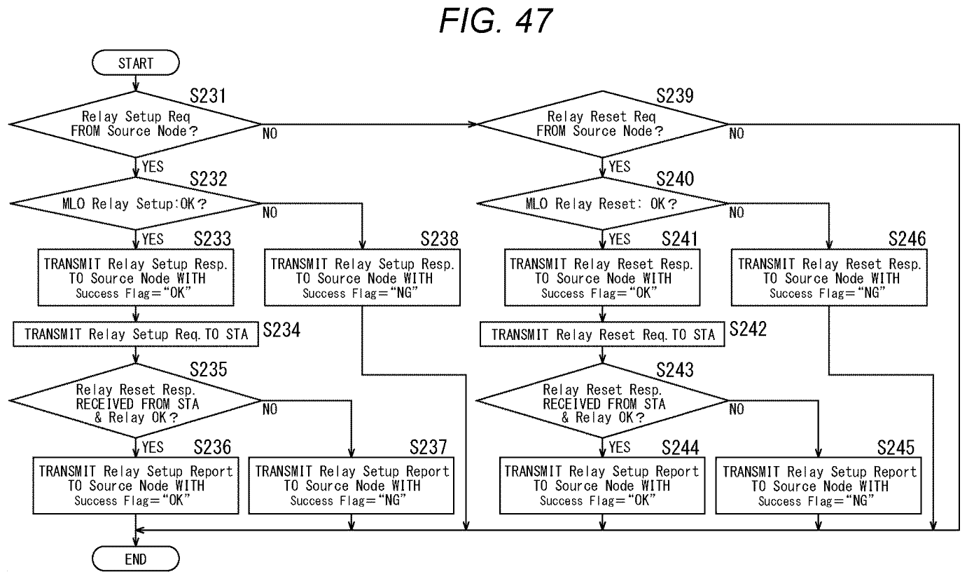

FIG. 47 is a flowchart for explaining an MLO Relay setting or releasing processing for DL of a Relay Node according to the second embodiment.

In step S231, the communication control unit 95 of the Relay Node determines whether or not a Relay Setup Request frame transmitted from the Source Node has been received. The Source Node transmits a Relay Setup Request frame or a Relay Reset Request frame (t201 in FIG. 42). In a case where it is determined in step S231 that the Relay Setup Request frame transmitted from the Source Node has been received, the processing proceeds to step S232.

That is, in the following steps S232 to S238, the DL Relay Initial Setup processing in FIG. 42 or the DL Relay Setup processing in FIG. 43 is performed.

In step S232, the communication control unit 95 of the Relay Node determines whether or not MLO Relay Setup can be performed. In a case where it is determined in step S232 that the MLO Relay Setup can be performed, the processing proceeds to step S233.

The implementation determination criterion in step S232 is not particularly limited. For example, the determination may be made on the basis of the magnitude of Relay Buffer Size or a channel status. In this case, a reason for rejection is indicated in Reason Code of the Relay Setup Response frame.

Furthermore, in a case where the Relay Node holds a packet to which a corresponding TID is assigned in the MAC Buffer, the Relay Node may reject the MLO Relay setting until all the transmissions are completed. In this case, information notifying that the corresponding packet in the MAC Buffer has disappeared may be transmitted from the Relay Node to the Source Node.

In step S233, the communication control unit 95 of the Relay Node sets Success Flag=“OK”, and causes a Relay Setup Response frame to be transmitted to the Source Node.

In step S234, the communication control unit 95 of the Relay Node causes a Relay Setup Request frame to be transmitted to the STA. The STA receives the Relay Setup Request frame and transmits a Relay Setup Response frame (t201 in FIG. 42).

In step S235, the communication control unit 95 of the Relay Node determines whether or not the Relay Setup Response frame transmitted from the STA has been received, and the Success Flag of the received Relay Setup Response frame is Relay OK.

In a case where it is determined in step S235 that the Relay Setup Response frame transmitted from the STA has been received and the Success Flag of the received Relay Setup Response frame is Relay OK, the processing proceeds to step S236.

In step S236, the communication control unit 95 of the Relay Node sets Success Flag=“OK”, and causes the Relay Setup Report frame to be transmitted to the Source Node.

In a case where it is determined in step S235 that the Relay Setup Response frame transmitted from the STA has not been received or the Success Flag of the received Relay Setup Response frame is Relay NG, the processing proceeds to step S237.

In step S237, the communication control unit 95 of the Relay Node sets Success Flag=“NG”, and causes the Relay Setup Report frame to be transmitted to Source.

After any one of steps S236 to S238, the MLO Relay setting processing for the DL of the Relay Node ends.

On the other hand, in a case where it is determined in step S231 that the Relay Setup Request frame transmitted from the Source Node has not been received, the processing proceeds to step S239.

In step S239, the communication control unit 95 of the Relay Node determines whether or not a Relay Reset Request frame transmitted from the Source Node has been received. In a case where it is determined that a Relay Reset Request frame transmitted from the Source Node has been received, the processing proceeds to step S240.

That is, in the following steps S240 to S246, the DL Relay Reset processing of FIG. 44 or the DL Relay Final Reset processing of FIG. 45 is performed.

In step S240, the communication control unit 95 of the Relay Node determines whether or not MLO Relay Reset can be performed. In a case where it is determined in step S240 that the MLO Relay Reset can be performed, the processing proceeds to step S241.

The implementation determination criterion in step S240 is also not particularly limited. Similarly to the implementation determination criterion in step S232, for example, the determination may be made on the basis of the size of the Relay Buffer 191 or the channel status. In this case, Reason Code of the Relay Reset Response frame indicates a reason for rejection.

In step S241, the communication control unit 95 of the Relay Node sets Success Flag=“OK”, and causes a Relay Reset Response frame to be transmitted to the Source Node. The Source Node receives a Relay Reset Response frame.

In step S242, the communication control unit 95 of the Relay Node causes a Relay Reset Request frame to be transmitted to the STA. The Source Node receives a Relay Reset Request frame and transmits a Relay Reset Response frame (t264 in FIG. 44).

In step S243, the communication control unit 95 of the Relay Node determines whether or not the Relay Reset Response frame transmitted from the STA has been received, and the Success Flag of the received Relay Reset Response frame is Relay OK.

In a case where it is determined in step S243 that the Relay Reset Response frame transmitted from the STA has been received and the Success Flag of the received Relay Reset Response frame is Relay OK, the processing proceeds to step S244.

In step S244, the communication control unit 95 of the Relay Node sets Success Flag=“OK”, and causes a Relay Reset Report to be transmitted to the Source.

In a case where it is determined in step S243 that the Relay Setup Response frame transmitted from the STA has not been received or the Success Flag of the received Relay Setup Response frame is Relay NG, the processing proceeds to step S245.

In step S245, the communication control unit 95 of the Relay Node sets Success Flag=“NG”, and causes a Relay Reset Report to be transmitted to the Source.

In a case where it is determined in step S240 that MLO Relay Reset cannot be performed, the processing proceeds to step S246.

In step S246, the communication control unit 95 of the Relay Node sets Success Flag=“NG”, and causes a Relay Reset Response frame to be transmitted to the Source Node.

After any one of steps S244 to S246, the MLO Relay releasing processing for the DL of the Relay Node ends.

### <Relay Setting or Releasing Processing in DL of STA>

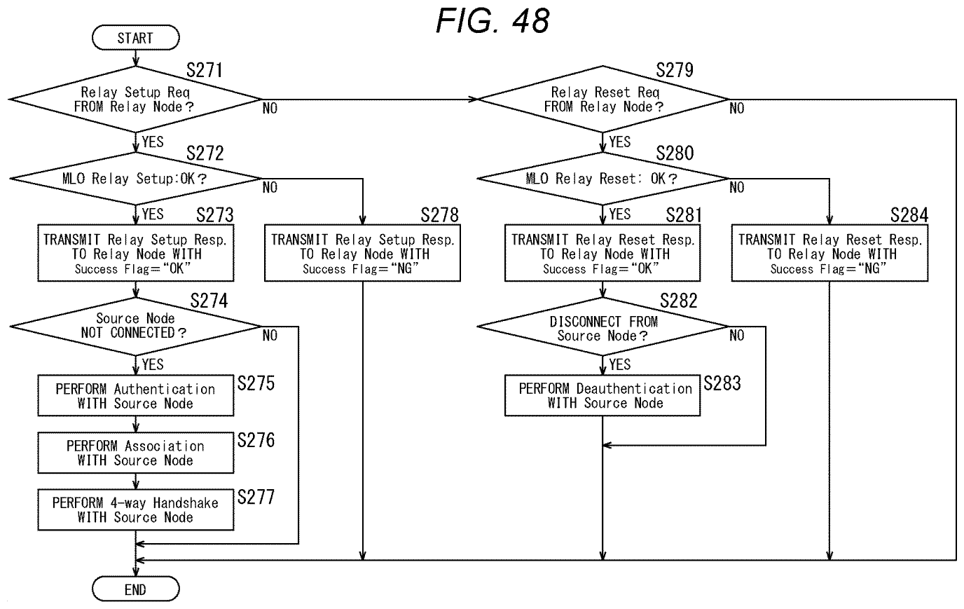

FIG. 48 is a flowchart for explaining DL MLO Relay setting or releasing processing of the STA according to the second embodiment. The Relay Node transmits a Relay Setup Request frame (t203 in FIG. 42).

In step S271, the communication control unit 145 of the STA determines whether or not a Relay Setup Request frame transmitted from the Relay Node has been received. In a case where it is determined in step S271 that the Relay Setup Request frame has been received, the processing proceeds to step S272.

Note that, in the following steps S272 to S278, the DL Initial Setup processing of FIG. 42 or the DL Setup processing of FIG. 43 is performed. Specifically, steps S272 to S273 and S278 are common, but the case where the determination in step S274 is Yes is the DL Initial Setup processing in FIG. 42, and the case where the determination in step S274 is NO is the DL Setup processing in FIG. 43.

In step S272, the communication control unit 145 of the STA determines whether or not MLO Relay Setup can be performed (OK). In a case where it is determined in step S272 that MLO Relay Setup can be performed, the processing proceeds to step S273.

In step S273, the communication control unit 145 of the STA transmits a Relay Setup Response frame to the Relay Node with Success Flag=“OK”.

In step S274, the communication control unit 145 of the STA determines whether or not the Source Node is not connected. In a case where it is determined in step S274 that the Source Node is not connected, the processing proceeds to step S275.

In step S275, the communication control unit 145 of the STA performs Authentication with the Source Node.

In step S276, the communication control unit 145 of the STA performs Relay Association which is connection processing with the Source Node.

In step S277, the communication control unit 145 of the STA performs Source Node and 4-Way Handshake.

Note that, in the above-described information exchange with the Source, in a case where the information exchange cannot be directly performed between the Source Node and the STA, the information exchange may be performed by relaying the Relay Node.

In a case where it is determined in step S272 that MLO Relay Setup cannot be performed, the processing proceeds to step S278.

In step S278, the communication control unit 145 of the STA transmits a Relay Setup Response frame to the Relay Node with Success Flag=“NG”.

After steps S277 and S278, the MLO Relay setting processing for the DL ends.

On the other hand, in a case where it is determined in step S271 that the Relay Setup Request frame transmitted from the Relay Node has not been received, the processing proceeds to step S279.

In step S279, the communication control unit 145 of the STA determines whether or not a Relay Reset Request frame transmitted from the Relay Node has been received. In a case where it is determined in step S279 that the Relay Reset Request frame transmitted from the Relay Node has been received, the processing proceeds to step S280.

Note that, in the following steps S280 to S284, the DL Reset processing of FIG. 44 or the DL Initial Reset processing of FIG. 45 is performed. Specifically, steps S280, S281, and S284 are common, but the case where the determination in step S282 is Yes is the DL Initial Reset processing in FIG. 45, and the case where the determination in step S282 is NO is the DL Reset processing in FIG. 44.

In step S280, the communication control unit 145 of the STA determines whether or not MLO Relay Reset can be performed. In a case where it is determined in step S280 that the MLO Relay Reset can be performed, the processing proceeds to step S281.

In step S281, the communication control unit 145 of the STA sets Success Flag=“OK”, and causes a Relay Reset Report frame to be transmitted to the Relay Node.

In step S282, the communication control unit 145 of the STA determines whether or not to disconnect from the Source Node. In a case where it is determined in step S282 that it is determined to disconnect from the Source Node, the processing proceeds to step S283.

Note that the disconnection in step S282 may be determined based on whether or not it is no longer necessary to perform the MLO Relay by the MLO Relay release of the present technology.

In step S283, the communication control unit 145 of the STA performs Deauthentication with the Source Node. Thereafter, the DL MLO Relay releasing processing of the STA ends.

In a case where it is determined in step S282 that the Source Node is not disconnected, the DL MLO Relay releasing processing of the STA ends.

In addition, in a case where it is determined in step S280 that MLO Relay Reset cannot be performed, the processing proceeds on to step S284.

In step S284, the communication control unit 145 of the STA sets Success Flag=“NG”, and causes a Relay Reset Report frame to be transmitted to the Relay Node. Thereafter, the DL MLO Relay releasing processing of the STA ends.

Note that, in a case where it is determined in the processing such as steps S272 and S282 described above that the MLO Relay Setup/Reset cannot be performed by itself, the Relay Setup or Reset Response frame is transmitted to the Relay Node with Success Flag=“NG”.

The determination criterion at this time is not particularly limited. For example, the determination may be made on the basis of a channel status or a traffic situation. In addition, in this case, the reason for rejection is indicated by Reason Code of Relay Setup or Reset Response frame.

### Effects of Second Embodiment

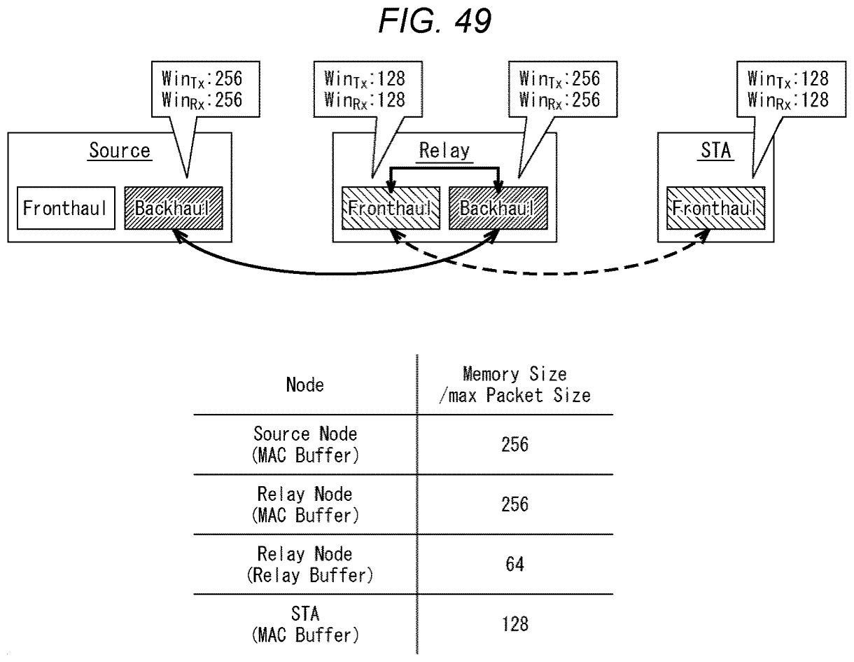

FIGS. 49 to 51 are diagrams illustrating effects of Relay BA Setup according to the second embodiment.

In FIGS. 49 to 51, similarly to FIGS. 37 to 39, Window Size of ScoreBoard (retransmission determination) on the fronthaul link side of the Source Node and the Relay Node, Window Size of ScoreBoard on the backhaul link side, and Window Size of ScoreBoard on the fronthaul link side of the STA are illustrated.

FIG. 49 is a diagram illustrating an example of a case of a conventional Relay.

In FIG. 49, 256 is set to Win_{TX} and Win_{RX} of ScoreBoard on the backhaul link side of Source Node.

Win_{TX} and Win_{RX} of ScoreBoard on the fronthaul link side of the Relay Node are set to 128. Win_{TX} and Win_{RX} of ScoreBoard on the backhaul link side of the Relay Node are set to 256.

Win_{TX} and Win_{RX} on ScoreBoard on the fronthaul link side of the STA are set to 128.

That is, in the case of FIG. 49, since the Source Node and the STA perform data communication for both the UL and the DL via the Relay, Win_{TX} and Win_{RX} of ScoreBoard on the backhaul link side of the Source Node and the Relay Node are set to “256” from the memory sizes of both. In addition, Win_{TX} and Win_{RX} of ScoreBoard on the fronthaul link side between the Relay Node and the STA are set to “128” from the memory size of the STA.

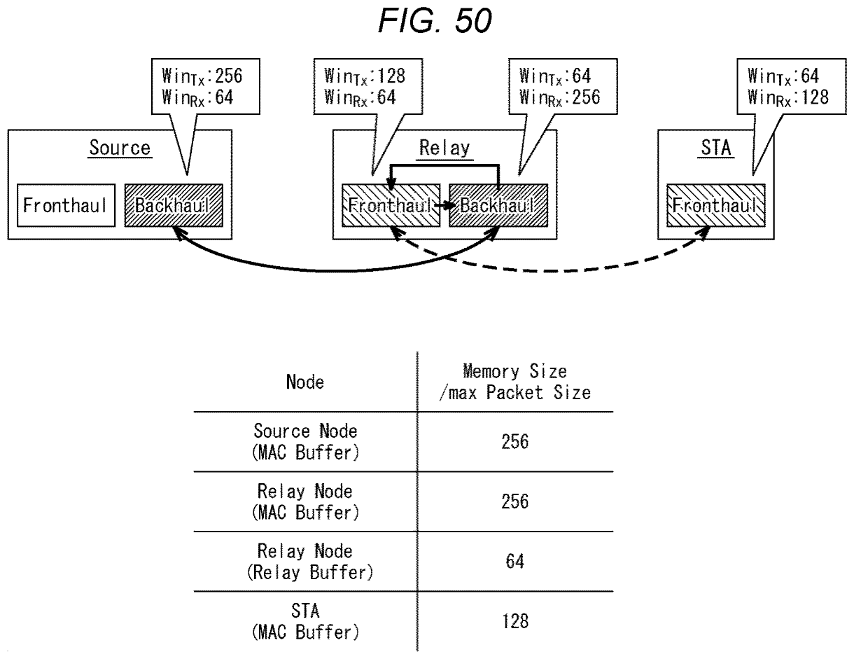

FIG. 50 is a diagram illustrating an example of a case where the UL MLO Relay is set.

In FIG. 50, Win_{TX} and Win_{RX} of ScoreBoard on the backhaul link side of Source Node are set to 256 and 64, respectively.

128 and 64 are set to Win_{TX} and Win_{RX} of ScoreBoard on the fronthaul link side of the Relay Node, respectively, and 64 and 256 are set to Win_{TX} and Win_{TX} of ScoreBoard on the backhaul link side of the Relay Node, respectively.

Win_{TX} and Win_{RX} on ScoreBoard on the fronthaul link side of the STA are set to 64 and 128, respectively.

That is, in a case where the UL MLO Relay is set from the state in FIG. 49, as illustrated in FIG. 50, Win_{TX} on ScoreBoard on the fronthaul link side of the STA, Win_{TX} on ScoreBoard on the backhaul link side of Source, Win_{RX} on the fronthaul link side of the Relay Node, and Win_{TX} on ScoreBoard on the backhaul link side are changed, and “64” is set on the basis of the Relay Buffer 191 held by the Relay Node.

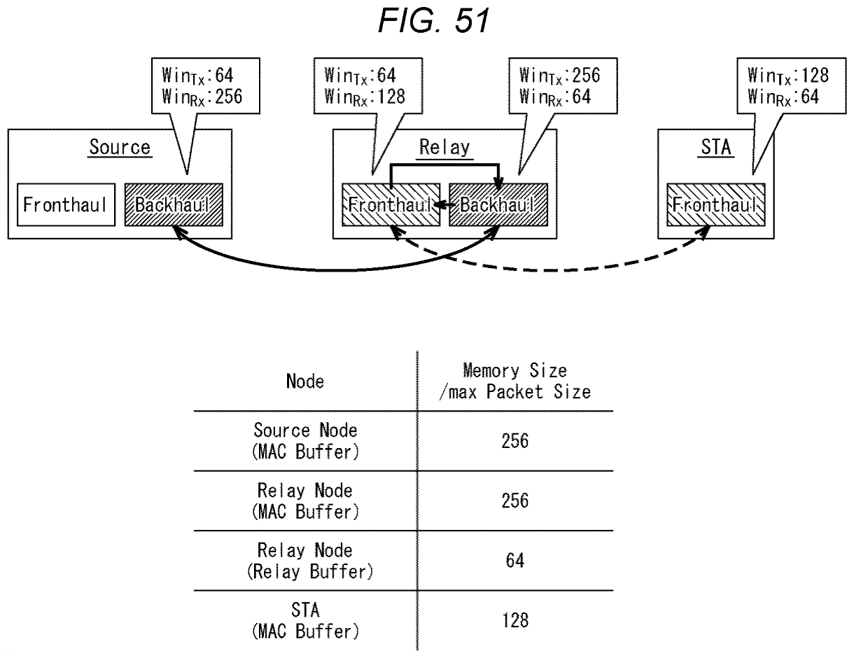

FIG. 51 is a diagram illustrating an example of a case where the DL MLO Relay is set.

In FIG. 51, Win_{TX} and Win_{RX} of ScoreBoard on the backhaul link side of Source Node are set to 64 and 256, respectively.

64 and 128 are set to Win_{TX} and Winₖ of ScoreBoard on the fronthaul link side of the Relay Node, respectively, and 64 and 256 are set to Win_{TX} and Win_{RX} of ScoreBoard on the backhaul link side of the Relay Node, respectively.

Win_{TX} and Win_{RX} on ScoreBoard on the fronthaul link side of the STA are set to 128 and 64, respectively.

That is, in a case where the DL MLO Relay is set from the state illustrated in FIG. 49, Win_{RX} on ScoreBoard on the fronthaul link side of the STA, Win_{TX} on ScoreBoard on the backhaul link side of the Source Node, Win_{TX} on the fronthaul link side of the Relay Node, and Win_{RX} on the backhaul link side are changed as illustrated in FIG. 51, and “64” is set on the basis of the Relay Buffer 191 held by the Relay Node.

### 4. OTHERS

### Effects of Present Technology

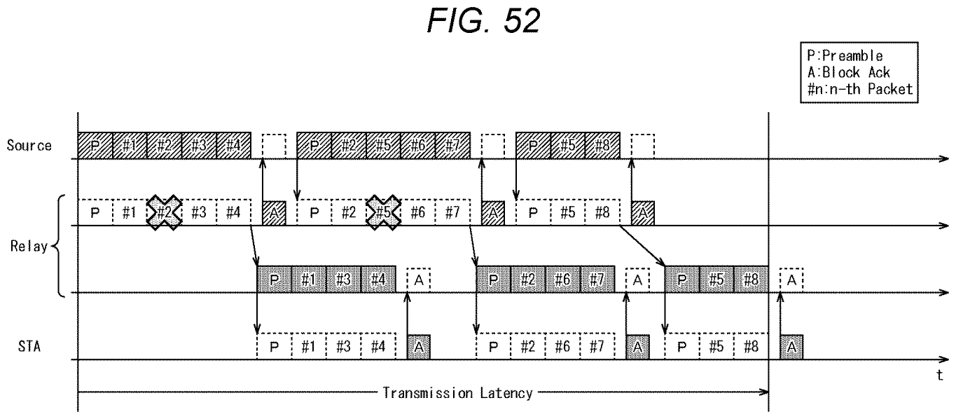

FIG. 52 is a diagram illustrating an example of effects of the present technology.

Similarly to FIG. 6, FIG. 52 illustrates an example in which packets #1 to #8 are transmitted from the Source Node to the STA via the Relay Node.

Note that, in the case of FIG. 52, examples of transmission and reception of data of the Source Node, the individual data processing unit 171-1 of the Relay Node, the individual data processing unit 171-2 of the Relay Node, and STA are illustrated in order from the top.

The packets #1 to #4 are transmitted from the Source Node to the Relay Node. At that time, it is assumed that only the packet #2 is damaged on the reception side. In the case of FIG. 25, buffering by the reorder processing is skipped while the retransmission processing performed in the individual data processing unit 171-1 on the backhaul link side of the Relay Node is maintained.

That is, the successfully received packets #1, #3, and #4 are sequentially supplied from the individual data processing unit 171-1 on the backhaul link side of the Relay Node to the individual data processing unit 171-2 on the fronthaul link side of the Relay Node via the Relay Buffer 191, and transmitted to the STA.

In addition, the Relay Node transmits Block Acks of the packets #1, #3, and #4 that have been successfully received to the Source Node.

The packets #1, #3, and #4 transmitted from the Relay Node are received by the STA. The STA transmits Block Acks of the successfully received packets #1, #3, and #4 to the Relay Node. In the Relay Node, reception of Block Ack is confirmed by the individual data processing unit 171-2 on the fronthaul link side.

The Source Node that has received the Block Ack from the Relay Node then transmits the packet #2 for which reception has failed and the next packets #5 to #7 to the Relay Node. At that time, it is assumed that only the packet #5 is damaged on the reception side. In this case, similarly, the successfully received packets #2, #6, and #7 are sequentially supplied from the individual data processing unit 171-1 on the backhaul link side of the Relay Node to the individual data processing unit 171-2 on the fronthaul link side of the Relay Node via the Relay Buffer 191, and transmitted to the STA.

Furthermore, the Relay Node transmits Block Acks of the packets #2, #6, and #7 that have been successfully received to the Source Node.

The packets #2, #6, and #7 transmitted from the Relay Node are received by the STA. The STA transmits Block Acks of the successfully received packets #2, #6, and #7 to the Relay Node. In the Relay Node, reception of Block Ack is confirmed by the individual data processing unit 171-2 on the fronthaul link side.

The Source Node that has received the Block Ack from the Relay Node then transmits the packet #5 for which reception has failed and the next packet #8 to the Relay Node. In this case, similarly, the successfully received packets #5 and #8 are sequentially supplied from the individual data processing unit 171-1 on the backhaul link side of the Relay Node to the individual data processing unit 171-2 on the fronthaul link side of the Relay Node via the Relay Buffer 191, and transmitted to the STA.

In addition, the Relay Node transmits Block Acks of the successfully received packets #5 and #8 to the Source Node.

The packets #5 and #8 transmitted from the Relay Node are received by the STA. The STA transmits Block Acks of the successfully received packets #5 and #8 to the Relay Node. In the Relay Node, reception of Block Ack is confirmed by the individual data processing unit 171-2 on the fronthaul link side.

As described above, as illustrated in FIG. 52, the transmission latency is shorter than that in the case of FIG. 6 or 7.

As described above, in the present technology, in the MLO Relay that can be implemented, while retransmission of the data processing unit is maintained, buffering in the reorder processing is skipped, and packets that have been successfully received are sequentially transmitted. As a result, a reduction in communication efficiency can be prevented, and an improvement effect in terms of a transmission latency can be expected.

Furthermore, in the present technology, setting of an MLO Relay and setting for retransmission processing are performed for each piece of information (TID) of a packet type. With this setting, it is also possible to process only the packet required to be transmitted with low latency. As a result, the transmission method can be switched more flexibly.

### <Configuration Example of Computer>

The series of processing described above can be executed by hardware or can be executed by software. In a case where the series of processing is executed by software, a program constituting the software is installed from a program recording medium to a computer incorporated in dedicated hardware, a general-purpose personal computer, or the like.

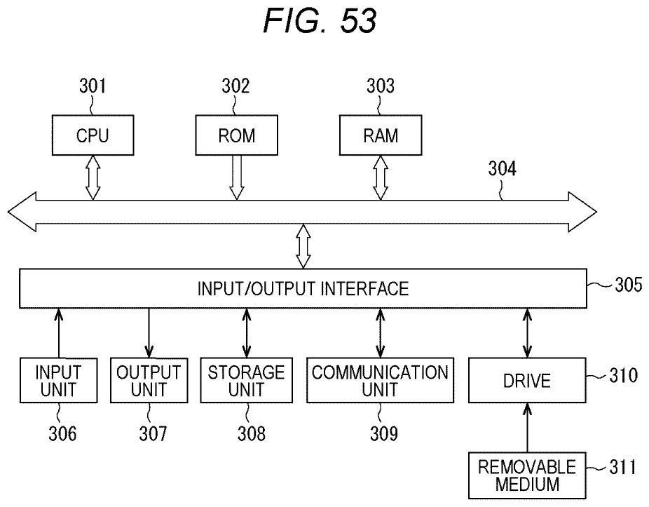

FIG. 53 is a block diagram illustrating a configuration example of hardware of a computer that executes the above-described series of processing by a program.

A central processing unit (CPU) 301, a read only memory (ROM) 302, and a random access memory (RAM) 303 are mutually connected by a bus 304.

An input/output interface 305 is also connected to the bus 304. An input unit 306 including a keyboard, a mouse, and the like, and an output unit 307 including a display, a speaker, and the like are connected to the input/output interface 305. Furthermore, a storage unit 308 including a hard disk, a nonvolatile memory, or the like, a communication unit 309 including a network interface or the like, and a drive 310 that drives a removable medium 311 are connected to the input/output interface 305.

In the computer configured as described above, for example, the CPU 301 loads the program stored in the storage unit 308 into the RAM 303 via the input/output interface 305 and the bus 304 and executes the program, and thus the series of processing described above is performed.

The program to be executed by the CPU 301 is provided, for example, by being recorded on the removable medium 311 or via a wired or wireless transmission medium such as a local area network, the Internet, or digital broadcasting, and is installed in the storage unit 308.

Note that the program executed by the computer may be a program for processing in time series in the order described in the present specification, or a program for processing in parallel or at a necessary timing such as when a call is made.

Note that in the present specification, a system means a set of a plurality of components (devices, modules (parts), and the like), and it does not matter whether or not all the components are in the same housing. Therefore, a plurality of devices housed in separate housings and connected via a network and one device in which a plurality of modules is housed in one housing are both systems.

Furthermore, the effects described in the present specification are merely examples and not limiting, and there may also be other effects.

Embodiments of the present technology are not limited to the above-described embodiments, and various modifications may be made without departing from the gist of the present technology.

For example, the present technology may be configured as cloud computing in which one function is shared by a plurality of devices through a network for processing in cooperation.

Furthermore, each step described in the above flowcharts may be executed by one device or shared and executed by a plurality of devices.

Moreover, in a case where a plurality of processing is included in one step, the plurality of processing included in the one step can be executed by one device or shared and executed by a plurality of devices.

### COMBINATION EXAMPLES OF CONFIGURATIONS

The present technology may also have the following configurations.
(1)
A wireless communication device including
a communication control unit that performs retransmission processing with each of a first other wireless communication device and a second other wireless communication device in response to a request signal transmitted from the first other wireless communication device or the second other wireless communication device, and performs a setting of relay communication in which encryption processing and decryption processing are skipped.
(2)
The wireless communication device according to (1),
in which, in a case of receiving the request signal including setting information of the relay communication transmitted from the first other wireless communication device or the second other wireless communication device, the communication control unit causes a response signal including response information to the setting of the relay communication to be transmitted.
(3)
The wireless communication device according to (2),
in which, in a case where the request signal is a relay communication setting request signal, the wireless communication device causes a relay communication setting response signal to be transmitted as the response signal.
(4)
The wireless communication device according to (2),
in which, in a case where the request signal is a connection request signal of the relay communication, the wireless communication device causes a connection response signal of the relay communication to be transmitted as the response signal.
(5)
The wireless communication device according to (2),
in which, in a case of receiving a relay communication release request signal including a processing number of the relay communication from the first other wireless communication device or the second other wireless communication device, the communication control unit causes a relay communication release response signal including the response information to be transmitted.
(6)
The wireless communication device according to (5),
in which, in a case where exchange of the relay communication release request signal and the relay communication release response signal with one of the first other wireless communication device and the second other wireless communication device is completed, the communication control unit performs disconnection processing with the one of the first other wireless communication device and the second other wireless communication device.
(7)
The wireless communication device according to (2),
in which the communication control unit causes a retransmission processing setting request signal for the relay communication to be transmitted to the first other wireless communication device or the second other wireless communication device.
(8)
The wireless communication device according to (2),
in which, in a case of receiving a retransmission processing setting request signal for the relay communication from at least one of the first other wireless communication device or the second other wireless communication device, the communication control unit causes a retransmission processing setting response signal for the relay communication to be transmitted to the at least one of the first other wireless communication device or the second other wireless communication device.
(9)
The wireless communication device according to (8),
in which the retransmission processing setting response signal includes a memory size of the relay communication.
(10)
A wireless communication method in which a wireless communication device is configured to
perform retransmission processing with each of a first other wireless communication device and a second other wireless communication device in response to a request signal transmitted from the first other wireless communication device or the second other wireless communication device, and perform a setting of relay communication in which encryption processing and decryption processing are skipped.
(11)
A wireless communication device including
a communication control unit that generates an encryption key directly with a first other wireless communication device and performs a setting of retransmission processing with a second other wireless communication device in relay communication in which communication with the first other wireless communication device is performed by relaying the second other wireless communication device.
(12)
The wireless communication device according to (11),
in which the communication control unit causes a relay communication setting request signal including setting information of the relay communication to be transmitted to the first other wireless communication device and the second other wireless communication device.
(13)
The wireless communication device according to (12),
in which the setting information includes at least a processing number of the relay communication, information indicating the second other wireless communication device, information indicating a direction in which the relay communication is performed, packet type information for performing the relay communication, and packet identification information.
(14)
The wireless communication device according to (12),
in which, after completion of exchange of the relay communication setting request signal and a relay communication setting response signal as a response to the relay communication setting request signal with the first other wireless communication device, the wireless communication device performs authentication processing and connection processing with the second other wireless communication device.
(15)
The wireless communication device according to (14),
in which the communication control unit exchanges a connection request signal for the relay communication and a connection response signal for the relay communication and skips encryption key generation processing during the connection processing.
(16)
The wireless communication device according to (14),
in which the communication control unit causes a relay setting completion signal to be transmitted to the first other wireless communication device after the connection processing is completed.
(17)
The wireless communication device according to (12),
in which, after completing exchange of the relay communication setting request signal and a relay communication setting response signal as a response to the relay communication setting request signal with the second other wireless communication device, the wireless communication device directly performs authentication processing, connection processing, and encryption key generation processing with the first other wireless communication device.
(18)
The wireless communication device according to (11),
in which the communication control unit causes a relay communication release request signal including a processing number of the relay communication to be transmitted to the first other wireless communication device or the second other wireless communication device.
(19)
The wireless communication device according to (18),
in which the communication control unit performs disconnection processing with at least one of the first other wireless communication device or the second other wireless communication device after completing exchange of the relay communication release request signal and a relay communication release response signal with the at least one of the first other wireless communication device or the second other wireless communication device.
(20)
The wireless communication device according to (12),
in which, after receiving the relay communication setting request signal or a relay communication release request signal from the first other wireless communication device or the second other wireless communication device, the communication control unit causes a response signal including response information of relay communication setting or release to be transmitted.
(21)
The wireless communication device according to (20),
in which the response information includes at least a processing number of the relay communication and information indicating settability.
(22)
The wireless communication device according to (12),
in which the wireless communication device causes a retransmission processing setting request signal for the relay communication to be transmitted to the second other wireless communication device.
(23)
The wireless communication device according to (12),
in which the wireless communication device causes a retransmission processing setting response signal of the relay communication to be transmitted after receiving a retransmission processing setting request signal of the relay communication from the second other wireless communication device.
(24)
A wireless communication method in which
a wireless communication device is configured to
generate an encryption key directly with a first other wireless communication device and performs a setting of retransmission processing with a second other wireless communication device in relay communication in which communication with the first other wireless communication device is performed by relaying the second other wireless communication device.

### REFERENCE SIGNS LIST

11 Wireless communication device
31 Wireless communication unit
54, 54-1, 54-2 Data processing unit
55 Communication control unit
93, 93-1, 93-2 Signal processing unit
95 Communication control unit
111 Wireless communication device
121 Wireless communication unit
144 Data processing unit
145 Communication control unit
151 Wireless communication device
161 Wireless communication unit
162 Control unit
171, 171-1, 171-2 Individual data processing unit
172 Common data processing unit
191 Relay Buffer

1. A wireless communication device comprising:
a communication control unit that performs retransmission processing with each of a first other wireless communication device and a second other wireless communication device in response to a request signal transmitted from the first other wireless communication device or the second other wireless communication device, and performs a setting of relay communication in which encryption processing and decryption processing are skipped.

2. The wireless communication device according to claim 1,
wherein, in a case of receiving the request signal including setting information of the relay communication transmitted from the first other wireless communication device or the second other wireless communication device, the communication control unit causes a response signal including response information to the setting of the relay communication to be transmitted.

3. The wireless communication device according to claim 2,
wherein, in a case where the request signal is a relay communication setting request signal, the wireless communication device causes a relay communication setting response signal to be transmitted as the response signal.

4. The wireless communication device according to claim 2,
wherein, in a case where the request signal is a connection request signal of the relay communication, the wireless communication device causes a connection response signal of the relay communication to be transmitted as the response signal.

5. The wireless communication device according to claim 2,
wherein, in a case of receiving a relay communication release request signal including a processing number of the relay communication from the first other wireless communication device or the second other wireless communication device, the communication control unit causes a relay communication release response signal including the response information to be transmitted.

6. The wireless communication device according to claim 5,
wherein, in a case where exchange of the relay communication release request signal and the relay communication release response signal with one of the first other wireless communication device and the second other wireless communication device is completed, the communication control unit performs disconnection processing with the one of the first other wireless communication device and the second other wireless communication device.

7. The wireless communication device according to claim 2,
wherein the communication control unit causes a retransmission processing setting request signal for the relay communication to be transmitted to the first other wireless communication device or the second other wireless communication device.

8. The wireless communication device according to claim 2,
wherein, in a case of receiving a retransmission processing setting request signal for the relay communication from at least one of the first other wireless communication device or the second other wireless communication device, the communication control unit causes a retransmission processing setting response signal for the relay communication to be transmitted to the at least one of the first other wireless communication device or the second other wireless communication device.

9. The wireless communication device according to claim 8,
wherein the retransmission processing setting response signal includes a memory size of the relay communication.

10. A wireless communication method in which
a wireless communication device is configured to
perform retransmission processing with each of a first other wireless communication device and a second other wireless communication device in response to a request signal transmitted from the first other wireless communication device or the second other wireless communication device, and perform a setting of relay communication in which encryption processing and decryption processing are skipped.

11. A wireless communication device comprising:
a communication control unit that generates an encryption key directly with a first other wireless communication device and performs a setting of retransmission processing with a second other wireless communication device in relay communication in which communication with the first other wireless communication device is performed by relaying the second other wireless communication device.

12. The wireless communication device according to claim 11,
wherein the communication control unit causes a relay communication setting request signal including setting information of the relay communication to be transmitted to the first other wireless communication device and the second other wireless communication device.

13. The wireless communication device according to claim 12,
wherein the setting information includes at least a processing number of the relay communication, information indicating the second other wireless communication device, information indicating a direction in which the relay communication is performed, packet type information for performing the relay communication, and packet identification information.

14. The wireless communication device according to claim 12,
wherein, after completing exchange of the relay communication setting request signal and a relay communication setting response signal as a response to the relay communication setting request signal with the first other wireless communication device, the wireless communication device performs authentication processing and connection processing with the second other wireless communication device as necessary.

15. The wireless communication device according to claim 11,
wherein the communication control unit causes a relay communication release request signal including a processing number of the relay communication to be transmitted to the first other wireless communication device or the second other wireless communication device.

16. The wireless communication device according to claim 12,
wherein, after receiving the relay communication setting request signal or a relay communication release request signal from the first other wireless communication device or the second other wireless communication device, the communication control unit causes a response signal including response information of relay communication setting or release to be transmitted.

17. The wireless communication device according to claim 16,
wherein the response information includes at least a processing number of the relay communication and information indicating settability.

18. The wireless communication device according to claim 12,
wherein the wireless communication device transmits a retransmission processing setting request signal for the relay communication to the second other wireless communication device.

19. The wireless communication device according to claim 12,
wherein the wireless communication device causes a retransmission processing setting response signal of the relay communication to be transmitted after receiving a retransmission processing setting request signal of the relay communication from the second other wireless communication device.

20. A wireless communication method in which
a wireless communication device is configured to
generate an encryption key directly with a first other wireless communication device and performs a setting of retransmission processing with a second other wireless communication device in relay communication in which communication with the first other wireless communication device is performed by relaying the second other wireless communication device.
